(19) United States
(12) Patent Application Publication
(10) Pub. No.: US 2024/0253284 A1
(43) Pub. Date: Aug. 1, 2024

(54) MANUFACTURING METHOD USING SHUTTLE MOLD AND OVERMOLDING

(71) Applicant: CANON VIRGINIA, INC., Newport News, VA (US)

(72) Inventors: Koki Kodaira, Newport News, VA (US); Yuichi Yanahara, Moriyama (JP); Tomohiro Shima, Yorktown, VA (US); Shigeru Katagiri, Kasama-shi (JP); Masayoshi Sonobe, Kasama-shi (JP)

(21) Appl. No.: 18/566,577

(22) PCT Filed: Jun. 1, 2022
(86) PCT No.: PCT/US2022/031825

§ 371 Date: Dec. 1, 2023

Related U.S. Application Data
(60) Provisional application No. 63/196,096, filed on Jun. 2, 2021.
(60) Provisional application No. 63/282,099, filed on Nov. 22, 2021.

(51) Int. Cl. B29C 45/76; B29C 45/16; B29C 45/42; B29C 45/78

(52) U.S. Cl. CPC B29C 45/762; B29C 45/162; B29C 45/42; B29C 45/78; B29C 2945/76531; B29C 2945/76648; B29C 2945/76735

(57) ABSTRACT

An injection molding system includes injecting resin into a mold, moving a mold between a first position within an injection molding machine and a second position outside the injection molding machine, wherein improvement to the injection molding system includes not moving a first mold until the injection molding machine performs N times of an injection process with the first mold, where the first mold is moved from the first position to the second position after the N times of the injection process with the first mold so a second external mold moves into the injection molding machine, and inserting a first molded part obtained based on the N times injection process with the first mold into the second mold such that resin is injected into the second mold in which the first molded part is inserted to obtain a second molded part.

### CROSS-REFERENCE TO RELATED APPLICATION

This application claims the benefit of U.S. Provisional Application 63/196096, which was filed on Jun. 2, 2021 and U.S. Provisional Application 63/282099, which was filed on Nov. 22, 2021.

### FIELD

The disclosure herein relates to an injection molding system.

### BACKGROUND

Manufacturing of molded parts by an injection molding machine includes injecting a resin into a mold after clamping the mold, pressing the resin into the mold at a high pressure in order to compensate for a volume decrease due to solidification of the resin, keeping the molded part in the mold until the resin solidifies, and ejecting the molded part from the mold. The injection molding process is repeatedly performed to obtain a desired number of molded parts. After a predetermined number of moldings are performed with one mold, the mold is ejected from the injection molding machine, the next mold is setup, the next mold is inserted into the injection molding machine, and then the predetermined number of injection moldings with the next mold is performed.

In the above-described molding approach, a method that uses two molds with one injection molding machine has been proposed. For example, US 2018/0009146/Japanese patent publication No. 2018-001738/VN20160002505 are seen to discuss a system in which conveying machines are arranged on both sides of an injection molding machine. FIG. 1 illustrates an injection molding system of US 2018/0009146/Japanese patent publication No. 2018-001738/VN20160002505. In this system, a mold is moved between a molding operation position where resin is injected and a molded part is taken out, and a cooling position where the resin injected into the mold is cooled.

The injection molding system of US 2018/0009146/Japanese patent publication No. 2018-001738/VN20160002505 is not seen to discuss the injection molding process known as overmolding. Overmolding is a multi-step injection molding process where two or more components are molded over top of one another.

What is needed is a shuttle mold injection system that enables overmolding.

### SUMMARY

An injection molding system comprising an injection molding machine for injecting a resin into a mold, a conveyer apparatus configured to move a mold between a first position within the injection molding machine and a second position outside the injection molding machine, a controller, and an inserting unit, wherein the improvement to the injection molding system includes the controller configured to control the conveyer apparatus not to move a first mold until the injection molding machine performs N times (N≥2) of an injection process with the first mold, wherein the controller is further configured to control the conveyer apparatus to move the first mold from the first position to the second position after the N times of the injection process with the first mold such that a second mold external to the injection molding machine moves into the injection molding machine, and the inserting unit configured to insert one of a first molded part obtained based on the N times injection process with the first mold into the second mold such that the injection molding machine injects a resin into the second mold in which the first molded part is inserted to obtain a second molded part.

### BRIEF DESCRIPTION OF THE DRAWINGS

The accompanying drawings, which are incorporated herein and form part of the specification, illustrate various embodiments, objects, features, and advantages of the present disclosure.

FIG. 1 illustrates an injection molding system.

FIG. 2 is a side view of an injection molding machine.

FIG. 3 is an end view of a fixed platen.

FIGS. 4A-4K illustrate a flowchart illustrating a molding process.

FIGS. 5A-5R illustrates a molding process according to an exemplary embodiment.

FIGS. 6A-6F illustrate a flowchart illustrating a molding process.

FIGS. 6G-61 illustrate an improvement to the molding process in FIGS. 6A-6F.

FIGS. 7A-7AO illustrate a molding process of an exemplary embodiment.

Throughout the Figures, the same reference numerals and characters, unless otherwise stated, are used to denote like features, elements, components or portions of the illustrated embodiments. While the subject disclosure is described in detail with reference to the Figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

With reference to the drawings, an injection molding system according to an embodiment of the present disclosure will be explained. The arrow symbols X and Y in each Figure indicate horizontal directions that are orthogonal to each other, and the arrow symbol Z indicates a vertical (upright) direction with respect to the ground.

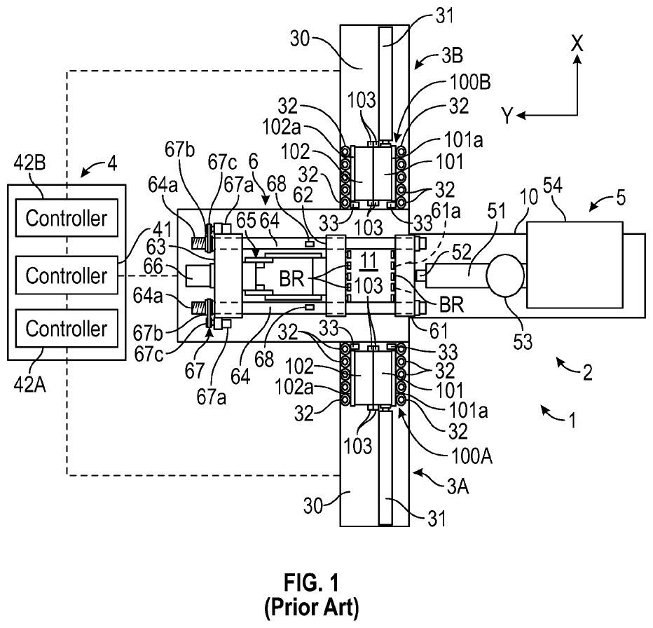

FIGS. 1-3 illustrate injection molding system 1 of US 2018/0009146/Japanese patent publication No. 2018-001738/VN20160002505 and are being provided herein for information/description purposes only.

The injection molding system 1 includes an injection molding machine 2, conveying machines 3A and 3B, and a control apparatus 4. The injection molding system 1 manufactures a molded part while alternating a plurality of molds using the conveying machines 3A and 3B for the one injection molding machine 2. Two molds, 100A and 100B are used.

The mold 100A/100B is a pair of a fixed mold 101 and a movable mold 102, which is opened/closed in relation to the fixed mold 101. The molded part is molded by injecting a molten resin into a cavity formed between the fixed mold 101 and the movable mold 102. Clamping plates 101a and 102a are respectively fixed to the fixed mold 101 and the movable mold 102. The clamping plates 101a and 102a are used to lock the mold 100A/100B to a molding operation position 11 (mold clamping position) of the injection molding machine 2.

For the mold 100A/100B, a self-closing unit 103 is provided for maintaining a closed state between the fixed mold 101 and the movable mold 102. The self-closing unit 103 enables preventing the mold 100A/100B from opening after unloading the mold 100A/100B from the injection molding machine 2. The self-closing unit 103 maintains the mold 100A/100B in a closed state using a magnetic force. The self-closing unit 103 located at a plurality of locations along opposing surfaces of the fixed mold 101 and the movable mold 102. The self-closing unit 103 is a combination of an element on the side of the fixed mold 101 and an element on the side of the movable mold 102. For the self-closing unit 103, typically two or more pair are installed for one of the molds 100A and 100B.

A conveying machine 3A loads and unloads the mold 100A onto/from the molding operation position 11 of the injection molding machine 2. A conveying machine 3B loads and unloads the mold 100B onto/from the molding operation position 11. The conveying machine 3A, the injection molding machine 2, and the conveying machine 3B are arranged to be lined up in this order in the X-axis direction. In other words, the conveying machine 3A and the conveying machine 3B are arranged laterally with respect to the injection molding machine 2 to sandwich the injection molding machine 2 in the X-axis direction. The conveying machines 3A and 3B are arranged to face each other, the conveying machine 3A is arranged on one side laterally of the injection molding machine 2, and the conveying machine 3B is arranged on the other side respectively adjacent. The molding operation position 11 is positioned between the conveying machine 3A and the conveying machine 3B. The conveying machines 3A and 3B respectively include a frame 30, a conveyance unit 31, a plurality of rollers 32, and a plurality of rollers 33.

The frame 30 is a skeleton of the conveying machine 3A and 3B, and supports the conveyance unit 31, and the pluralities of rollers 32 and 33. The conveyance unit 31 is an apparatus that moves the mold 100A/100B back and forth in the X-axis direction, and that removes and inserts the mold 100A/100B in relation to the molding operation position 11.

The conveyance unit 31 is an electrically driven cylinder with a motor as a driving source, and includes a rod that moves forward/backward in relation to the cylinder. The cylinder is fixed to the frame 30, and the fixed mold 101 is fixed to the edge portion of the rod. For the conveyance unit 31 both a fluid actuator and an electric actuator can be used, where the electric actuator can provide better precision of control of the position or the speed when conveying the mold 100A/100B. The fluid actuator can be an oil hydraulic cylinder, or an air cylinder, for example. The electric actuator can, in addition to being an electrically driven cylinder, be a rack-and-pinion mechanism with a motor as the driving source, a ball screw mechanism with a motor as the driving source, or the like.

The conveyance unit 31 is arranged independently for each of the conveying machines 3A and 3B. However, a common support member that supports the molds 100A and 100B can be used, and a single common conveyance unit 31 can be arranged for this support member. A case where the conveyance unit 31 is arranged independently for each of the conveying machines 3A and 3B enables handling cases where a movement strokes differ between the mold 100A and the mold 100B when conveying. For example, a case where molds cannot be conveyed simultaneously since the widths of the molds (the width in the X direction) differ or the thickness of the molds (the width in the Y direction) differ.

The plurality rollers 32 configure a row of rollers arranged in the X-axis direction, where two rows are configured separated in the Y-axis direction. The plurality of rollers 32 rotate around the axis of revolution in the Z-axis direction, and guide movement in the X-axis direction of the mold 100A/100B contacting the side surfaces of the mold 100A/100B (the side surfaces of the clamping plates 101a and 102a) and supporting the mold 100A/100B from the side. The plurality rollers 33 configure a row of rollers arranged in the X-axis direction, where two rows are configured separated in the Y-axis direction. The plurality of rollers 33 rotate around the axis of revolution in the Y direction, and cause movement in the X direction of the mold 100A/100B to be smooth, supporting the bottom surfaces of the mold 100A/100B (the bottom surfaces of the clamping plates 101a and 102a) and supporting the mold 100A/100B from below.

The control apparatus 4 includes a controller 41 for controlling the injection molding machine 2, a controller 42A for controlling the conveying machine 3A, and a controller 42B for controlling the conveying machine 3B. Each of the controllers 41, 42A and 42B includes, for example, a processor such as a CPU, a RAM, a ROM, a storage device such as a hard disk, and interfaces connected to sensors or actuators (not illustrated). The processor executes programs stored in the storage device. An example of a program (control) that the controller 41 executes is described below. The controller 41 is communicably connected with the controllers 42A and 42B, and provides instructions related to the conveyance of the mold 100A/100B to the controllers 42A and 42B. The controllers 42A and 42B, if loading and unloading of the mold 100A/100B terminates, transmit a signal for operation completion to the controller 41. In addition, the controllers 42A and 42B transmit an emergency stop signal at a time of an abnormal occurrence to the controller 41.

A controller is arranged for each of the injection molding machine 2, the conveying machine 3A, and the conveying machine 3B, but one controller can control all three machines. The conveying machine 3A and the conveying machine 3B can be controlled by a single controller for more reliable and collaborative operation.

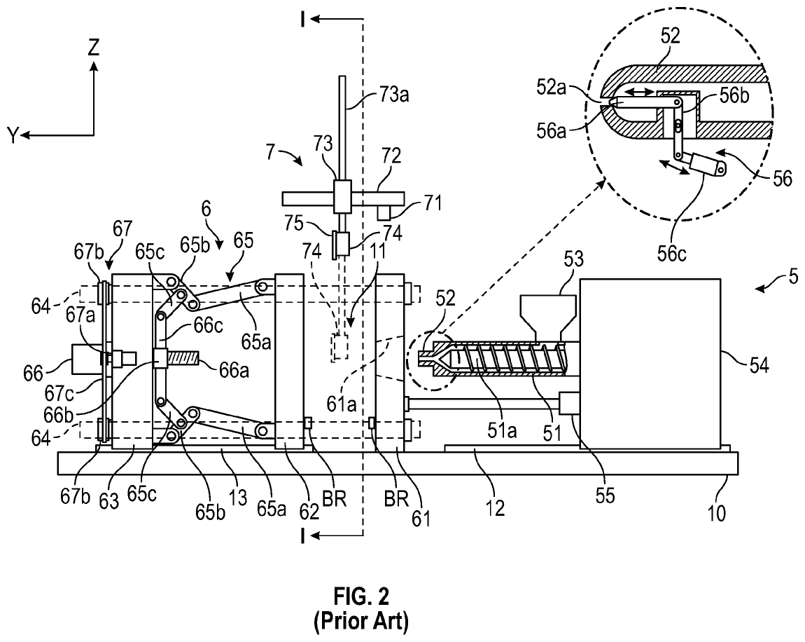

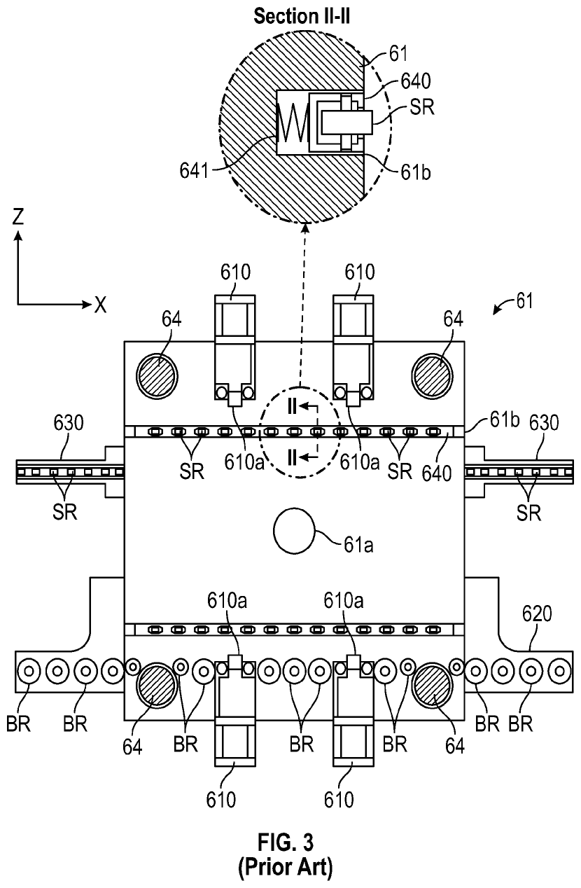

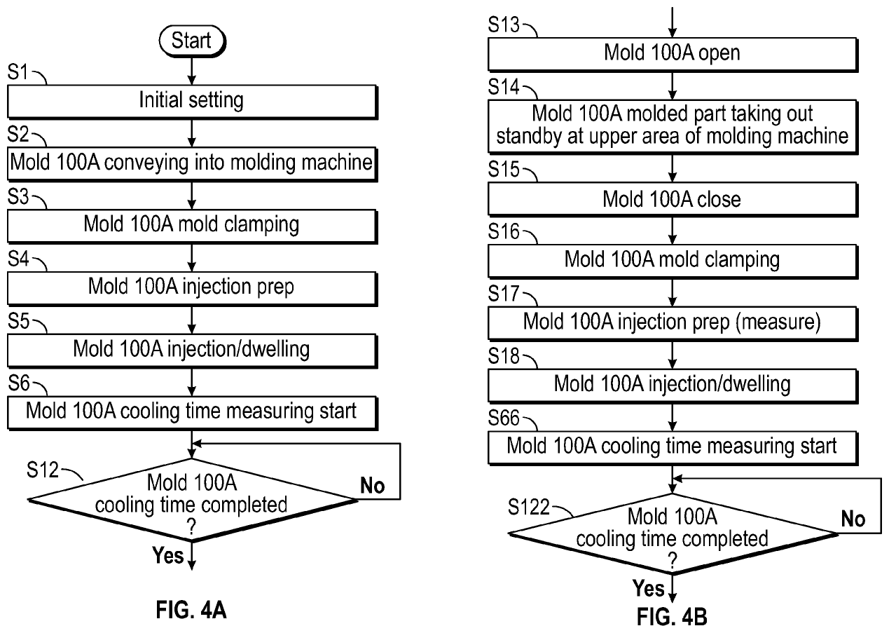

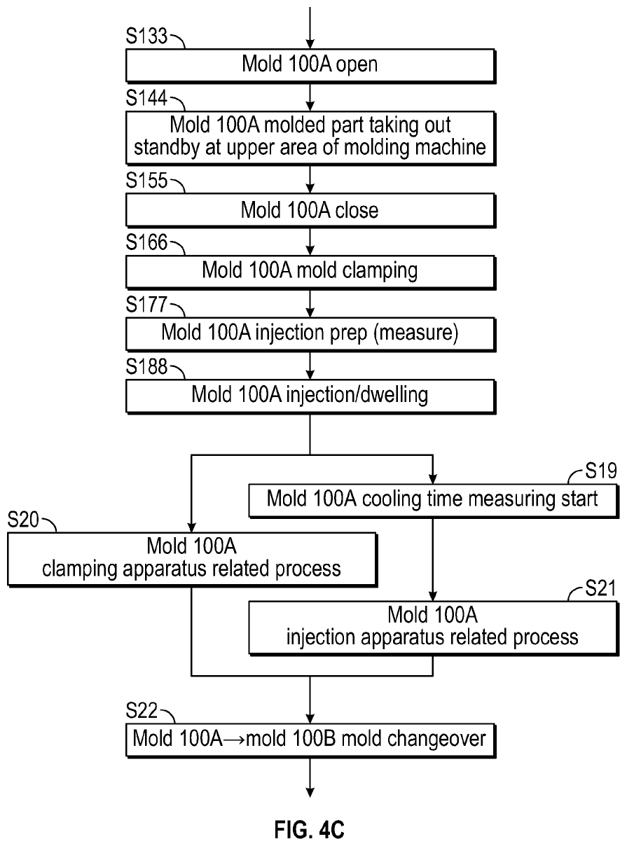

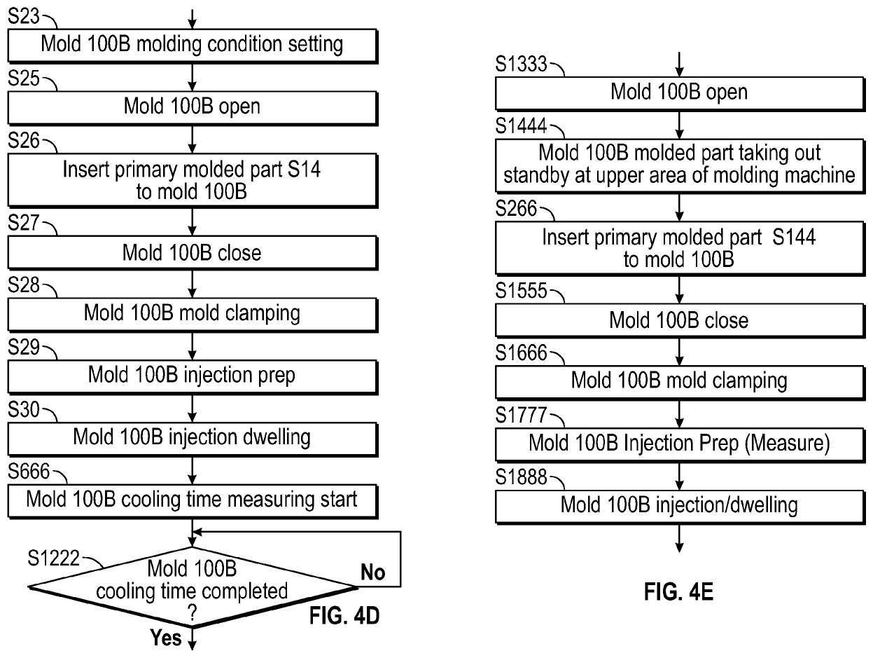

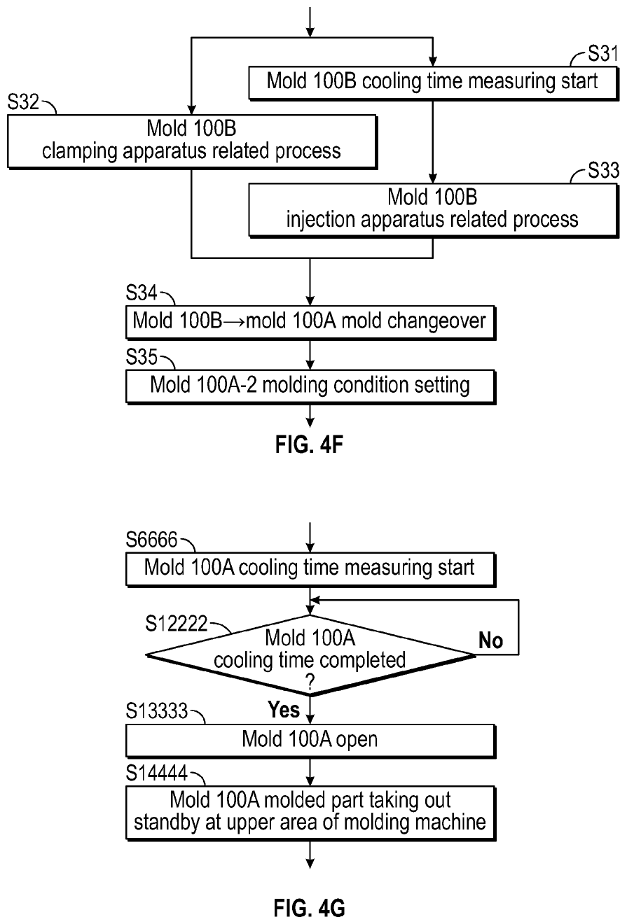

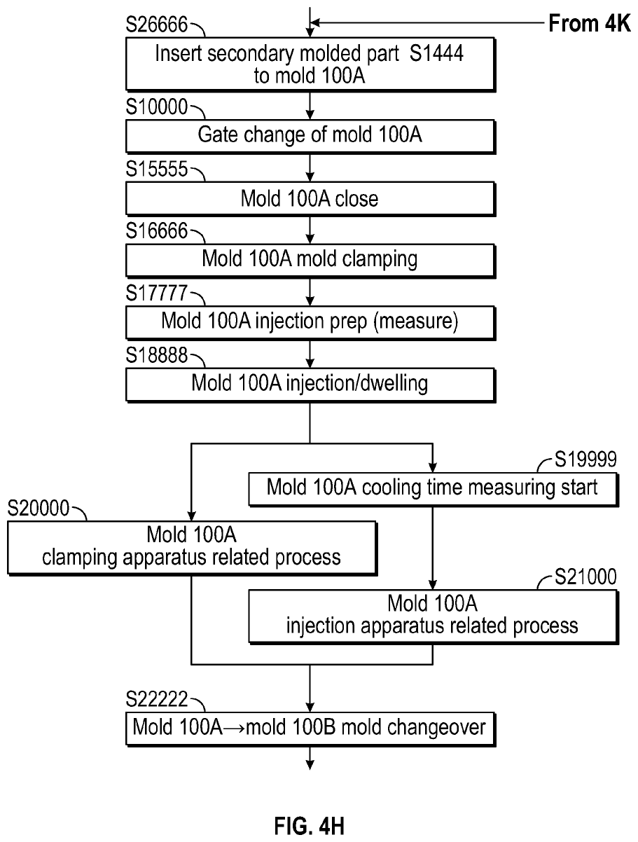

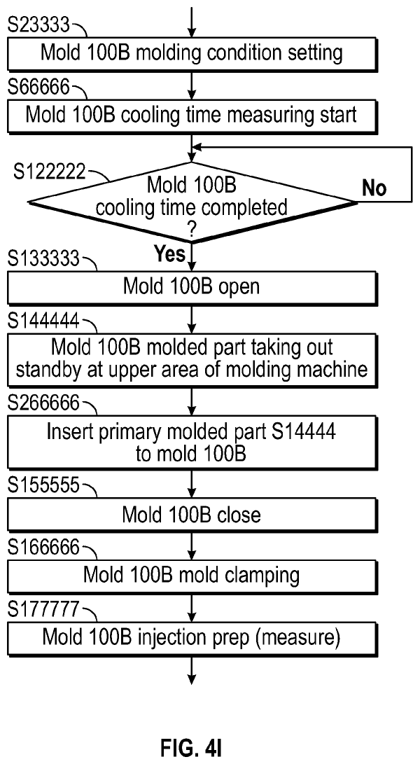

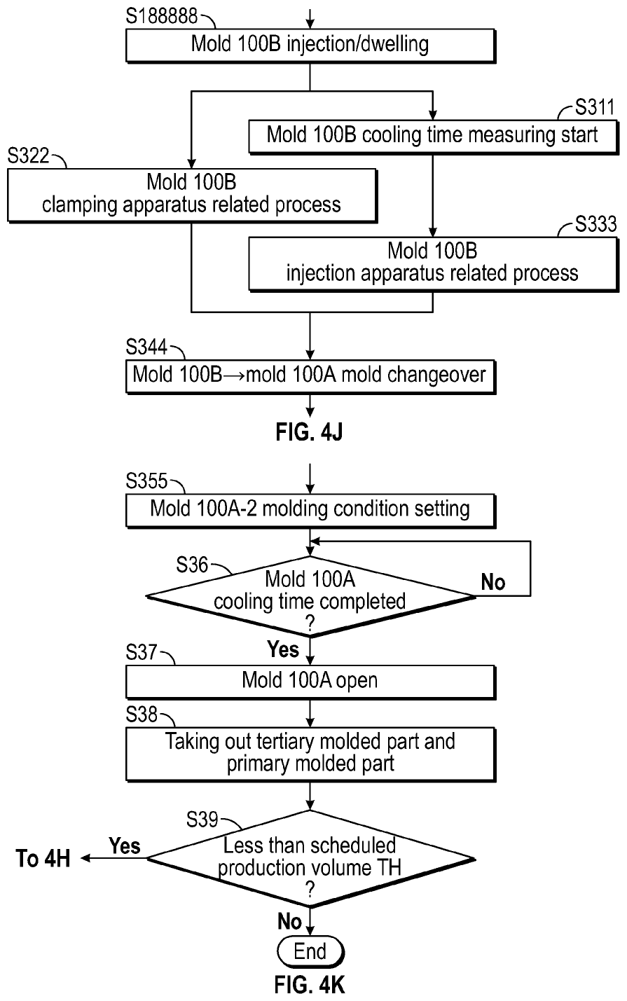

FIG. 2 illustrates a side view of the injection molding machine 2. FIG. 3 illustrates an end view of a fixed platen 61, and a figure viewing from the arrow direction of the I-I line in FIG. 2. FIG. 4 illustrates a partial perspective view for describing the configuration of a periphery of the molding operation position 11.

With reference to FIG. 1 and FIG. 2, the injection molding machine 2 includes an injecting apparatus 5, a clamping apparatus 6, and a take-out robot 7 for ejecting a molded part. The injecting apparatus 5 and the clamping apparatus 6 are arranged on a frame 10 in the Y-axis direction.

The injecting apparatus 5 includes an injection cylinder 51 that is arranged to extend in the Y-axis direction. The injection cylinder 51 includes a heating device (not illustrated) such as a band heater, and melts a resin introduced from a hopper 53. A screw 51a is integrated into the injection cylinder 51, and by rotation of the screw 51a, plasticizing and measuring the resin introduced into the injection cylinder 51 are performed, and by movement in the axial direction (Y-axis direction) of the screw 51a, it is possible to inject a molten resin from an injection nozzle 52.

In FIG. 2, an example of a shut-off nozzle as the nozzle 52 is illustrated. For an opening/closing mechanism 56 of FIG. 2, a pin 56a for opening/closing the discharge port 52a is arranged. The pin 56a is connected with an actuator (a cylinder) 56c via a link 56b, and by the operation of the actuator 56c the discharge port 52a is opened and closed.

The injection cylinder 51 is supported by a driving unit 54. In the driving unit 54, a motor for plasticizing and measuring the resin by rotationally drive the screw 51a, and a motor for driving the screw 51a to move forward/backward in the axial direction are arranged. The driving unit 54 can move forward/backward in the Y-axis direction along a rail 12 on the frame 10, and in the driving unit 54, an actuator (for example, an electrically driven cylinder) 55 for causing the injecting apparatus 5 to move forward/backward in the Y-axis direction is arranged.

The clamping apparatus 6 performs a clamping and opening and closing of the molds 100A/100B. In the clamping apparatus 6, the following are arranged in order in the Y-axis direction: the fixed platen 61, a movable platen 62, and a movable platen 63. Through platens 61 to 63, a plurality of tie-bars 64 pass. Each of the tie-bars 64 is an axis that extends in the Y-axis direction, one end of which is fixed to the fixed platen 61. Each of the tie-bars 64 is inserted into a respective through hole formed in the movable platen 62. The other end of each of the tie-bars 64 is fixed to the movable platen 63 through an adjusting mechanism 67. The movable platens 62 and 63 can move in the Y-axis direction along a rail 13 on the frame 10, and the fixed platen 61 is fixed to the frame 10.

A toggle mechanism 65 is arranged between the movable platen 62 and the movable platen 63. The toggle mechanism 65 causes the movable platen 62 to move forward/backward in the Y-axis direction in relation to the movable platen 63 (in other words, in relation to the fixed platen 61). The toggle mechanism 65 includes links 65a to 65c. The link 65a is connected rotatably to the movable platen 62. The link 65b is pivotably connected to the movable platen 63. The link 65a and the link 65b are pivotably connected to each other. The link 65c and the link 65b are pivotably connected to each other. The link 65c is pivotably connected to an arm 66c.

The arm 66c is fixed on a ball nut 66b. The ball nut 66b engages a ball screw shaft 66a that extends in the Y-axis direction, and moves forward/backward in the Y-axis direction by rotation of the ball screw shaft 66a. The ball screw shaft 66a is supported such that it is free to rotate by the movable platen 63, and a motor 66 is supported by the movable platen 63. The motor 66 rotationally drives the ball screw shaft 66a while the rotation amount of the motor 66 is detected. Driving the motor 66 while detecting the rotation amount of the motor 66 enables clamping, opening, and closing of the mold 100A/100B.

The injection molding machine 2 includes sensors 68 for measuring a clamping force, where each sensor 68 is, for example, a strain gauge provided on the tie-bar 64, and calculates a clamping force by detecting a distortion of the tie-bar 64.

The adjusting mechanism 67 includes nuts 67b supported to freely rotate on the movable platen 63, motors 67a as driving sources, and transfer mechanisms for transferring the driving force of the motors 67a to the nuts 67b. Each of the tie-bars 64 passes through a hole formed in the movable platen 63, and engages with the nut 67b. By causing the nuts 67b to rotate, the engagement positions in the Y-axis direction between the nuts 67b and the tie-bars 64 change. That is, the position at which the movable platen 63 is fixed in relation to the tie-bar 64 changes. With this, it is possible to cause a space between the movable platen 63 and the fixed platen 61 to change, and thereby it is possible to adjust a clamping force or the like.

The molding operation position 11 is a region between the fixed platen 61 and the movable platen 62.

The mold 100A/100B introduced into the molding operation position 11 are sandwiched between the fixed platen 61 and the movable platen 62 and thereby clamped. Opening and closing in based on movement of the movable mold 102 by movement of the movable platen 62 is performed.

The take-out robot 7 includes a rail 71 that extends in the X-axis direction and a movable rail 72 that can move in the X-axis direction on the rail 71. The movable rail 72 is installed to extend in the Y-axis direction and a slider 73 is provided on the movable rail 72. The slider 73 includes a function for moving in the Y-axis direction guided by the movable rail 72, and a function of moving an elevating shaft 73a up and down in the Z-axis direction. A vacuum head 74 is provided on the lower end of the elevating shaft 73a a, and a chuck plate 75 specialized to a molded part is mounted on the vacuum head 74. After opening, the take-out robot 7 moves the vacuum head 74 between the fixed mold 101 and the movable mold 102 as illustrated by the broken lines in FIG. 2 with the rail 71, the movable rail 72, and the slider 73, vacuums the molded part, and conveys it outside the injection molding machine 2. In another exemplary embodiment, the take-out robot is a type that grips the molded part mechanically.

FIG. 3 illustrates an opening portion 61a in a central portion of the fixed platen 61 through which the nozzle 52 moves forward/backward. To the surface on the side of the movable platen 62 (called an inner surface) of the fixed platen 61 a plurality of rollers BR are supported such that they are free to rotate. The plurality of rollers BR rotate around the axis of revolution in the Y-axis direction, and cause movement in the X-axis direction of the mold 100A/100B to be smooth, supporting the bottom surfaces (the bottom surface of the clamping plate 101a) of the mold 100A/100B and supporting the mold 100A/100B from below. On both sides in the X-axis direction of the fixed platen 61, a roller supporting body 620 is fixed, and the plurality of rollers BR are supported by the roller supporting body 620. On the inner surface of the fixed platen 61, grooves 61b that extend in the X-axis direction are formed.

The grooves 61b are formed in two rows separated vertically. On each of the grooves 61b a roller unit 640 is arranged. For the roller unit 640, a plurality of rollers SR are supported such that they are free to rotate. The plurality of rollers SR rotate around the axis of revolution in the Z-axis direction, and guide movement in the X-axis direction of the mold 100A/100B contacting the outer surfaces of the mold 100A/100B (the outer surface of the clamping plate 101a) and supporting the mold 100A/100B from the side. As illustrated in the cross sectional view of the line II-II, while the roller unit 640, by a bias of a spring 641, is positioned at a position at which the roller SR protrudes from the groove 61b, at a time of clamping it is retracted in the groove 61b. and positioned at a position at which the roller SR does not protrude from the groove 61b. The roller unit 640 can prevent the inner surfaces of the mold 100A/100B and the fixed platen 61 from contacting and damaging the inner surfaces at a time of alternating the mold 100A/100B, and the roller unit 640 does not impede the inner surface of the fixed platen 61 and the mold 100A/100B being closed at a time of clamping. On both sides in the X-axis direction of the fixed platen 61, a roller supporting body 630 is fixed, and a plurality of rollers SR are supported by the roller supporting body 630.

On the fixed platen 61, a plurality of fixing mechanisms (clamps) 610 are arranged for fixing the fixed mold 101 to the fixed platen 61. Each fixing mechanism 610 includes an engaging portion 610a that engages with the clamping plate 101a, and a built-in actuator (not illustrated) that moves the engaging portion 610a between an engagement position and an engagement release position.

Note that for the movable platen 62, similarly to the fixed platen 61, a plurality of rollers BR, the roller supporting bodies 620 and 630, the roller unit 640, and the fixing mechanism 610 for fixing the movable mold 102 are arranged.

FIGS. 4A-4K illustrate an example of an operation of the injection molding system 1 executed by the controller 41 according to the present embodiment. FIGS. 4A-4K include steps that are known injection molding functions and steps that are improvements to these known functions. The known functions are being included to provide a thorough description of the present embodiment. For description purposes, the steps associated with the improvements will be indicated as being improvements. In the following example, a case in which a molding operation is performed while alternating molds 100A and 100B.

An initial setting is performed in step S1. The operation conditions of the injecting apparatus 5 and the clamping apparatus 6 are registered for both molds 100A and 100B. The operation conditions include, but are not limited to, the amount of resin that is injected at one time, the temperature, the injection speed, the clamping force, the initial value of the position of the movable platen 63 in relation to the tie-bars 64, etc. These operation conditions differ even when the mold 100A and the mold 100B are the same type of mold. Because the mold 100A is used for a first molding operation, the operations conditions related to the mold 100A are automatically set as the operation conditions. Heating of the injection cylinder 51 and plasticizing and measuring of the resin and the like for the first time is also started.

As described below, even in a case of the operation conditions for the mold 100A, the operation conditions for molding the primary molded part can be different from the operation conditions for molding a primary molded part and a tertiary molded part. In step S1, the controller 41 sets the operation condition A for molding a primary molded part “n” using the mold 100A, the operation condition B for molding a secondary molded part “y” using the mold 100B, and the operation condition C for molding the primary molded part “n” and a tertiary molded part “x” using the mold 100A based on user input.

In step S2, the mold 100A is conveyed into the injection molding machine 2. The motor 66 is driven to widen the gap between the fixed platen 61 and the movable platen 62 to slightly wider than the thickness of the mold 100A (the width in the Y direction). Next, the controller 41 transmits an instruction to load the mold 100A to the controller 42A, and the controller 42A drives the conveyance unit 31 to load the mold 100A into the molding operation position 11. The mold 100A is unloaded and the mold 100B loaded at the same time. When loading of the mold 100A completes, a signal indicating load completion is transmitted from the controller 42A to the controller 41. When the signal indicating load completion is received, the motor 66 is driven to bring the fixed platen 61 and the movable platen 62 into close contact with the mold 100A. At this time it is not necessary to generate a clamping force as it is generated to occur during a molding. The mold 100A is locked to each of the fixed platen 61 and the movable platen 62 by driving the fixing mechanisms 610.

In step S3, clamping of the mold 100A by the fixed platen 61 and the movable platen 62 is performed by driving the motor 66 to drive the toggle mechanism 65. Preparation for injection in relation to the mold 100A is performed in step S4. The actuator 55 is driven to move the injecting apparatus 5, causing the nozzle 52 to contact the mold 100A.

In step S5, injection and dwelling of molten resin is performed. More specifically, the injecting apparatus 5 is driven to fill molten resin into a cavity in the mold 100A from the nozzle 52, and to press the resin in the cylinder 51 into the mold 100A at a high pressure in order to compensate for a volume decrease due to the resin solidifying. The actual clamping force is measured by the sensor 68. During molding, the mold 100A thermally expands due to the temperature of the mold 100A gradually rising. and there are cases where a difference arises in the initial clamping force and the clamping force after some time has passed. Thus, it is possible to correct the clamping force at the time of the next clamping based on a result of measurement by the sensors 68.

The adjustment of the clamping force is performed by an adjustment of the position of the movable platen 63 in relation to the tie-bar 64 by driving the motor 67. This enables enhancing precision of the clamping force by adjusting the clamping force by correcting the initial value of the position of the movable platen 63 in relation to the tie-bars 64 based on the result of measurement by the sensors 68. The adjustment of the position of the movable platen 63 in relation to the tie-bars 64 can be performed at any timing.

In step S6, the timing of the cooling time for the molded part in the mold 100A is started. In step S12, it is determined whether the cooling of the mold 100A has completed based on whether the cooling time, which started measuring in step S6, has reached a predetermined time. In the case that the cooling completed, the processing in steps S13 and S15 are performed in parallel to the step of S14. Step S12 is an injection molding operation improvement since the cooling occurs before the mold 100A is moved/removed as described below.

Through the above steps of injection preparation (S4), injection dwelling (S5), and cooling (time measurement start and completion judgment) (S6, S12), a first primary molded part is molded. While not illustrated in FIG. 4A, the cooling process of injected resin is performed during a period from a start of the measurement of the cooling time in step S6 to the completion determination in step S12, and is a process in which molten resin is cooled in a mold by a temperature controller (not illustrated) connected to the mold 100A or by air provided from external to the injection molding system 1.

Steps S13-S122 of FIG. 4B illustrate an injection molding operation improvement. In step S13. the movable platen 62 is separated from the fixed platen 61 by driving the motor 66. The fixed mold 101 is fixed to the fixed platen 61 by the fixing mechanisms 610, and the movable mold 102 is fixed to the movable platen 62 by the fixing mechanisms 610. The movable mold 102 separates from the fixed mold 101 and the mold 100A is opened. The first primary molded part remaining on a side of the movable mold 102 of the mold 100A is removed by driving the take-out robot 7 in step S14, and conveyed outside the injection molding system 1. The vacuum head 74 is moved to a position where the chuck plate 75 faces a molded part P, where the molded part P is secured by a suction force. The take-out robot 7 continues to secure the first primary molded part until the first primary molded part is inserted into the mold 100B (Placement), as described below.

In step S15, the movable platen 62 is moved towards the fixed platen 61 by driving the motor 66. This results in the movable mold 102 closely contacting the fixed mold 101, and the mold 100A is closed.

In step S16, the toggle mechanism 65 is driven by driving the motor 66, and the fixed platen 61 and the movable platen 62 clamp the mold 100A. In step S17, mold 100A is prepared for injection. This includes measuring the resin. When the nozzle 52 is separated from the mold 100A, the injection machine 5 is moved by driving the actuator 55 to touch the nozzle 52 to the mold 100A.4

In step S18, injection and dwelling of molten resin is performed. The injection in step S18 is for molding a second primary molded part with the same shape as in step S5.

More specifically, the injecting apparatus 5 is driven to fill molten resin into a cavity in the mold 100A from the nozzle 52, and to press the resin into the mold 100A at a high pressure in order to compensate for a volume decrease due to resin solidifying. Upon the processing of step S18, the actual clamping force is measured by the sensor 68. During molding, the mold 100A thermally expands due to the temperature of the mold 100A gradually rising. In some instances, a difference arises in the initial clamping force and the clamping force after a period of time has passed. Accordingly, it is possible to correct the clamping force at the time of the next clamping based on a result of measurement by the sensors 68.

The adjustment of the clamping force is performed by an adjustment of the position of the movable platen 63 in relation to the tie-bar 64 by driving the motor 67. This enables enhancing precision of the clamping force by adjusting the clamping force by correcting the initial value of the position of the movable platen 63 in relation to the tie-bars 64 base on the result of measurement by the sensors 68. The adjustment of the position of the movable platen 63 in relation to the tie-bars 64 can be performed at any timing.

In step S66, timing of the cooling time of the molded part in the mold 100A is started.

In step S122, it is determined whether the cooling of the mold 100A is completed based on whether the cooling time, which started measuring in step S66, has reached a predetermined time. In the case that the cooling completed, the processing of steps S133 and S155 are performed in parallel to step S144.

Through the above steps of injection preparation (S4), injection dwelling (S5), and cooling (Time measurement start and completion judgment) (S66, S122), the second primary molded part is molded. In the present embodiment, the first and second primary molded parts are molded parts of the same material and shape. While not illustrated, the cooling process of the injected resin is performed from the start of the measurement of the cooling time in step S66 until the completion determination is made in step S122, where the molten resin is cooled in a mold by a temperature controller (not illustrated) connected to the mold 100A or by air provided from external to the injection molding system 1.

Steps S133-S188 of FIG. 4C illustrate an injection molding operation improvement. In step S133, the movable platen 52 is separated from the fixed platen by driving motor 66. The fixed mold 101 is fixed to fixed platen 61 by a fixing mechanism 610 and the movable mold 102 is fixed to the movable platen 62 by a fixed mechanism 610, resulting in the movable mold 102 separating from the fixed mold 101 and the mold 100A is opened.

In step S144, the second primary molded part remaining on a side of the movable mold 102 (in cavity) of the mold 100A is removed by driving the take-out robot 7, and conveyed to an upper area of the molding machine 2 and held in standby. The vacuum head 74 is moved to a position where the chuck plate 75 faces the molded part P, and the molded part P is secured by suction. The take-out robot 7 continues to secure the second primary molded part until the second primary molded part is inserted into the mold 100B (Placement) as described below.

In step S155, the movable platen 62 is approached to the fixed platen 61 by driving the motor 66. With this, the movable mold 102A closely contacts with the fixed mold 101A, and the mold 100A is closed.

In step S166, clamping of the mold 100A by the fixed platen 61 and the movable platen 62 is performed by driving the motor 66 to drive the toggle mechanism 65. In step S177, preparation for injection in relation to the mold 100A is performed. Here, the resin is measured. The actuator 55 is driven to move the injecting apparatus 5, causing the nozzle 52 to touch the mold 100A.

In step S188, injection and dwelling of molten resin is performed. The injection in step $188 is for molding a third primary molded part with the same shape as in step S5.

More specifically, the injecting apparatus 5 is driven to fill molten resin into a cavity in the mold 100A from the nozzle 52, and to press the resin in the cylinder 51 into the mold 100A at a high pressure in order to compensate for a volume decrease due to resin solidifying. Upon the processing of step S188, the actual clamping force is measured by the sensor 68. During molding, the mold 100A thermally expands due to the temperature of the mold 100A gradually rising, wherein in some instances, a difference arises in the initial clamping force and the clamping force after a period of time has passed. Accordingly, it is possible to correct the clamping force at the time of the next clamping based on a result of measurement by the sensors 68.

The adjustment of the clamping force is performed by an adjustment of the position of the movable platen 63 in relation to the tie-bar 64 by driving the motor 67. This enables enhancing precision of the clamping force by adjusting the clamping force by correcting the initial value of the position of the movable platen 63 in relation to the tie-bars 64 based on the result of measurement by the sensors 68. The adjustment of the position of the movable platen 63 in relation to the tie-bars 64 can be performed at any timing.

Next, the processing of steps S19 and S21 are performed in parallel to step S20. In step S19, timing of the time for cooling the molded part in the mold 100A is started. In step S20, processing related to the clamping apparatus 6 is performed. First, locking of the mold 100A by the fixing mechanism 610 is released. After a delay of a predetermined time from step S188, the motor 66 is driven to drive the toggle mechanism 65. This results in removal of the clamping force, and the movable platen 62 slightly separates in relation to the fixed platen 61, and a space enabling alternating the molds is formed.

In step S21, processing related to the injecting apparatus 5 is performed. Here, for example, a dwelling suck back, a nozzle shut-off, a retraction of the injecting apparatus 5, etc., are performed. The dwelling suck back and the nozzle shut-off prevent the molten resin from dripping when the nozzle 52 separates from the mold 100A. These processes can be performed during a delay time prior to causing the movable platen 62 to slightly separate in relation to the fixed platen 61. The dwelling suck back reduces a resin pressure in the injection cylinder 51 and in the mold 100A, when, after the dwelling, the screw 51a retracted. The nozzle shut-off closes the discharge port 52a of the nozzle 52. The described operation enables suppressing leakage of resin.

Through the above steps of injection preparation (S17/S177), injection dwelling (S18/S188), and cooling (Time measurement start and completion judgment), the second and third primary molded parts are molded. While not illustrated, the cooling process of the injected resin is performed during a period from the start of the measurement of the cooling time in step S19 to the completion determining before in the step of S22, and is a process where the molten resin is cooled in a mold by a temperature controller (not illustrated) connected to the mold 100A or by air external to the injection molding system 1.

At least a part of the cooling process of the mold 100A is carried out on the conveying machine 3A instead of at the molding operation position 11. The cooling of the mold 100A is carried out in parallel with at least a part of the process from the alternating the mold in S22 to the alternating the mold in S34, such as, for example, the removal (S14444) of the molded part A in the mold 100B at the molding operation position 11 and the arrangement of the primary molded part (S26) as described below.

In step S22, mold 100A and 100 B are exchanged. The mold 100A is unloaded from the molding operation position 11 to the conveying machine 3A, and the mold 100B is loaded from the conveying machine 3B to the molding operation position 11. The controller 41 transmits an instruction to unload the mold 100A to the controller 42A, and the controller 42A drives the conveyance unit 31 to unload the mold 100A from the molding operation position 11. When unloading completes, a signal indicating unload completion is transmitted from the controller 42A to the controller 41. The mold 100A is cooled on the conveying machine 3A. The self-closing unit 103 maintains the closed state of the mold 100A.

When the signal to indicate loading completion is received, conditions regarding the mold 100B are set as the operation conditions of the molding operation in step S23. The controller 41 reads and sets the operation condition B from the multiple operation conditions (operation conditions A, B, and C), which were set in step S1. For example, the thickness of the mold 100B (the width of the Y direction), the clamping force, etc., are set as the operation conditions of molding for this time. Operation conditions such as an injection speed, etc., corresponding to the mold 100B are also set. A start of measurement of plasticization for the next injection is performed. The motor 66 is driven to cause the fixed platen 61 and the movable platen 62 to closely contact with the mold 100B. At this time, it is not necessary to generate a clamping force that is generated during molding to occur. The mold 100B is secured to each of the fixed platen 61 and the movable platen 62 by driving the fixing mechanism 610.

In the present embodiment, step S23 is performed after step S22. In another exemplary embodiment, because it may take time to switch operation conditions, for example, the operation conditions can be switched simultaneously, for example, with an instruction to unload the mold 100A.

In step S25, the movable platen 62 is separated from the fixed platen 61 by driving the motor 66. The fixed mold 101 is fixed to the fixed platen 61 by the fixing mechanisms 610 and the movable mold 102 is fixed to the movable platen 62 by the fixing mechanisms 610. The movable mold 102 separates from the fixed mold 101, and the mold 100B is opened.

Steps S26-S30 in FIG. 4D illustrate an injection molding operation improvement. In step S26, the first primary molded part is inserted (placement), as in step S14, to a movable tool side of mold 100B by driving the take-out robot 7. In step S27, the movable platen 62 is moved towards the fixed platen 61 by driving the motor 66. The results in the movable mold 102 closely contacting the fixed mold 101, and the mold 100B is closed.

In step S28, clamping of the mold 100B by the fixed platen 61 and the movable platen 62 is performed by driving the motor 66 to drive the toggle mechanism 65. In step S29, preparation for injection in relation to the mold 100B is performed. Here, the actuator 55 is driven to move the injecting apparatus 5, causing the nozzle 52 to touch the mold 100B. Molding of a secondary molded part α occurs in a state where the first primary molded part is placed in the mold 100B, by the steps from S29 to S33 and S36, a resin is injected and overmolded into the first primary molded part to be combined. In the present embodiment, the resin injected to mold the secondary molded part α is a different type of resin from the resin injected to mold the primary molded part. The cooling process of the injected resin is performed from the start of the cooling time measurement at step S666 through step S1222 to the completion determination at step S1333, and is a process in which the molten resin is cooled in a mold by a temperature controller (not illustrated) connected to the mold 100B or by air provided external from the injection molding system 1.

In step S30, injection and dwelling of molten resin is performed. More specifically, the injecting apparatus 5 is driven to fill molten resin into a cavity in the mold 100B from the nozzle 52 and to press the resin in the cylinder 51 into the mold 100B at a high pressure in order to compensate for a volume decrease due to resin solidifying. This results in a secondary molded part α generated by overmolding the first primary molded part. In the process of step 30, the actual clamp force is measured by the sensor 68. During molding, the mold 100AB thermally expands due to the temperature of the mold 100B gradually rising, and there are cases where a difference arises in the initial clamping force and the clamping force after a period of time has passed. Accordingly, it is possible to correct the clamping force at the time of the next clamping based on a result of measurement by the sensors 68. The adjustment of the clamping force is performed by an adjustment of the position of the movable platen 63 in relation to the tie-bar 64 by driving the motor 67. This enables enhancing precision of the clamping force by adjusting the clamping force by correcting the initial value of the position of the movable platen 63 in relation to the tie-bars 64 based on the result of measurement by the sensors 68.

In step S666, timing of the cooling the molded part in the mold 100B is started.

In step S1222, it is determined whether the cooling of the mold 100B is completed based on whether the cooling time, which started measuring in step S666, has reached a predetermined time. In the case that the cooling completed, the processing of step S1333 to step S1555 and the processing of step S1444 are performed in parallel.

The molding of the secondary molded part α is performed by each of the above steps of injection preparation (S29), injection dwelling (S30), and cooling (Time measurement start and completion judgment) (S666, S1222). The cooling process of the injected resin is performed from the start of the measurement of the cooling time in step S666 to the completion determination in step S1222, and is a process in which the molten resin is cooled in a mold by a temperature controller (not illustrated) connected to the mold 100B or by air provided from external to the injection molding system 1.

In step S1333, the movable platen 62 is separated from the fixed platen 61 by driving the motor 66. The fixed mold 101 is fixed to the fixed platen 61 by the fixing mechanisms 610 and the movable mold 102 is fixed to the movable platen 62 by the fixing mechanisms 610. This results in the movable mold 102 separating from the fixed mold 101 and the mold 100B is opened.

Steps S266-S1888 in FIG. 4E illustrate an injection molding operation improvement. In step S1444, the secondary molded part α remaining on a side of the movable mold 102 (in cavity) of the mold 100B is removed by driving the take-out robot 7, and is kept in standby by conveying to the upper area of the injection molding machine 2. The vacuum head 74 is moved to a position at which the chuck plate 75 faces the secondary molded part α, and the secondary molded part α is secured by suction. The take-out robot 7 continues to secure the secondary molded part α from the take-out step (S1444) until the insertion of the secondary molded part α into the mold 100 A (placement) (S26666) is performed as described below.

In step S1555, the motor 66 is driven to move the movable platen 61 closer to the fixed platen 62. As a result, the separated movable mold 102 comes into close contact with the fixed mold 101 again, and the mold 100B is closed.

In step S1666, clamping of the mold 100B by the fixed platen 61 and the movable platen 62 is performed by driving the motor 66 to drive the toggle mechanism 65. In step S1777, preparation for injection in relation to the mold 100B is performed. Here, the actuator 55 is driven to move the injecting apparatus 5, causing the nozzle 52 to touch the mold 100B. Here, the resin is measured. The actuator 55 is driven to move the injecting apparatus 5, causing the nozzle 52 to touch the mold 100B.

In step S1888, injection and dwelling of molten resin is performed. The injection in step S1888 is for molding the secondary molded part β having the same shape as in step S29.

More specifically, the injecting apparatus 5 is driven to fill molten resin into a cavity in the mold 100B from the nozzle 52 and to press the resin in the cylinder 51 into the mold 100B at a high pressure in order to compensate for a volume decrease due to resin solidifying. Upon the processing of step S1888, the actual clamping force is measured by the sensor 68. During molding, the mold 100B thermally expands due to the temperature of the mold 100B gradually rising. In some instances, a difference arises in the initial clamping force and the clamping force after a period of time has passed. Accordingly, it is possible to correct the clamping force at the time of the next clamping based on a result of measurement by the sensors 68. The adjustment of the clamping force is performed by an adjustment of the position of the movable platen 63 in relation to the tie-bar 64 by driving the motor 67. In this way, it is possible to enhance precision of the clamping force by adjusting the clamping force by correcting the initial value of the position of the movable platen 63 in relation to the tie-bars 64 in accordance with the result of measurement by the sensors 68.

Next, the processing of steps S31 and S33 are performed in parallel to step S32. In step S31, timing of the time for cooling the molded part in the mold 100B is started. In step S32, processing related to the clamping apparatus 6 is performed. Securing of the mold 100B by the fixing mechanism 610 is released. After a delay of a predetermined time from step S30, the motor 66 is driven to drive the toggle mechanism 65. This results in removal of the clamping force, the movable platen 62 slightly separates in relation to the fixed platen 61, and a space enabling alternating molds is formed.

In step S33, processing related to the injecting apparatus 5 is performed. Here, for example, a dwelling suck back, a nozzle shut-off, a retraction of the injecting apparatus 5, etc., are performed.

More specifically, the dwelling suck back and the nozzle shut-off prevent the molten resin from dripping when the nozzle 52 separates from the mold 100B. These processes can be performed during a delay time prior to causing the movable platen 62 to slightly separate in relation to the fixed platen 61 in step S32. The dwelling suck back reduces a resin pressure in the injection cylinder 51 and in the mold 100B, when, after the dwelling, the screw 51a is retracted. The nozzle shut-off closes the discharge port 52a of the nozzle 52. The described operation enables suppression of resin leakage. It is possible to improve the precision of the measuring of the resin for the next injection. While the foregoing processing enables preventing the resin from leaking, there are instances where long threadlike resin is generated between the mold 100B and the nozzle 52 due to the structure of the mold or the type of resin. Those instances can be addressed by installing an apparatus for shooting air into the nozzle 52.

In step S34, mold 100B and mold 100A are exchanged. The mold 100B is unloaded from the molding operation position 11 to the conveying machine 3B, and the mold 100A is loaded from the conveying machine 3A to the molding operation position 11. The controller 41 transmits an instruction to unload the mold 100B to the controller 42B, and the controller 42B drives the conveyance unit 31 to unload the mold 100B from the molding operation position 11. When unloading of the mold 100B is completed, a signal indicating unload completion is transmitted from the controller 42B to the controller 41. The mold 100B is cooled on the conveying machine 3B. The self-closing unit 103 maintains the closed state of the mold 100B.

When the signal to indicate loading completion is received, the second set of conditions regarding the mold 100A are set as the operation conditions of the molding operation in step S35. The controller 41 reads and sets the operation conditions B out of the plurality of operation conditions (operation conditions A, B, and C) set in step S1. The difference between the first set of conditions and the second set of conditions of the mold 100A is measurement value, injection speed, dwelling alternating position and dwelling force etc. since the second set of conditions require to mold a primary molded part and a tertiary molded part at the same time. A start of measurement of plasticization for the next injection is performed. The motor 66 is driven to cause the fixed platen 61 and the movable platen 62 to closely contact with the mold 100A. It is not necessary to generate a clamping force that is generated during molding. The mold 100A is secured to each of the fixed platen 61 and the movable platen 62 by driving the fixing mechanism 610.

In the present embodiment, step S35 is performed after step S34. In another exemplary embodiment, because it may take time to switch operation conditions, for example, the operation conditions can be switched simultaneously with, for example, an instruction to unload the mold 100B.

In step S6666, timing of the cooling time of the molded part in the mold 100A is started.

In step S12222, it is determined whether the cooling of the mold 100A completed based on whether the cooling time, which started measuring in step S6666, has reached a predetermined time. In the case that the cooling completed, the processing of step S13333 to step S15555 and the processing of step S14444 are performed in parallel.

In step S13333, the movable platen 62 is separated from the fixed platen 61 by driving the motor 66. The fixed mold 101 is fixed to the fixed platen 61 by the fixing mechanisms 610 and the movable mold 102 is fixed to the movable platen 62 by the fixing mechanisms 610. This enables the movable mold 102 to separate from the fixed mold 101 and the mold 100A is opened. A primary molded part remaining on the side of the movable mold 102 (in cavity) of the mold 100A is removed by driving the take-out robot 7 in step S1444, and conveyed to an upper part of the injection molding machine 2 to and waits there in standby. The vacuum head 74 is moved to a position at which the chuck plate 75 faces a third primary molded part, where the third primary molded part is secured by suction. The take-out robot 7 continues to secure the third primary molded part from the take-out step (S14444) until the insertion (placement) of the third primary molded part into the mold 100B (S 26666) is performed as described below.

FIGS. 4H-4K illustrate an injection molding operation improvement.

In step 26666, secondary molded part α, that is in standby at an upper part of the injection molding machine 2 (step S14444) is inserted (placement) into movable mold 102 side of mold 100A by driving the take-out robot 7.

In step S10000, a flow channel on the tertiary molded part side is released by driving a gate G placed on the fixed side of the mold 100A. This enables resin to fill and dwell in the primary and tertiary molded parts at the same time with a single injection. The gate G can be driven by air, hydraulic pressure, servo, etc.

In step S15555, the movable platen 62 is moved towards the fixed platen 61 by driving the motor 66. This enables the movable mold 102 to closely contact with the fixed mold 101, and the mold 100A is closed.

In step S16666, clamping of the mold 100A by the fixed platen 61 and the movable platen 62 is performed by driving the motor 66 to drive the toggle mechanism 65.

In step S17777, preparation for injection in relation to the mold 100A is performed. Here, the actuator 55 is driven to move the injecting apparatus 5, causing the nozzle 52 to touch the mold 100A.

In step 18888, injection of molten resin and dwelling are performed. The injection in this step S18888 is for molding the tertiary molded part x and the primary molded part n.

More specifically, the injecting apparatus 5 is driven to fill molten resin into a cavity in the mold 100A from the nozzle 52 and to press the resin into the mold 100A at a high pressure in order to compensate for a volume decrease due to resin solidifying. Upon the processing of step S18888, the actual clamping force is measured by the sensor 68. During molding, the mold 100A thermally expands due to the temperature of the mold 100A gradually rising. There are instances where a difference arises in the initial clamping force and the clamping force after a period of time has passed. Accordingly, it is possible to correct the clamping force at the time of the next clamping based on a result of measurement by the sensors 68. The adjustment of the clamping force is performed by an adjustment of the position of the movable platen 63 in relation to the tie-bar 64 by driving the motor 67. In this way, it is possible to enhance precision of the clamping force by adjusting the clamping force by correcting the initial value of the position of the movable platen 63 in relation to the tie-bars 64 in accordance with the result of measurement by the sensors 68.

Next, the processing of steps S19999 and steps S2100Are performed in parallel to step S2000. In step S19999, timing of the time for cooling the molded part in the mold 100A is started. In step S20000, processing related to the clamping apparatus 6 is performed. Securing of the mold 100A by the fixing mechanism 610 is released. After a delay of a predetermined time from step S18888, the motor 66 is driven to drive the toggle mechanism 65. This results in removing the clamping force, and the movable platen 62 is slightly separates in relation to the fixed platen 61, and a space enabling alternating the molds is formed.

In step S21000, processing related to the injecting apparatus 5 is performed. Here, for example, a dwelling suck back, a nozzle shut-off, a retraction of the injecting apparatus 5, etc., are performed.

The dwelling suck back and the nozzle shut-off prevent the molten resin from dripping when the nozzle 52 separates from the mold 100A. These processes can be performed during a delay time prior to causing the movable platen 62 to slightly separate in relation to the fixed platen 61 in step S20000. The dwelling suck back reduces a resin pressure in the injection cylinder 51 and in the mold 100A, when, after the dwelling, the screw 51a is retracted. The nozzle shut-off closes the discharge port 52a of the nozzle 52. This operation enables suppressing leakage of resin and improves the precision of the measuring of the resin for the next injection. The foregoing processing enables preventing the resin from leaking. In some instances, there are cases where long threadlike resin is generated between the mold 100A and the nozzle 52 due to the structure of the mold or the type of resin. An apparatus for shooting air into the nozzle 52 can be installed to prevent this.

Through the above steps of injection preparation (S17777), injection drawling (S18888), and cooling (time measurement start and completion judgment), molding of the tertiary molded part x and primary molded part n performed. The cooling process of the injected resin is performed during a period from the start of the measurement of the cooling time in step S19999 to the completion determining before in the step of S36, and is a process in which the molten resin is cooled in the mold by a temperature controller (not illustrated) connected to the mold 100A or by air provided external from the injection molding system 1.

At least a part of the cooling process of the mold 100A is carried out on the conveying machine 3A and not at the molding operation position 11. The cooling of the mold 100A is carried out in parallel with at least a part of the process from the alternating the mold in S22222 to the alternating the mold in S344, such as, for example, the removal (S144444) of the secondary molded part α in the mold 100B at the molding operation position 11 and the arrangement of the primary molded part (S266666) as described below.

In step S22222, mold 100A and mold 100B are exchanged. The mold 100A is unloaded from the molding operation position 11 to the conveying machine 3A, and the mold 100B is loaded from the conveying machine 3B to the molding operation position 11. The controller 41 transmits an instruction to unload the mold 100A to the controller 42A, and the controller 42A drives the conveyance unit 31 to unload the mold 100A from the molding operation position 11. When unloading of mold 100A is completed, a signal indicating unload completion is transmitted from the controller 42A to the controller 41. The mold 100A is cooled on the conveying machine 3A. The self-closing unit 103 maintains the closed state of the mold 100A.

When the signal to indicate loading completion is received, conditions regarding the mold 100B are set as the operation conditions of the molding operation in step S23333. That is, the controller 41 reads and sets the operation conditions B out of the plurality of operation conditions (operation conditions A, B, and C) set in step S1. For example, the thickness of the mold 100B (the width of the Y direction), the clamping force and the like are set as the operation conditions of the molding operation for this time. Operation conditions such as an injection speed or the like corresponding to the mold 100B are also set. A start of measurement of plasticization for the next injection is performed. The motor 66 is driven to cause the fixed platen 61 and the movable platen 62 to closely contact with the mold 100B. At this time, it is not necessary to generate a clamping force that is generated during molding. The mold 100B is secured to each of the fixed platen 61 and the movable platen 62 by driving the fixing mechanism 610.

In the present embodiment, step S23333 is performed after step S22222 in the embodiment. In another exemplary embodiment, since it may take time to switch operation conditions, for example, the operation conditions can be switched simultaneously, for example, with an instruction to unload the mold 100A.

In step 66666, timing of the cooling time of the part in the mold 100B is started.

In step S122222, it is determined whether the cooling of the mold 100B has completed based on whether the cooling time, which started measuring in step S66666, has reached a predetermined time. When the cooling is completed, the processing in steps 133333 to 155555 and the processing in step 144444 are performed in parallel.

Through the above steps of injection preparation (S17777), injection drawling (S18888), and cooling (time measurement start and completion judgment) (S66666, S122222), molding of the secondary molded part y is performed. The cooling process of the injected resin is performed during a period from the start of the measurement of the cooling time in step S66666 to the completion determining before in the step of S122222, and is a process in which the molten resin is cooled in the mold by a temperature controller (not illustrated) connected to the mold 100B or by air provided from external to the injection molding system 1.

In step S133333, the movable platen 62 is separated from the fixed platen 61 by driving the motor 66. The fixed mold 101 is fixed to the fixed platen 61 by the fixing mechanisms 610 and the movable mold 102 is fixed to the movable platen 62 by the fixing mechanisms 610. This enables separating the movable mold 102 from the fixed mold 101 and the mold 100B is opened. The secondary molded part α remaining on a side of the movable mold 102 (in cavity) of the mold 100B is removed by driving the take-out robot 7 in step S144444, and conveyed to an upper part of the injection molding machine 2 and remains there in standby. The vacuum head 74 is moved to a position where the chuck plate 75 faces the secondary molded part α, and the secondary molded part α is secured by suction. The take-out robot 7 continues to secure the secondary molded part α from the take-out step (S144444) until insertion of the secondary molded part α into the mold 100B (Placement) (S26666) is performed.

In step S155555, the movable platen 62 is moved towards the fixed platen 61 by driving the motor 66. This results in the movable mold 102 closely contacting the fixed mold 101, and the mold 100B is closed.

In step S166666, clamping of the mold 100B by the fixed platen 61 and the movable platen 62 is performed by driving the motor 66 to drive the toggle mechanism 65. In step S177777, preparation for injection in relation to the mold 100B is performed. Here, the actuator 55 is driven to move the injecting apparatus 5, causing the nozzle 52 to touch the mold 100B.

In step S188888, injection and dwelling of molten resin is performed. The injection in step S188888 is for molding the secondary molded part y having the same shape as in step S177.

More specifically, the injecting apparatus 5 is driven to fill molten resin into a cavity in the mold 100B from the nozzle 52 and to press the resin at a high pressure in order to compensate for a volume decrease due to resin solidifying. Upon the processing of step S188888, the actual clamping force is measured by the sensor 68. During molding, the mold 100B thermally expands due to the temperature of the mold 100B gradually rising, and there are cases where a difference arises in the initial clamping force and the clamping force after a period of time has passed. Accordingly, it is possible to correct the clamping force at the time of the next clamping based on a result of measurement by the sensors 68. The adjustment of the clamping force is performed by an adjustment of the position of the movable platen 63 in relation to the tie-bar 64 by driving the motor 67. In this way, it is possible to enhance precision of the clamping force by adjusting the clamping force by correcting the initial value of the position of the movable platen 63 in relation to the tie-bars 64 in accordance with the result of measurement by the sensors 68.

Next, the processing of steps S311 and S333 are performed in parallel to step S322. In step S311, timing of the time for cooling the molded part in the mold 100B is started. In step S322, processing related to the clamping apparatus 6 is performed. Securing of the mold 100B by the fixing mechanism 610 is released. After a delay of a predetermined time from step S17777, the motor 66 is driven to drive the toggle mechanism 65. This results in removal of the clamping force, the movable platen 62 is slightly separates in relation to the fixed platen 61, and a space enabling exchanging of molds is formed.

In step S333, processing related to the injecting apparatus 5 is performed. Here, for example, a dwelling suck back, a nozzle shut-off, a retraction of the injecting apparatus 5 or the like are performed.

The dwelling suck back and the nozzle shut-off prevent the molten resin from dripping when the nozzle 52 separates from the mold 100B. These processes can be performed during a delay time prior to causing the movable platen 62 to slightly separate in relation to the fixed platen 61 in step S32. The dwelling suck back reduces a resin pressure in the injection cylinder 51 and in the mold 100B after the dwelling when the screw 51a is caused to retract. The nozzle shut-off closes the discharge port 52a of the nozzle 52. This operation enables suppressing leakage of resin and improving the precision of the measuring of the resin for the next injection. The foregoing processing enables preventing the resin from leaking. There are situations where long threadlike resin is generated between the mold 100B and the nozzle 52 due to the structure of the mold or the type of resin. An apparatus for shooting air into the nozzle 52 can be installed to prevent this.

In step S344, exchanging mold 100B for mold 100A is performed. The mold 100B is unloaded from the molding operation position 11 to the conveying machine 3B, and the mold 100A is loaded from the conveying machine 3A to the molding operation position 11. The controller 41 transmits an instruction to unload the mold 100B to the controller 42B, and the controller 42B drives the conveyance unit 31 to unload the mold 100B from the molding operation position 11. When unloading of mold 100B is completed, a signal indicating unload completion is transmitted from the controller 42B to the controller 41. The mold 100B is cooled on the conveying machine 3B. The self-closing unit 103 maintains the closed state of the mold 100B.

When the signal to indicate loading completion is received, a second set of conditions regarding the mold 100A is set as the operation conditions of the molding operation in step S355. The controller 41 reads and sets the operation conditions B from among the plurality of operation conditions (operation conditions A, B, and C) set in step S1. The difference between the first set of conditions and the second set of conditions of the mold 100A is measurement value, injection speed, dwelling alternating position and dwelling force etc. as the second set of conditions require to mold a primary molded part and tertiary molded part at the same time. A start of measurement of plasticization for the next injection is performed. The motor 66 is driven to cause the fixed platen 61 and the movable platen 62 to closely contact with the mold 100A. At this time, it is not necessary to generate a clamping force that is generated during molding. The mold 100A is secured to each of the fixed platen 61 and the movable platen 62 by driving the fixing mechanism 610.

In the present embodiment, step S355 is performed after step S344. In another exemplary embodiment, because it may take time to switch operation conditions, for example, the operation conditions may be switched simultaneously, for example, with an instruction to unload the mold 100B.

In step S36, it is determined whether the cooling of the mold 100A completed based on whether the cooling time, which started measuring in step S36, has reached a predetermined time. In a case that the cooling completed, the processing of step S37 to step S39 and the processing of step S38 are performed in parallel.

In step S37, the movable platen 62 is separated from the fixed platen 61 by driving the motor 66. The fixed mold 101 is fixed to the fixed platen 61 by the fixing mechanisms 610, and the movable mold 102 is fixed to the movable platen 62 by the fixing mechanisms 610. This results in the movable mold 102 separating from the fixed mold 101 and the mold 100A is opened. The molded part remaining on a side of the movable mold 102 of the mold 100A is removed by driving the take-out robot 7 in step S38, and conveyed external to the injection molding system 1. The vacuum head 74 is moved to a position at which the chuck plate 75 faces the tertiary molded part x, and the primary molded part n and are secured via a suction force. The completed removed parts are separated from the tertiary molded part x and primary molded part n secured by the suction force. The tertiary molded part x is set on a belt conveyor (not illustrated) or directly loaded into a storage location, e.g., box, (not illustrated) by the take-out robot 7.

In step S39, the number of molded parts produced as of this step is compared against an expected production volume TH. The number of molded parts produced is stored so far is stored in a ROM or RAM (not illustrated). The production volume TH is a target production volume set in step S1.

In a case where the number of the molded part is less than the expected production volume TH, the processing returns to step S26666, and the above described processing is repeated. In other words, the processing proceeds to insertion/injection/dwelling/ of primary molded parts for mold 100A and mold 100B, and exchanging of mold 100A and mold 100B are carried out.

When the number of molded parts reaches the expected production volume TH, the process ends.

The tertiary molded part x is removed by a holding section 74C in a state where a holding section 74A of the take-out robot 7 holds the primary molded part n and a holding section 74B holds the secondary molded part y.

An example of an exemplary embodiment of the above-described process where tertiary molded parts x1, x2, x3 and x4 are completed in this order will now be provided. As described above, not only before a first tertiary molded part (for example, x1.) is completed, the process of molding a primary molded part n1 and a secondary molded part y2 for a second tertiary molded part (for example, x2.) to be completed after the first tertiary molding x1 is completed has started, but also a primary molding n2 and the secondary molded part y2 for x2 have already been completed. Injection is also performed on primary parts n3 and y3 for x3. If the transition from step S39 to step S26666 is considered, at step S26666, the secondary molded part y2 for x2 is removed at step S144444 after step S26666. In other words, the secondary molded part for x2 is completed before taking out x1.

### Mold Behavior

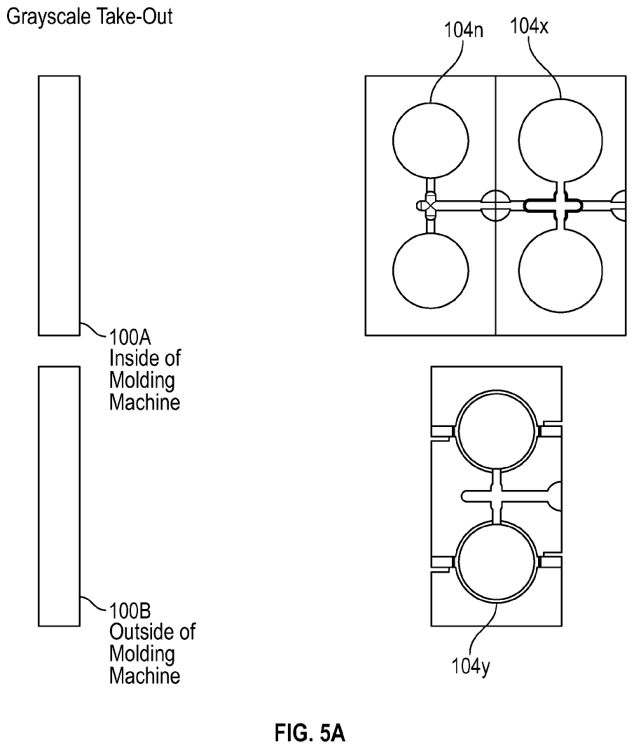

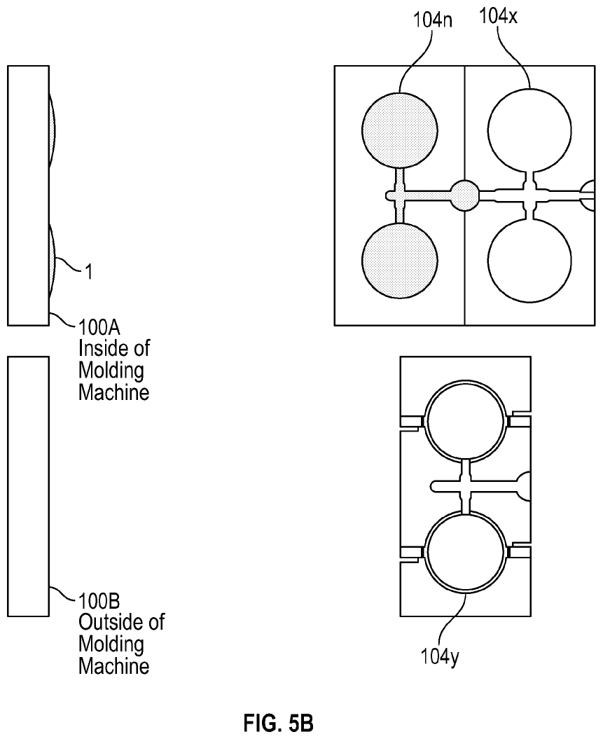

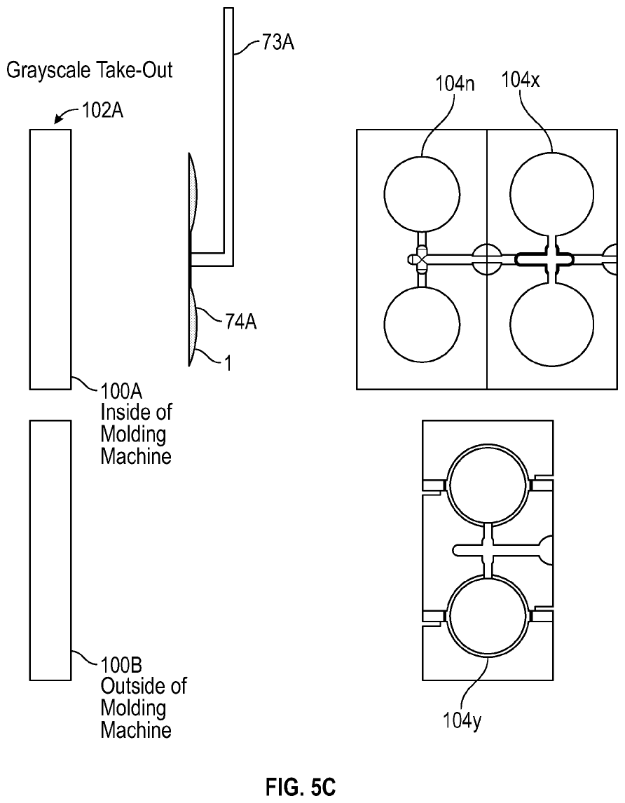

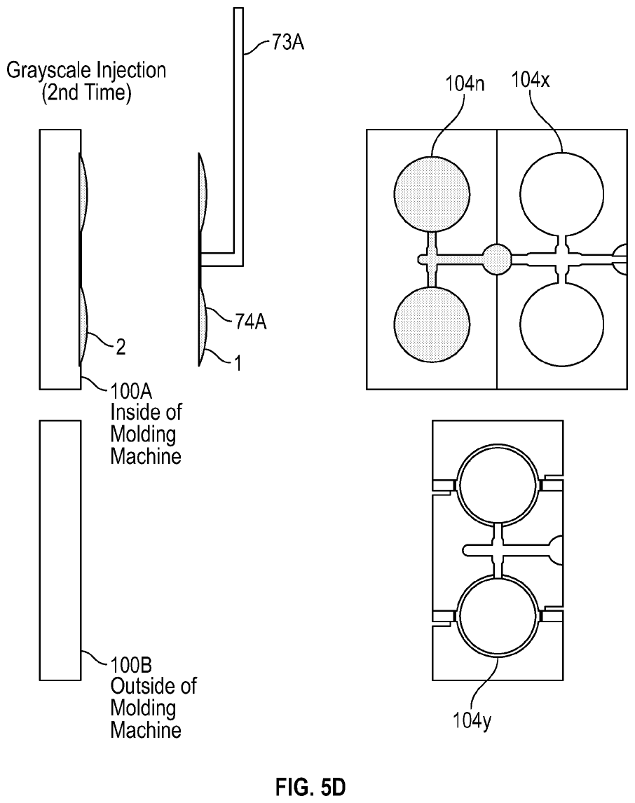

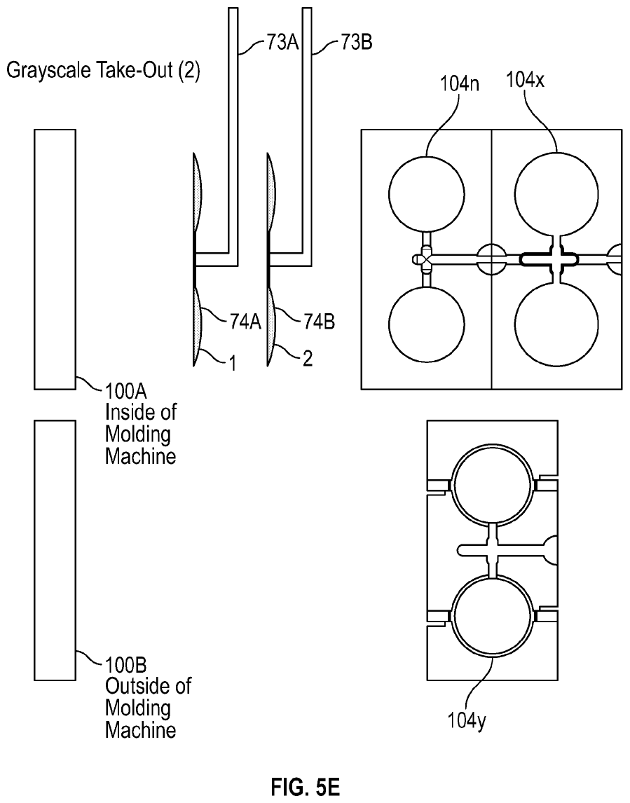

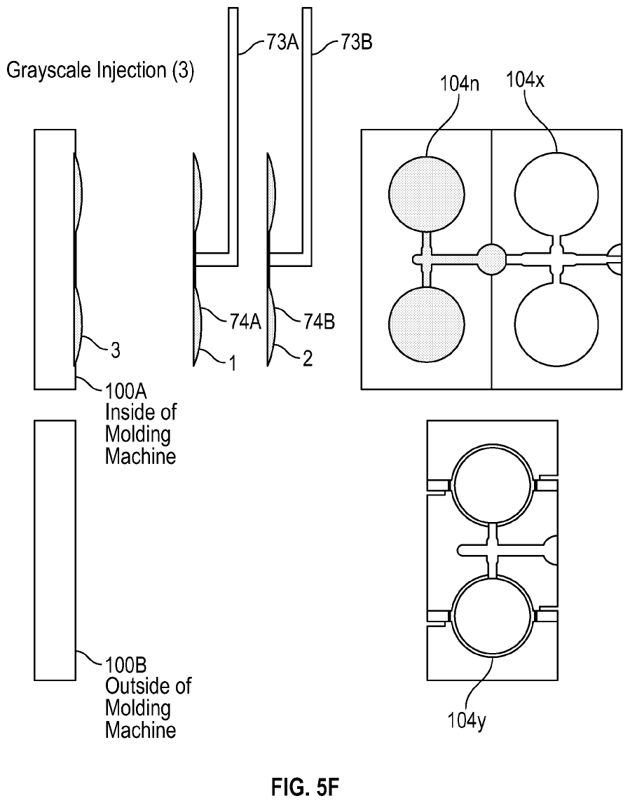

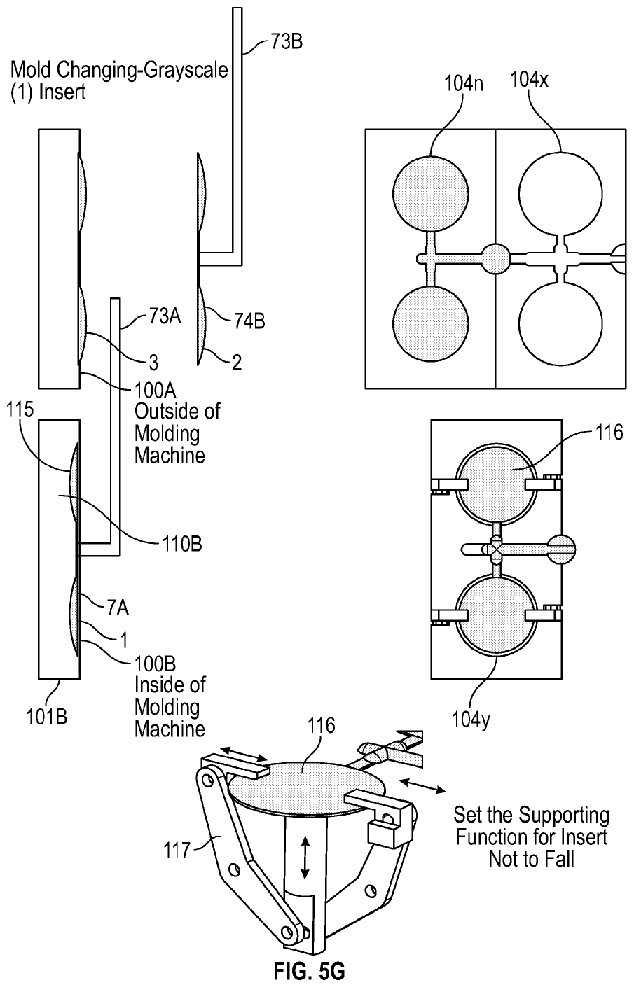

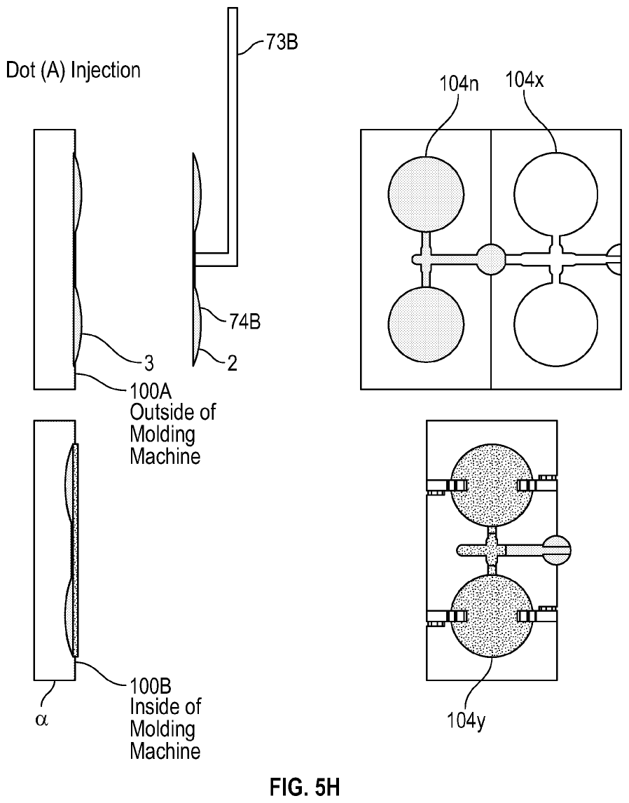

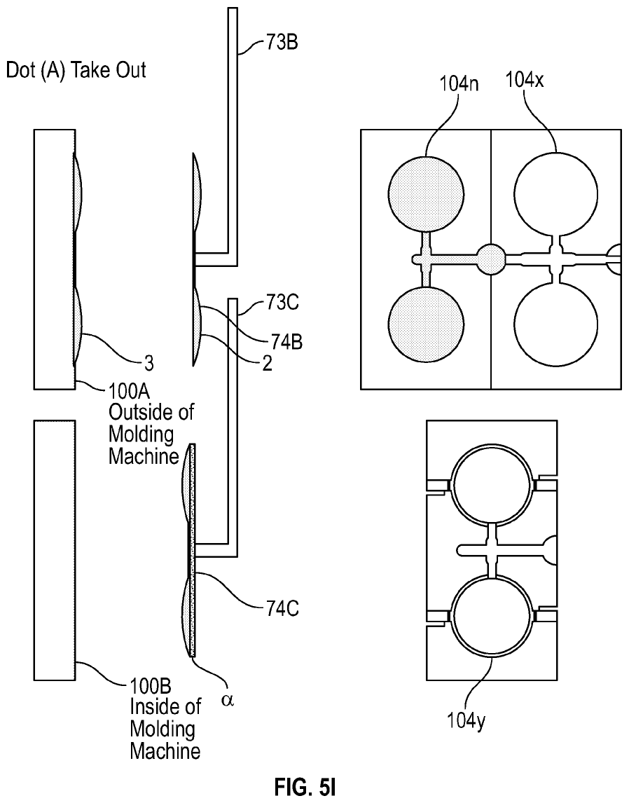

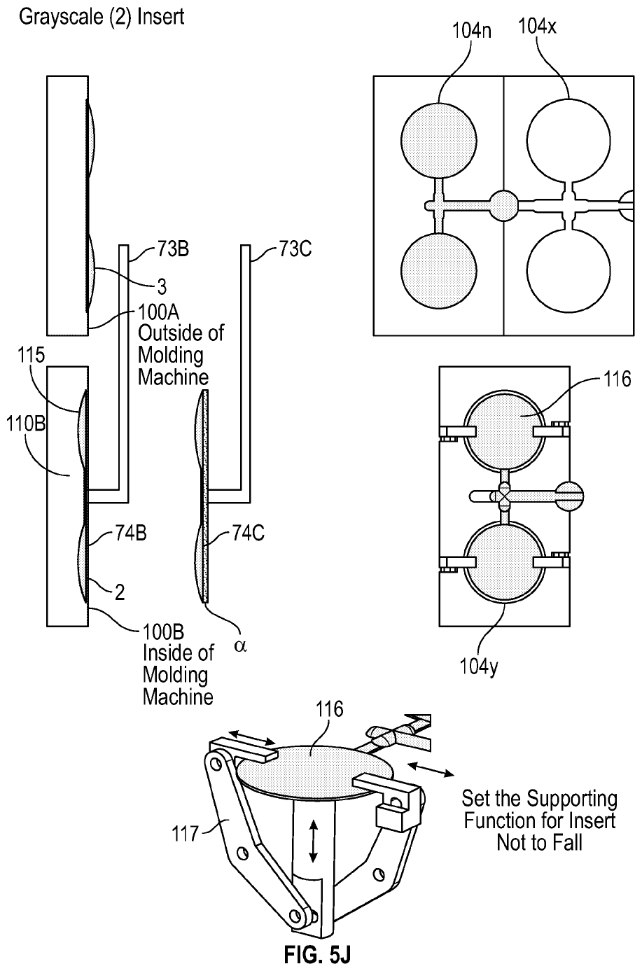

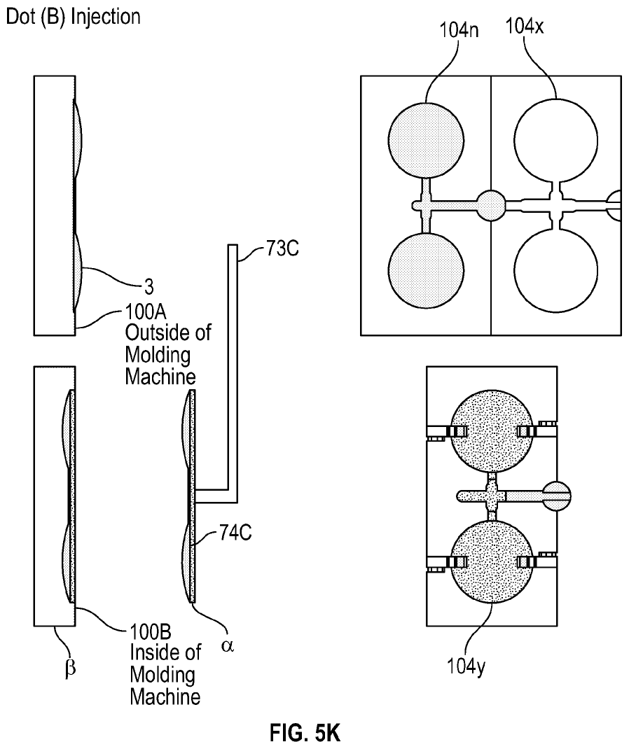

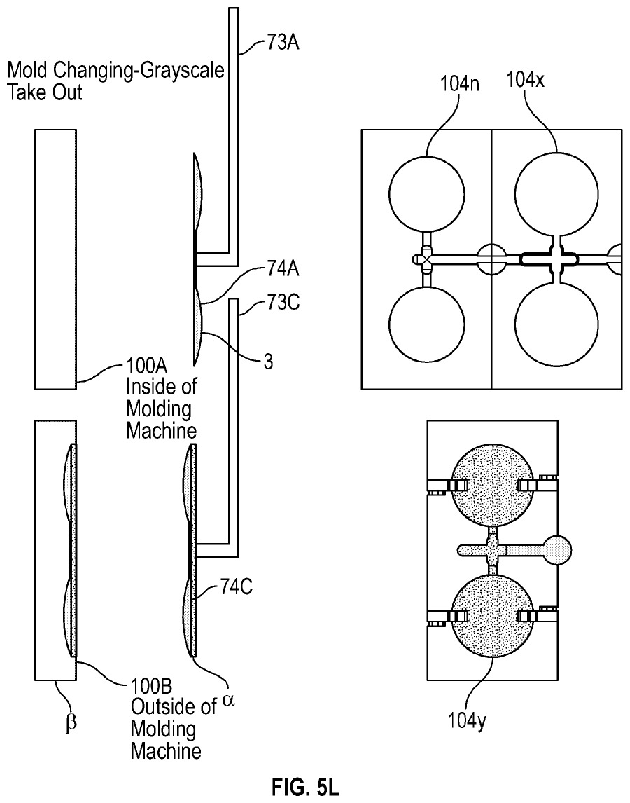

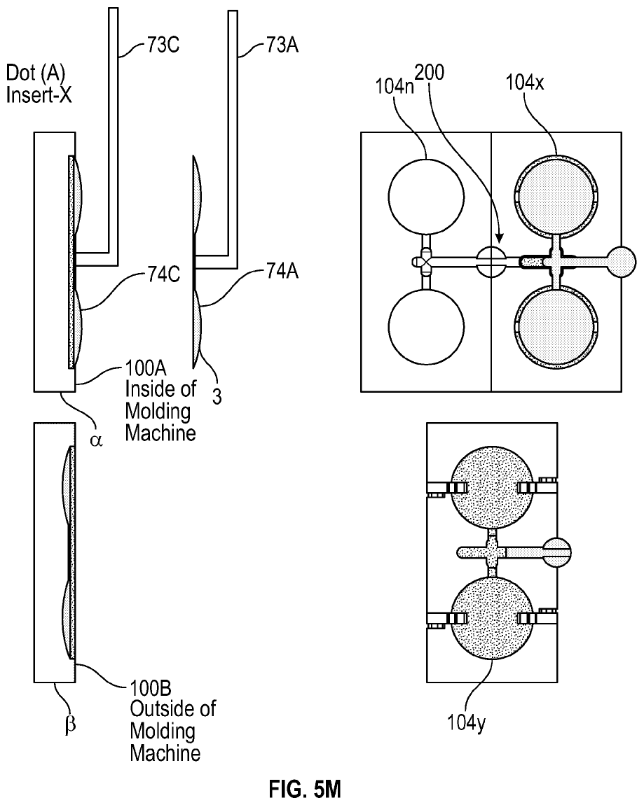

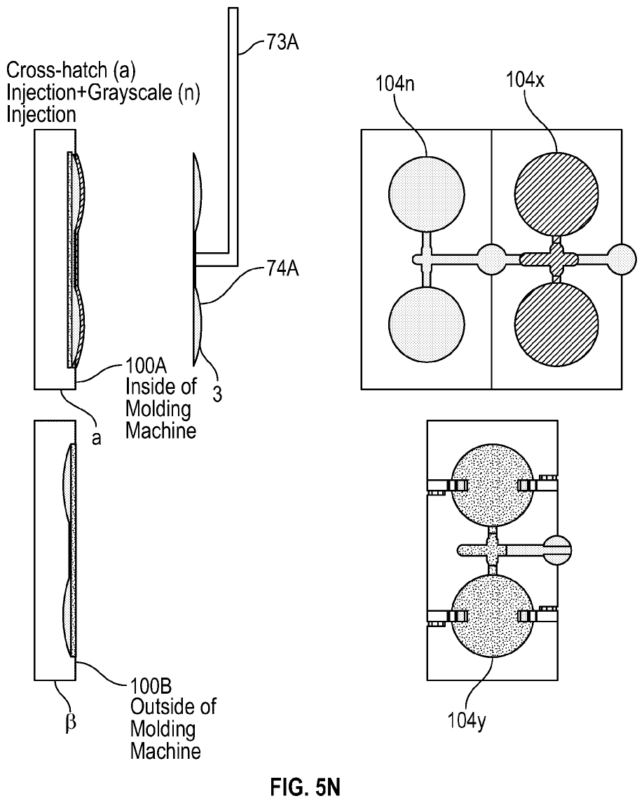

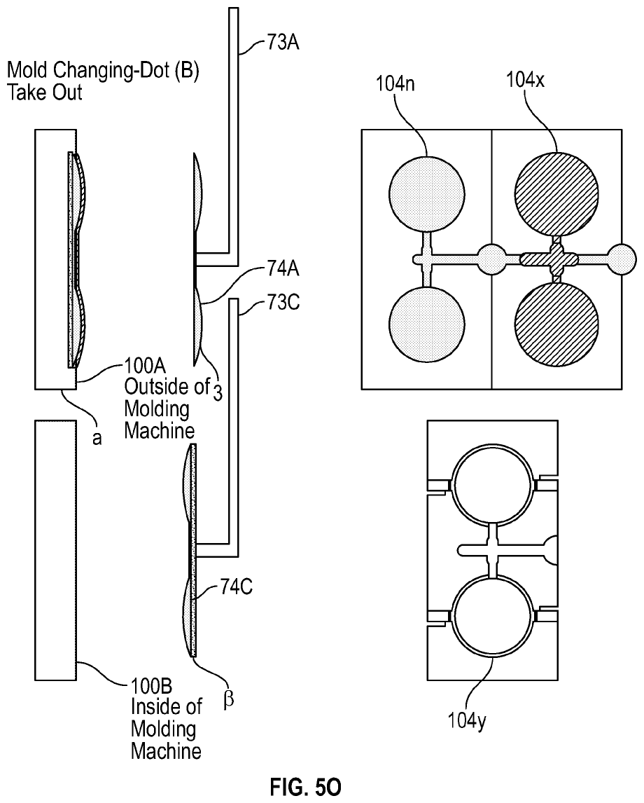

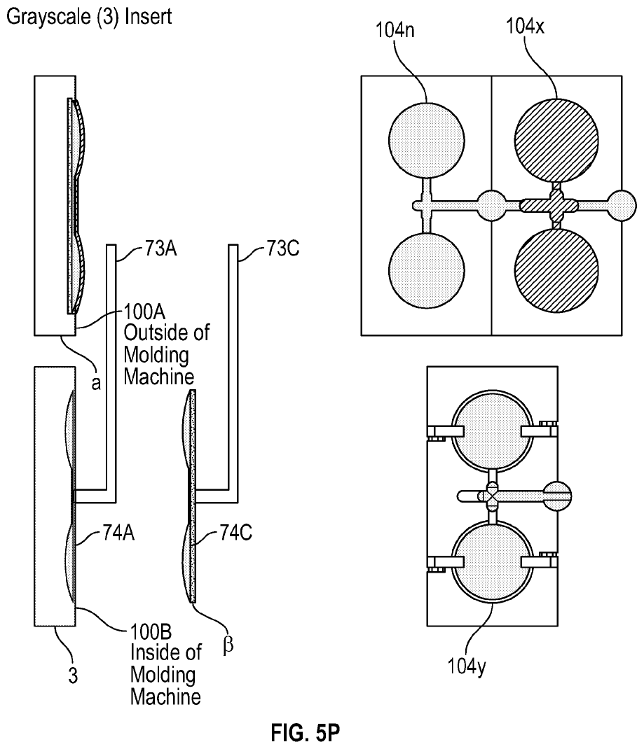

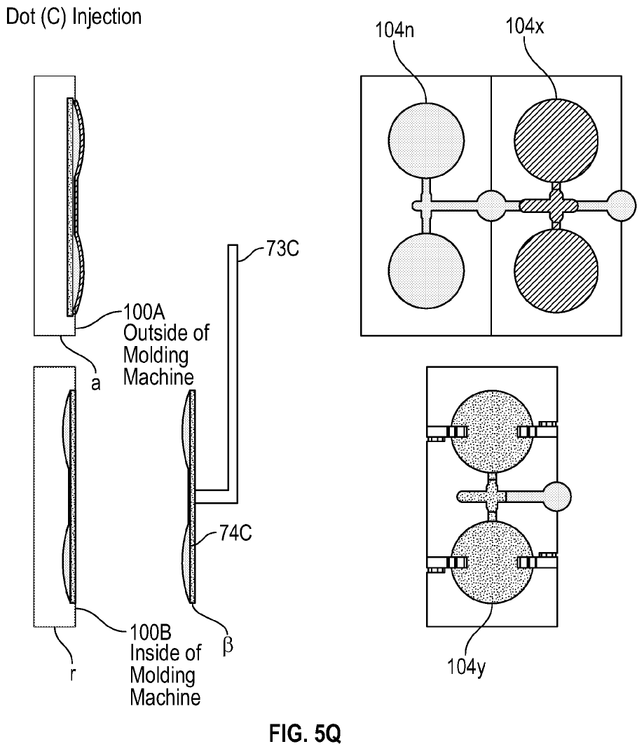

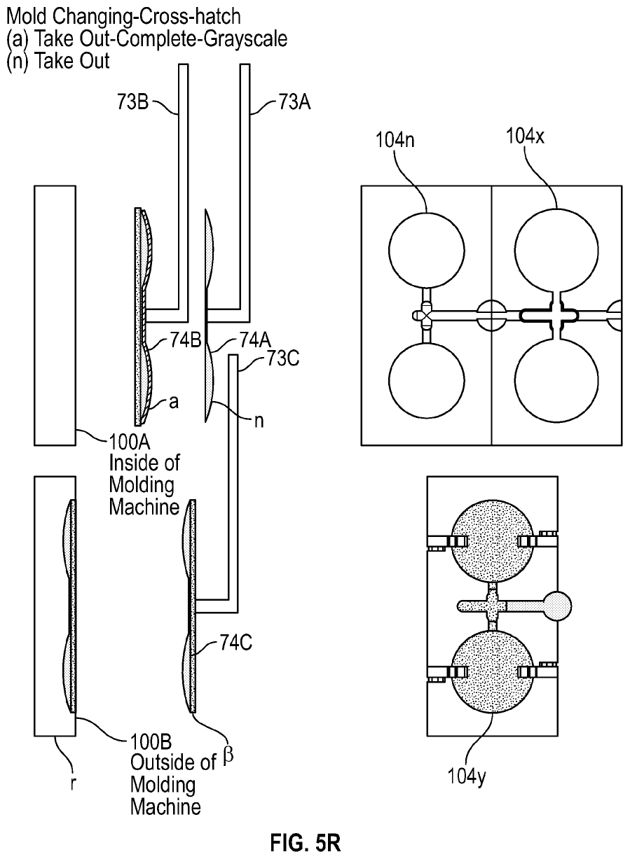

FIGS. 5A-5R illustrate a molding process with a configuration of molds from primary to tertiary molded parts using an injection molding system that implements the process of FIGS. 4A-4K.

According to the exemplary embodiment, a primary molded part is referred to as the primary molded part 1, the primary molded part 2, and the primary molded part 3 based on the order in which the primary molded part is generated. When it is not necessary to specify which primary molding is referred to, primary molded part n will be used.

According to the exemplary embodiment, a secondary molded part is a molded part generated by additionally performing an injection process on the primary molded part n. The secondary molded part is referred to as a secondary molded part α and a secondary molded part β based on the generation order. When it is not necessary to specify which secondary molded part is referred to, secondary molded part y will be used.

According to the exemplary embodiment, the tertiary molded part is a molded part generated by additionally performing an injection process on the secondary molded part y. The tertiary molded part is referred to as the tertiary molded part x.

FIGS. 5A-5R are sectional views of the molds 100A and 100B and a cavity shape on the movable mold 102 side.

FIG. 5A illustrates a cross section of the mold 100A parallel to the YZ plane and a plane view of the movable mold 102 in the negative Y-axis direction. When the mold 100A is located in the injection molding machine 2, the mold opening direction is the positive Y-axis direction, the direction in which the mold 100A is removed to the conveying machine 3A side is the negative X-axis direction, and the vertical direction is the positive Z-axis direction.

The mold 100A is a mold for molding a primary molded part 1 (n) and a tertiary molded part x, described below, and comprises a movable mold 102, a cavity 104n corresponding to the primary molded part 1, and a cavity 104x corresponding to the tertiary molded part 3. The cavities 100n and 104x of the mold 104A have convex shapes in the XZ plane, respectively. The cavity of the movable mold 102 also has a planar shape, and has an arbitrary lens shape in the cavities 104n and 104x. The cavity 104x can accept a secondary molded part α (y), described below, and after the mold is closed, the secondary molded part α (y) can be overmolded to form a tertiary molded part x.

The mold 100B is a mold for molding the secondary molded part α (x) and is composed of a cavity 104x corresponding to the secondary molded part α. The fixed cavity 104y of the mold 100B has a convex shape in the XZ plane. The cavity of the movable mold 102 has a planar shape and has an arbitrary lens shape in the cavity 104y.

The cavity 104y can accept the primary molding 1 (n), and after the mold is closed, the primary molding 1 (n) can be overmolded to form the secondary molded part α (y).

FIG. 5A illustrates a closed state of the mold 100A and a mold configuration of step S1 to step S4 of FIG. 4A. The fixed mold 101 has a projection part 131 corresponding to the curved surface 105 of the primary molded part 1 (n) and a projection part 106 corresponding to the curved surface 132 of the tertiary molding x. The curved surfaces 105 and 106 can be of any lens shape.

On the other hand, the movable mold 102 has a planar shape.

FIG. 5B illustrates a state in which the molten resin is poured into the cavity 104n of the mold 100A for manufacturing the primary molded part 1 (n) and a mold configuration of the molds in step S5 to step S12 of FIG. 4A. The primary molded part 1 is constituted in mold 100A.

FIG. 5C illustrates a state in which the mold 100A is opened and the lift shaft 73A of the take-out robot 7 enters the mold 100A and a series of operations of step S14 of FIG. 4B. The primary molded part 1 (n) is secured by a holding part (chuck) 74A connected to an elevating shaft 73A of the take-out robot 7 and is removed from a movable mold 102. The holding part 74A is holding a part of a gate part of the primary molding 1 (n) that uses suction force. As described below, before the gate is placed in the mold 100B (insert), the gate is temporarily placed in a dedicated location and the direction in which the gate of the holding portion 74A is held is changed. A system other than a vacuum type system can be used for the holding section 74A.

In addition to vertical movement as described above, the take-out machine 7 of the present embodiment has a rotation mechanism 73 capable of rotating at least the holding portion 74A at least 180 degrees in an axial direction by rotating the elevating shaft 78 around the axis. The rotating mechanism 78 can also be provided with a mechanism for moving the elevating shaft 73A or the holding portion 74A up and down (z-axis direction) or a mechanism for moving the elevating shaft 73A or the holding portion 74A to the right and left (y-axis direction, mold clamping/mold opening direction).

As described below, the rotation mechanism is used for arranging the primary molded 1 removed from the movable mold 102 on the movable mold 102, and in view of the purpose thereof, it is sufficient if at least the holding portion 74A can be rotated about an axis in a direction parallel to the surfaces (XZ Plane) of the platens 61 and 62 of the injection molding machine 2 by 180 degrees.

The rotation mechanism 78 and the vertical and horizontal movement mechanisms are controlled by a control unit of the take-out machine 7, where the control unit is controlled by the controller unit 41 of the injection molding system 1.

FIG. 5D illustrates a state in which the molten resin is poured into the cavity 104n of the mold 100A for manufacturing the primary molded part 2 (n), and is an embodiment of a mold in steps S15 to S122 of FIG. 4B. The primary molded part 2 is configured in the mold 100A. At the time, the primary molded part 1 described in step S14 is held by the holding portion 74A and is in standby at the upper part of the injection molding machine 2.

FIG. 5E illustrates the state in which the lift shaft 73B of the take-out robot 7 is placed into the mold 100A by opening the mold 100A and a series of operations associated with step S144 of FIG. 4C. The primary molded part 2 (n) is secured with suction force by a holding part (chuck) 74B connected to an elevating shaft 73B of the take-out machine 7 and is removed from a movable mold 102.

FIG. 5F illustrates the state in which the molten resin is poured into the cavity 104n of the mold 100A for manufacturing the primary molded part 3 (n), and it is an embodiment of the mold in the steps S155 to S177 of FIG. 4E. The primary molded 3 is configured in the mold 100A. At the time, the primary molded parts 1 and 2 are held by the holding parts 74A and 74B and are stored at the upper part of the injection molding machine 1.

FIG. 5G illustrates the open state of the mold 100B and the state in which the holding portion 74A holding the primary molded part 1 enters the mold 100B (inserted state). This state illustrates a series of operations in step S26 of FIG. 4D.

A part 116 of a plane of the primary molded part 1 is inserted into an insert holding machine 117 of a movable mold 102 to perform positioning and arrangement of the primary molded part 1 in a recessed part (cavity) of the movable mold 102.

The movable mold 102 forms a part of the cavity 110 of the secondary molded part, and the recessed 110B for arranging (insert) the primary molded 1 and the projection 115 of the primary molded part 1 are fitted. The fixed mold 101 forms a part of the cavity 110 and is configured in a planar shape.

FIG. 5H illustrates the state where the secondary molded part α is overmolded in the movable mold 102 of the mold 100B and the resin injected (overmold) in a state in which the primary molded part 1 is inserted to configure the secondary molded part α (y). This state illustrates a series of operations in steps S27 to S1222 in FIG. 4D.

FIG. 5I illustrates the state in which the mold 100B is opened and the lift shaft 73C of the take-out robot 7 is inserted into the mold 100B, and the series of operations in step S1444 of FIG. 4E is described. The secondary molded part α (y) is held with a suction force by a holding section (chuck) 74C connected to the elevating shaft 73C of the take-out robot 7, and is removed from the movable mold 102.

FIG. 5J illustrates an open state of the mold 100B, and the state in which the holding portion 74 A holding the primary molded part 2 is inserted into the mold 100B (inserted state). The series of operations in step S266 of FIG. 4E is illustrated.

A part 116 of the plane of the primary molded part 2 is inserted into an insert holding machine 117 of the movable mold 102 to perform positioning and arrangement of the primary molded part 2 in a recessed part (cavity) of the movable mold 102.

The movable mold 102 forms a part of the cavity 110 of the secondary molded part, and the recess 110B for arranging (insert) the primary molded part 2 and the projection 115 of the primary molded part 1 are fitted. The fixed mold 101 forms a part of the cavity 110 and is configured in a planar shape.

FIG. 5K illustrates a case where the secondary molded part β (y) is overmolded in the movable mold 102 of the mold 100B, and the resin is injected (overmold) in a state in which the primary molded part 2 (n) is inserted to configure the secondary molded part β (y). The series of operations in step S155 to S1888 in FIG. 4E is described.

FIG. 5L illustrates a state where the mold 100A is opened and the lift shaft 73A of the take-out robot 7 is inserted into the mold 100A. The primary molded part 3 (n) is held with a suction force by a holding section (chuck) 74A connected to the elevating shaft 73A of the take-out robot 7. The series of operations in step S14444 in FIG. 4G is illustrated.

FIG. 5M illustrates the state where the mold 100A is opened, and the secondary molded part α (y) is inserted into the holding portion 74AC of mold 100B (inserted state). The series of operations in step S26666 of FIG. 4K is described.

Positioning and arrangement of a part of the secondary molded part α(y) to a recessed area (cavity) of movable mold 102 of primary molded part 3 is achieved by vacuuming and sucking from a side of movable mold 102.

A gate 200 is switched by 180° to enable overmolding to the secondary molded part α (y). This enables molding the primary molded part and the tertiary molded part simultaneously. The switching can be performed by air, hydraulic pressure, servo, etc.

FIG. 5N illustrates the state where the tertiary molded part x is overmolded in the movable mold 102 of the mold 100A, and the resin is injected (overmold) in a state where the second molded part α (y) is inserted to configure the tertiary molded part x. One of the cavities is filled with the primary molded part n. The series of operations in step S15555 to S18888 in FIG. 4K is illustrated.

One result of the present exemplary embodiment is the ability to efficiently manufacture a thick lens by two insert-molding operations.

FIG. 5O illustrates the state in which the mold 100B is opened and the lift shaft 73C of the take-out robot 7 is inserted into the mold 100B, and the series of operations in step S144444 of FIG. 4I is illustrated. The secondary molded part β (y) is held with a suction force by a holding section (chuck) 74C connected to the elevating shaft 73C of the take-out robot 7, and is removed from the movable mold 102.

FIG. 5P illustrates the state in which the mold 100B is opened, in which the holding portion 74A holding the primary molded part 3 is inserted into the mold 100B (inserted state). The series of operations in step S26666 of FIG. 4I is illustrated.

FIG. 5Q illustrates the state where the secondary molded part y is overmolded in the movable mold 102 of the mold 100B, and the resin is injected (overmold) in a state where the primary molded part n is inserted to configure the secondary molded part y. The series of operations in step S155555 to S188888 in FIG. 4I and 4K is illustrated.

FIG. 5R illustrates an open state of the mold 100A where the tertiary molded part x and the primary molded part n are ejected. The tertiary molded part x is held by a suction force to the holding part 74B, and the primary molded part n is held by a suction force to a holding part 74A. Both the tertiary molded part x and the primary molded part n are conveyed external to the mold 100A at the same time and divided into a tertiary molded part and a primary molded part by a cutting mechanism (not illustrated) with a gate cutting function. The tertiary molded part is unloaded external to injection molding machine 2 and loaded on a belt conveyor (not illustrated) or the like. This completes a thick molded part. The primary molded part n held by the suction force to the holding portion 74C is held at an upper part of the injection molding machine 2 until it is inserted into the mold 100B.

Since a plurality of thick lens molded part x can be manufactured in parallel while the molds 100A and 100B are loading/unloading into/from the injection molding machine 2 by the conveying machine 3A and the conveying machine 3B, the idling time of the injection molding machine 2 can be reduced, and efficient manufacturing can be realized.

In another exemplary embodiment with an injection molding system including the conveying machine 3A and the conveying machine 3B is used, the process of waiting the primary molded parts α1 and α2 while being held by the holding portions 74A and 7B of the take-out robot 7 at an upper part of the injection molding machine 2 may not be performed. The primary molded parts α1 and α2 can be removed by the take-out robot 7 and temporarily placed in a storage location, e.g., a box, provided external to the injection molding machine 2 for storing primary molded parts.

In an exemplary embodiment, the mold 100A and the mold 100B can be connected to each other via, for example, a linking part. In another exemplary embodiment, the mold 100A and the mold 100B can be an integrated unit. For example, the fixed mold 102 of the mold 100A and the fixed mold 102 of the mold 100 B can be integrated.

While an example of a two-time overmolding operation has been provided, a single or more than two overmolding operation can be performed.

### Mold Parts Manufacturing

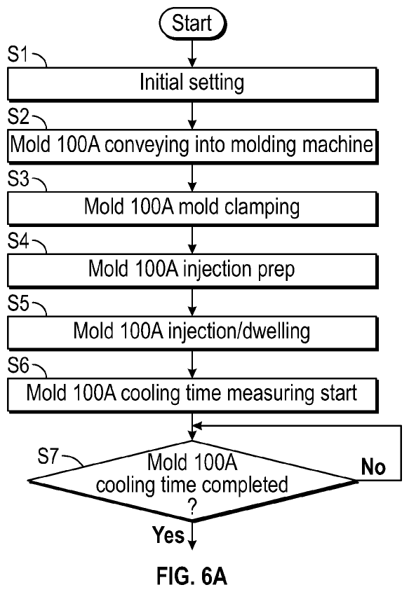

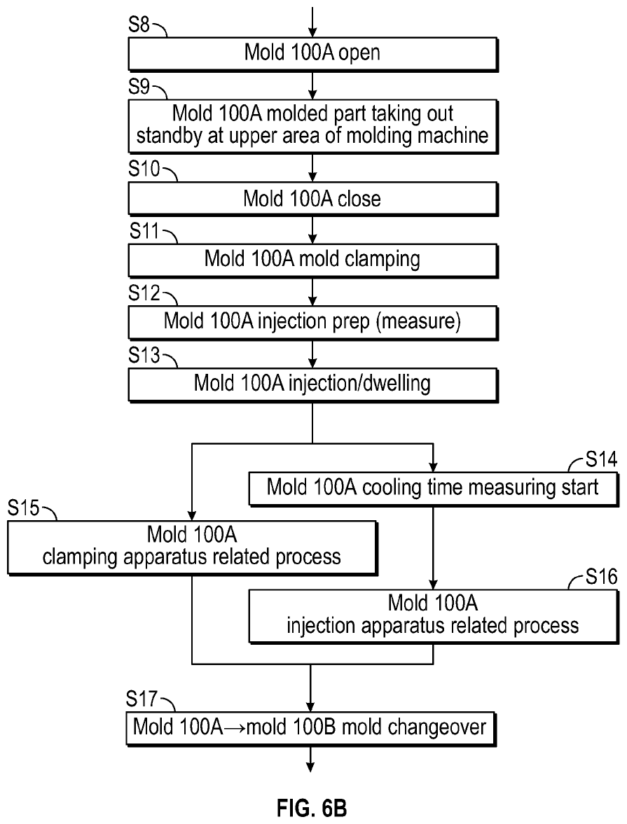

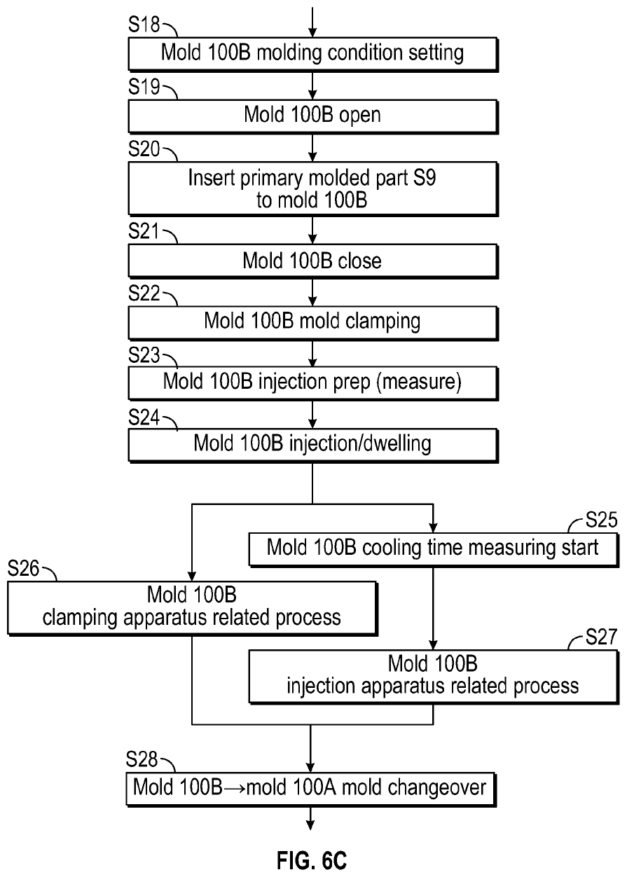

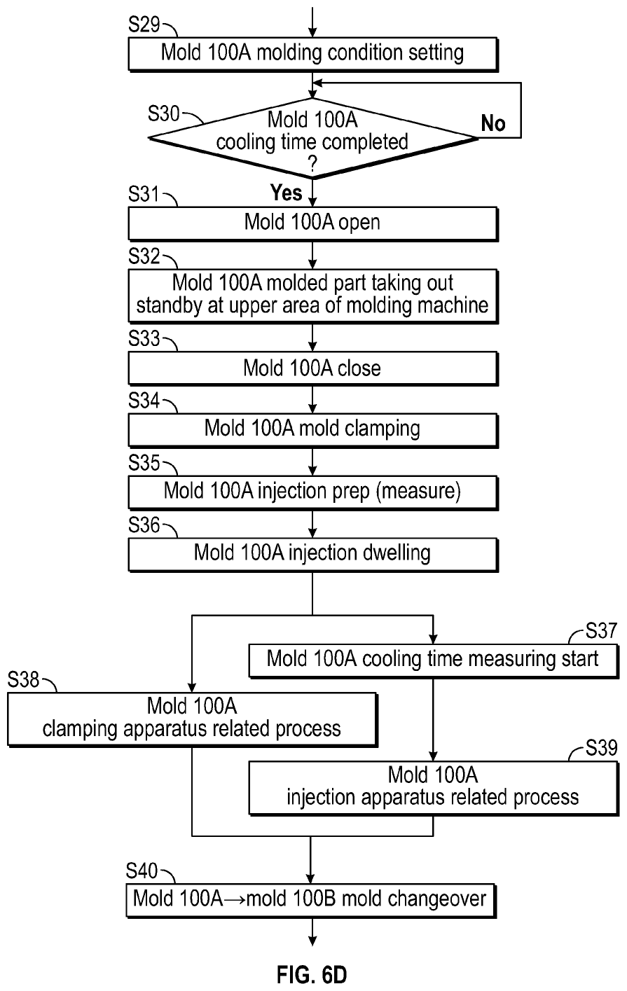

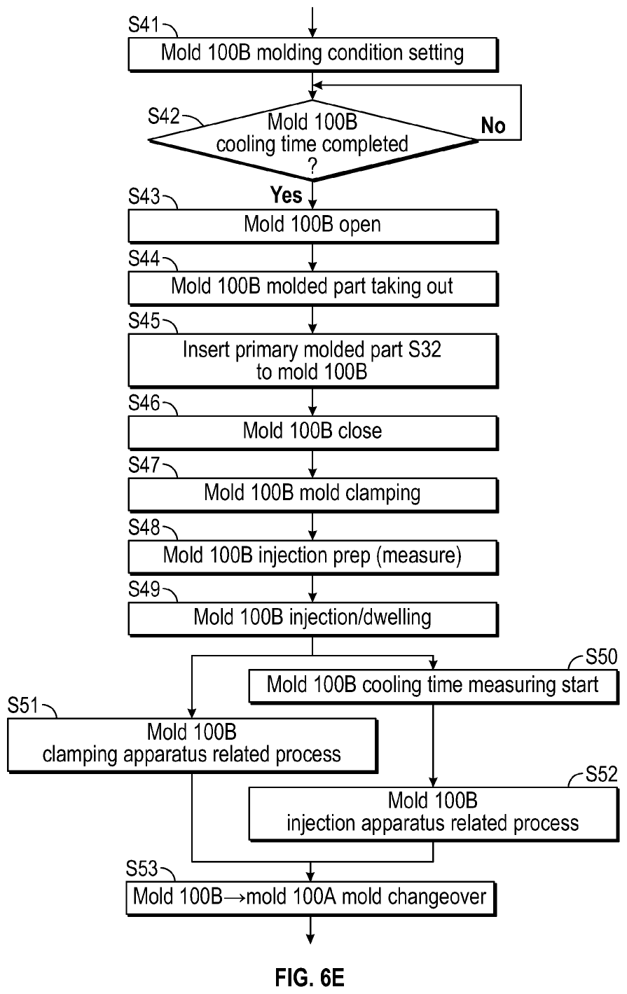

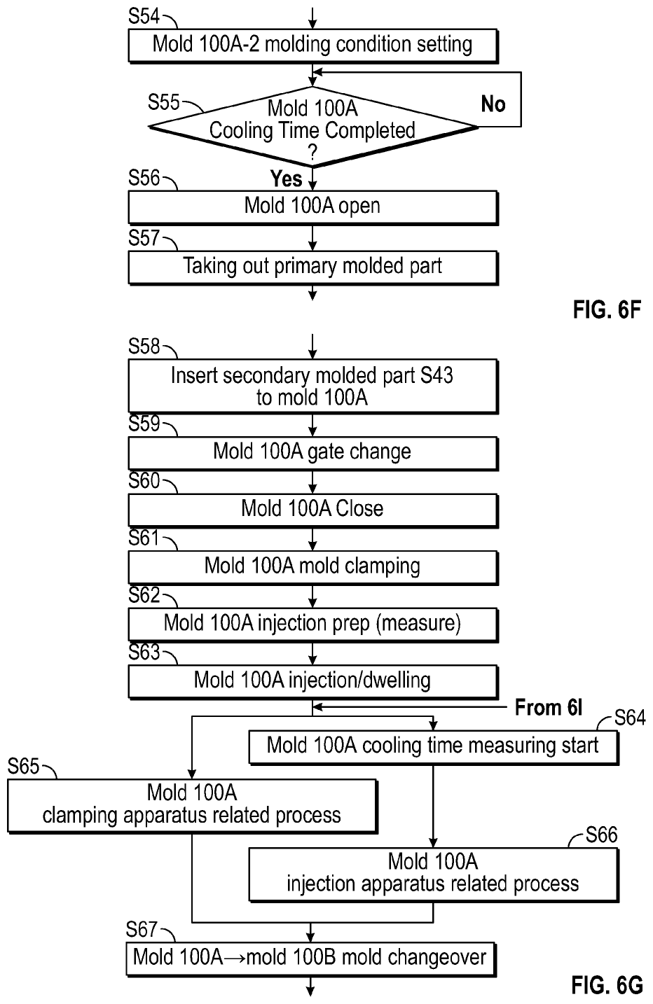

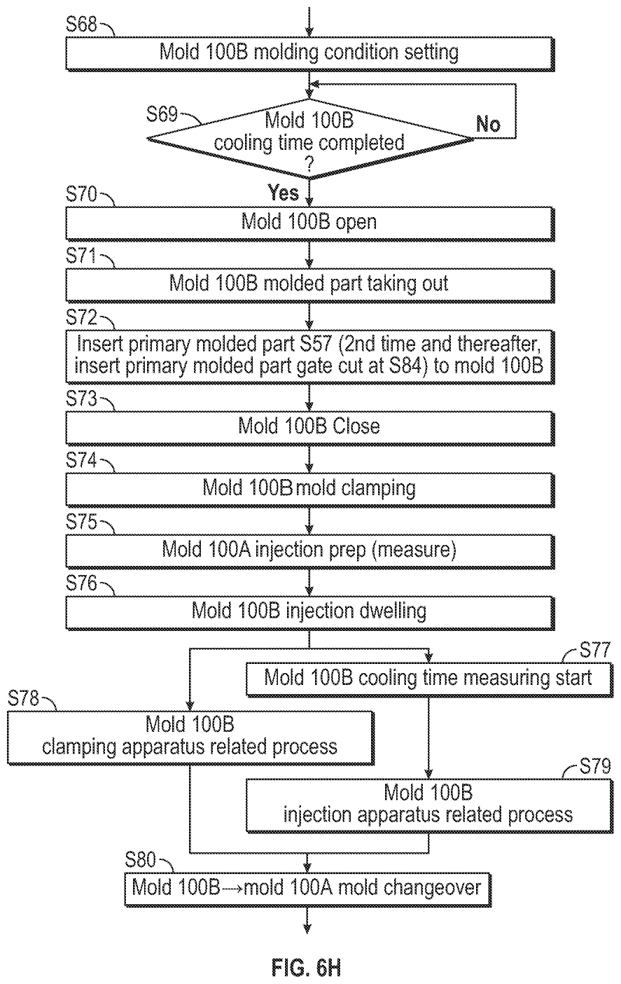

FIGS. 6A-6I provide an example of operation of the injection molding system 1. In the following example, a case in which a molding operation is performed where mold 100A and mold 100B are exchanged.

FIGS. 6A-6F illustrate a flowchart illustrating a molding process. An initial setting is performed in step S1. For each of mold 100A and mold 100B, operation conditions of the injecting apparatus 5 and the clamping apparatus 6 are registered. For example, these are the amount of resin that is injected in one time, the temperature, the injection speed, the clamping force, the initial value of the position of the movable platen 63 in relation to the tie-bars 64, etc. These conditions can differ or be the same for the mold 100A and the mold 100B.

The mold 100A is used as the first molding operation, where the conditions related to the mold 100A are automatically set as the first operation conditions. The initial heating of the injection cylinder 51 and measuring plasticizing of the resin and the like are started. As described below, even in the case of the operation conditions for the mold 100A, the operation conditions for molding a primary molded part n can be different from the operation conditions for molding the primary molded part n and a tertiary molded part x.

In step S1, the controller 41 sets each of the operation conditions A for forming the primary molded part n using the mold 100A, the operation conditions B for forming the secondary molded part y using the mold 100B, and the operation conditions C for forming the primary molded part n and the tertiary molded part x using the mold 100A.

In step S2, the mold 100A is conveyed into the injection molding machine 2. The motor 66 is driven to cause the space between the fixed platen 61 and the movable platen 62 to become slightly wider than the thickness of the mold 100A (the width in the Y direction). Next, the controller 41 transmits an instruction to load the mold 100A to the controller 42A, and the controller 42A drives the conveyance unit 31 to load the mold 100A into the molding operation position 11. When loading completes, a signal indicating load completion is transmitted from the controller 42A to the controller 41. When the signal indicating load completion is received, the motor 66 is driven to cause the fixed platen 61 and the movable platen 62 to closely contact with the mold 100A. At this time, it is not necessary to generate a clamping force that is generated during molding. to occur. The mold 100A is also secured to each of the fixed platen 61 and the movable platen 62 by driving the fixing mechanisms 610.

In step S3, clamping of the mold 100A by the fixed platen 61 and the movable platen 62 is performed by driving the motor 66 to drive the toggle mechanism 65. In step S4, preparation for injection in relation to the mold 100A is performed. Here, the actuator 55 is driven to move the injecting apparatus 5, causing the nozzle 52 to touch the mold 100A.

In step S5, injection and dwelling of molten resin is performed. More specifically, the injecting apparatus 5 is driven to fill molten resin into a cavity in the mold 100A from the nozzle 52, and to press the resin at a high pressure in order to compensate for a volume decrease due to resin solidifying. During molding, the mold 100A thermally expands due to the temperature of the mold 100A gradually rising. There are cases where a difference arises in the initial clamping force and the clamping force after a period of time has passed. Accordingly, it is possible to correct the clamping force at the time of the next clamping based on a result of measurement by the sensors 68. The adjustment of the clamping force is performed by an adjustment of the position of the movable platen 63 in relation to the tie-bar 64 by driving the motor 67. In this way, it is possible to enhance precision of the clamping force by adjusting the clamping force by correcting the initial value of the position of the movable platen 63 in relation to the tie-bars 64 in accordance with the result of measurement by the sensors 68.

In step S6, timing of the cooling time of the part in the mold 100A is started. In step S7, it is determined whether the cooling of the mold 100A completed based on whether the cooling time, which started measuring in step S6, has reached a predetermined time.

Through the above steps of injection preparation (S4), injection dwelling (S5), and cooling (time measurement start and completion judgment), a first primary molded part is molded. The cooling process of the injected resin is performed during a period from the start of the measurement of the cooling time in step S6 to the completion determining before in the step of S7, and is a process where the molten resin is cooled in the mold 100A by a temperature controller (not illustrated) connected to the mold 100A or by air provided from external to the injection molding system 1.

In step S8, the movable platen 62 is separated from the fixed platen 61 by driving the motor 66. The fixed mold 101 is fixed to the fixed platen 61 by the fixing mechanisms 610 and the movable mold 102 is fixed to the movable platen 62 by the fixing mechanisms 610. This results in the movable mold 102 separating from the fixed mold 101 and the mold 100A is opened. A primary molded part remaining on the side of the movable mold 102 (in cavity) of the mold 100A is removed by driving the take-out robot 7 in step S9, and conveyed to an upper part of the injection molding machine 2 where is remains in standby. The take-out robot 7 continues to secure the first primary molded part from the take-out process (S9) until the insertion (placement) (S20) of the first primary molded part into the mold 100B is performed as described below.

In step S10, the movable platen 62 is moved toward the fixed platen 61 by driving the motor 66. The enables the movable mold 102 to closely contact with the fixed mold 101, and the mold 100A is closed.

In step S11, clamping of the mold 100A by the fixed platen 61 and the movable platen 62 is performed by driving the motor 66 to drive the toggle mechanism 65. In step S12, preparation for injection in relation to the mold 100A is performed. Here, the actuator 55 is driven to move the injecting apparatus 5, causing the nozzle 52 to touch the mold 100A.

In step S13, injection and dwelling of molten resin is performed. The injection in step S13 is for molding a second primary molded part having the same shape as in step S5.

More specifically, the injecting apparatus 5 is driven to fill molten resin into a cavity in the mold 100A from the nozzle 52 and to press the resin at a high pressure in order to compensate for a volume decrease due to resin solidifying. Upon the processing of step S13, the actual clamping force is measured by the sensor 68. During molding, the mold 100A thermally expands due to the temperature of the mold 100A gradually rising. There are instances where a difference arises in the initial clamping force and the clamping force after a period of time has passed. Accordingly, it is possible to correct the clamping force at the time of the next clamping based on a result of measurement by the sensors 68. The adjustment of the clamping force is performed by an adjustment of the position of the movable platen 63 in relation to the tie-bar 64 by driving the motor 67. In this way, it is possible to enhance precision of the clamping force by adjusting the clamping force by correcting the initial value of the position of the movable platen 63 in relation to the tie-bars 64 in accordance with the result of measurement by the sensors 68. The adjustment of the position of the movable platen 63 in relation to the tie-bars 64 may be performed at any timing.

Next, the processing of step S14 and step S16 are performed in parallel to the processing of step S15. In step S14, timing of the time for cooling the molded part in the mold 100A is started. In step S15, processing related to the clamping apparatus 6 is performed. Securing of the mold 100A by the fixing mechanism 610 is released. After a delay of a predetermined time from step S13, the motor 66 is driven to drive the toggle mechanism 65. This results in removal of the clamping force and the movable platen 62 slightly separates in relation to the fixed platen 61, and a space where mold 100A and mold 100B can be exchanged is formed.

In step S16, processing related to the injecting apparatus 5 is performed. Here, for example, a dwelling suck back, a nozzle shut-off, a retraction of the injecting apparatus 5 or the like are performed.

The dwelling suck back and the nozzle shut-off prevent the molten resin from dripping when the nozzle 52 separates from the mold 100A. These processes can be performed during a delay time prior to causing the movable platen 62 to slightly separate in relation to the fixed platen 61 in step S15. The dwelling suck back reduces a resin pressure in the injection cylinder 51 and in the mold 100A when, after the dwelling, the screw 51a is retracted. The nozzle shut-off closes the discharge port 52a of the nozzle 52. This operation enables suppressing leakage of resin and improving the precision of the measuring of the resin for the next injection. The foregoing processing enables preventing the resin from leaking. There are instances where long threadlike resin is generated between the mold 100A and the nozzle 52 due to the structure of the mold or the type of resin. An apparatus for shooting air into the nozzle 52 can be installed to prevent this.

In step S17, mold 100A is exchanged with mold 100B. The mold 100A is unloaded from the molding operation position 11 to the conveying machine 3A, and the mold 100B is loaded from the conveying machine 3B to the molding operation position 11. The controller 41 transmits an instruction to unload the mold 100A to the controller 42A, and the controller 42A drives the conveyance unit 31 to unload the mold 100A from the molding operation position 11. The mold 100B is moved from the conveying machine 3B to the molding operation position 11. When unloading of the mold 100A completes, a signal indicating unload completion is transmitted from the controller 42A to the controller 41. The mold 100A is cooled on the conveying machine 3A. The self-closing unit 103 maintains the closed state of the mold 100A.

When the signal to indicate loading completion is received, conditions regarding the mold 100B are set as the operation conditions of the molding operation in step S18. That is, the controller 41 reads and sets the operation conditions B from among the multiple operation conditions (operation conditions A, B, and C) set in S1. For example, the thickness of the mold 100B (the width of the Y direction), the clamping force and the like are set as the operation conditions of the molding operation for this time. Operation conditions such as an injection speed or the like corresponding to the mold 100B are set. A start of measurement of plasticization for the next injection is performed. The motor 66 is driven to cause the fixed platen 61 and the movable platen 62 to closely contact with the mold 100B. At this time, it is not necessary to generate a clamping force that is generated during molding. The mold 100B is secured to each of the fixed platen 61 and the movable platen 62 by driving the fixing mechanism 610.

In the above-described embodiment, step S18 is performed after step S17. In another exemplary embodiment, because it may take time to switch operation conditions, for example, the operation conditions can be switched simultaneously with an instruction to unload the mold 100A.

In step S19, the movable platen 62 is separated from the fixed platen 61 by driving the motor 66. The fixed mold 101 is fixed to the fixed platen 61 by the fixing mechanisms 610, and the movable mold 102 is fixed to the movable platen 62 by the fixing mechanisms 610. This results in the movable mold 102 separating from the fixed mold 101, and the mold 100B is opened. In step S20, the first primary molded part located in standby in step S9 is inserted (placement) to the mold 100B by driving the take-out robot 7.

In step S21, the movable platen 62 is moved towards the fixed platen 61 by driving the motor 66. This results in the movable mold 102 closely contacting the fixed mold 101B, and the mold 100B is closed.

In step S22, clamping of the mold 100B by the fixed platen 61 and the movable platen 62 is performed by driving the motor 66 to drive the toggle mechanism 65. In step S23, preparation for injection in relation to the mold 100B is performed. The actuator 55 is driven to move the injecting apparatus 5, causing the nozzle 52 to touch the mold 100B. A secondary molded part a is molded in a state where the first primary molded part is placed in the mold 100B, by step S24, a resin is injected and overmolded into the primary molded part to be combined.

Next, the processing of step S25 and step S27 are performed in parallel to the processing of step S26. In step S25, timing of the time for cooling the molded part in the mold 100B is started. In step S26, processing related to the clamping apparatus 6 is performed. Securing of the mold 100B by the fixing mechanism 610 is released. After a delay of a predetermined time from step S24, the motor 66 is driven to drive the toggle mechanism 65. This results in releasing the clamping force and the movable platen 62 is slightly separates in relation to the fixed platen 61, and a space where exchanging mold 100B and mold 100A is formed.

In step S27, processing related to the injecting apparatus 5 is performed. Here, for example, a dwelling suck back, a nozzle shut-off, a retraction of the injecting apparatus 5 or the like are performed.

In step S28, exchanging of mold 100B and mold 100A is performed. The mold 100B is unloaded from the molding operation position 11 to the conveying machine 3B, and the mold 100A is loaded from the conveying machine 3A to the molding operation position 11. The controller 41 transmits an instruction to unload the mold 100B to the controller 42B, and the controller 42B drives the conveyance unit 31 to unload the mold 100B from the molding operation position 11. The mold 100A is moved from the conveying machine 3A to the molding operation position 11. When unloading of mold 100B completes, a signal indicating unload completion is transmitted from the controller 42B to the controller 41. The mold 100B is cooled on the conveying machine 3B. At this time, the self-closing unit 103 maintains the closed state of the mold 100B.

When the signal to indicate loading completion is received, conditions regarding the mold 100A are set as the operation conditions of the molding operation in step S29. That is, the controller 41 reads and sets the operation conditions out of the multiple operation conditions (operation conditions A, B, and C) set in S1. For example, the thickness of the mold 100A (the width of the Y direction), the clamping force and the like are set as the operation conditions of the molding operation for this time. Operation conditions such as an injection speed or the like corresponding to the mold 100A is set. A start of measurement of plasticization for the next injection is performed. The motor 66 is driven to cause the fixed platen 61 and the movable platen 62 to closely contact with the mold 100A. At this time, it is not necessary to generate a clamping force that is generated during molding. The mold 100A is secured to each of the fixed platen 61 and the movable platen 62 by driving the fixing mechanism 610.

In step S30, it is determined whether the cooling of the mold 100A completed based on whether the cooling time, which started measuring in step S14, has reached a predetermined time.

In step S31, the movable platen 62 is separated from the fixed platen 61 by driving the motor 66. The fixed mold 101 is fixed to the fixed platen 61 by the fixing mechanisms 610 and the movable mold 102 is fixed to the movable platen 62 by the fixing mechanisms 610. This results in the movable mold 102 separating from the fixed mold 101 and the mold 100A is opened.

In step S32, a second primary molded part remaining on a side of the movable mold 102 (in cavity) of the mold 100A is removed by driving the take-out robot 7, and placed in standby by conveying to an upper area of injection molding machine 2. The take-out robot 7 continues to secure the second primary molded part from the take-out step (S32) until the insertion of a second secondary molded part into the mold 100B (placement) (S45) is performed as described below.

In step S33, the movable platen 62 is moved towards the fixed platen 61 by driving the motor 66. This results in the movable mold 102 closely contacting the fixed mold 101, and the mold 100A is closed.

In step S34, clamping of the mold 100A by the fixed platen 61 and the movable platen 62 is performed by driving the motor 66 to drive the toggle mechanism 65. In step S35, preparation for injection in relation to the mold 100A is performed. Here, the actuator 55 is driven to move the injecting apparatus 5, causing the nozzle 52 to touch the mold 100A.

In step S36, injection and dwelling of molten resin is performed. The injection in step S36 is for molding a third primary molded part having the same shape as in step S5. More specifically, the injecting apparatus 5 is driven to fill molten resin into a cavity in the mold 100A from the nozzle 52 and to press the resin at a high pressure in order to compensate for a volume decrease due to resin solidifying. Upon the processing of step S35, the actual clamping force is measured by the sensor 68. During molding, the mold 100A thermally expands due to the temperature of the mold 100A gradually rising. There are instances where a difference arises in the initial clamping force and the clamping force after a period of time has passed. Accordingly, it is possible to correct the clamping force at the time of the next clamping based on a result of measurement by the sensors 68. The adjustment of the clamping force is performed by an adjustment of the position of the movable platen 63 in relation to the tie-bar 64 by driving the motor 67. In this way, it is possible to enhance precision of the clamping force by adjusting the clamping force by correcting the initial value of the position of the movable platen 63 in relation to the tie-bars 64 in accordance with the result of measurement by the sensors 68. The adjustment of the position of the movable platen 63 in relation to the tie-bars 64 may be performed at any timing.

Next, the processing of step S37 and step S39 are performed in parallel to the processing of step S38. In step S37, timing of the time for cooling the molded part in the mold 100A is started. In step S38, processing related to the clamping apparatus 6 is performed. Securing of the mold 100A by the fixing mechanism 610 is released. After a delay of a predetermined time from step S36, the motor 66 is driven to drive the toggle mechanism 65. This results in removal of clamping force and the movable platen 62 slightly separates in relation to the fixed platen 61, and a space where mold 100A and mold 100B can be exchanged is formed.

In step S39, processing related to the injecting apparatus 5 is performed. Here, for example, a dwelling suck back, a nozzle shut-off, a retraction of the injecting apparatus 5 or the like are performed.

In step S40, exchanging of mold 100A and mold 100B is performed. The mold 100A is unloaded from the molding operation position 11 to the conveying machine 3A, and the mold 100B is loaded from the conveying machine 3B to the molding operation position 11. The controller 41 transmits an instruction to unload the mold 100A to the controller 42A, and the controller 42A drives the conveyance unit 31 to unload the mold 100A from the molding operation position 11. The mold 100B is moved from the conveying machine 3B to the molding operation position 11. When unloading of mold 100A completes, a signal indicating unload completion is transmitted from the controller 42A to the controller 41. The mold 100A is cooled on the conveying machine 3A. The self-closing unit 103 maintains the closed state of the mold 100A.

When the signal to indicate loading completion is received, conditions regarding the mold 100B are set as the operation conditions of the molding operation in step S40. That is, the controller 41 reads and sets the operation conditions from among the multiple operation conditions (operation conditions A, B, and C) set in S1. For example, the thickness of the mold 100B (the width of the Y direction), the clamping force and the like are set as the operation conditions of the molding operation for this time. Operation conditions such as an injection speed or the like corresponding to the mold 100B are set. A start of measurement of plasticization for the next injection is performed. The motor 66 is driven to cause the fixed platen 61 and the movable platen 62 to closely contact with the mold 100B. At this time, it is not necessary to generate a clamping force that is generated during molding. Also, the mold 100B is locked to each of the fixed platen 61 and the movable platen 62 by driving the fixing mechanism 610.

In the present exemplary embodiment, step S41 is performed after step S40. In another exemplary embodiment, because it may take time to switch operation conditions, for example, the operation conditions can be switched simultaneously with an instruction to unload the mold 100A.

In step S42, it is determined whether the cooling of the mold 100B completed based on whether the cooling time, which started measuring in step S25, has reached a predetermined time.

In step S43, the movable platen 62 is separated from the fixed platen 61 by driving the motor 66. The fixed mold 101 is fixed to the fixed platen 61 by the fixing mechanisms 610 and the movable mold 102 is fixed to the movable platen 62 by the fixing mechanisms 610. This results in the movable mold 102 separating from the fixed mold 101 and the mold 100B is opened. The secondary molded part α remaining on a side of the movable mold 102 (in cavity) of the mold 100B is removed by driving the take-out robot 7 in step S44 and conveyed to an upper part of injection molding machine 2 to standby after insertion of the second primary molded part to a side of movable mold 102 of mold 100B. The take-out robot 7 continues to secure the secondary molded part α from the take-out process (S44) until the insertion (placement) (S58) of the secondary molded part α into the mold 100A is performed as described below.

In step S46, the movable platen 62 is moved towards the fixed platen 61 by driving the motor 66. This results in the movable mold 102 closely contacting with the fixed mold 101, and the mold 100B is closed.

In step S47, clamping of the mold 100B by the fixed platen 61 and the movable platen 62 is performed by driving the motor 66 to drive the toggle mechanism 65. In step S48, preparation for injection in relation to the mold 100B is performed. The actuator 55 is driven to move the injecting apparatus 5, causing the nozzle 52 to touch the mold 100B. A secondary molded part β is molded in a state where the second primary molded part is placed in the mold 100B, by the step S49, a resin is injected and overmolded into the second primary molded part to be combined.

Next, the processing of step S50 and step S52 are performed in parallel to the processing of step S51. In step S50, timing of the time for cooling the molded part in the mold 100B is started. In step S51, processing related to the clamping apparatus 6 is performed. Securing of the mold 100B by the fixing mechanism 610 is released. After a delay of a predetermined time from step S49, the motor 66 is driven to drive the toggle mechanism 65. This results in releasing of the clamping force and the movable platen 62 slightly separates in relation to the fixed platen 61, and a space where the mold 100B and the mold 100A are exchanged is formed.

In step S52, processing related to the injecting apparatus 5 is performed. Here, for example, a dwelling suck back, a nozzle shut-off, a retraction of the injecting apparatus 5 or the like are performed.

In step S53, mold 100B is exchanged with mold 100A. The mold 100B is unloaded from the molding operation position 11 to the conveying machine 3B, and the mold 100A is loaded from the conveying machine 3A to the molding operation position 11. The controller 41 transmits an instruction to unload the mold 100B to the controller 42B, and the controller 42B drives the conveyance unit 31 to unload the mold 100B from the molding operation position 11. The mold 100A is moved from the conveying machine 3A to the molding operation position 11. When unloading of mold 100B completes, a signal indicating unload completion is transmitted from the controller 42B to the controller 41. The mold 100B is cooled on the conveying machine 3B. The self-closing unit 103 maintains the closed state of the mold 100B.

When the signal to indicate loading completion is received, conditions regarding the mold 100A are set as the operation conditions of the molding operation in step S54. In order to shift from this process to a process of simultaneously molding a primary molded part and a tertiary molded part, an operation condition C, which is different from the operation conditions A, of mold 100A, is set. Conditions such as a clamping force and a measured value can be different between operation conditions A and C

A start of measurement of plasticization for the next injection is performed. The motor 66 is driven to cause the fixed platen 61 and the movable platen 62 to closely contact with the mold 100A. At this time, it is not necessary to generate a clamping force that is generated during molding. The mold 100A is secured to each of the fixed platen 61 and the movable platen 62 by driving the fixing mechanism 610.

In step S55, it is determined whether the cooling of the mold 100A completed based on whether the cooling time, which started measuring in step S36, has reached a predetermined time.

In step S56, the movable platen 62 is separated from the fixed platen 61 by driving the motor 66. The fixed mold 101 is fixed to the fixed platen 61 by the fixing mechanisms 610, and the movable mold 102 is fixed to the movable platen 62 by the fixing mechanisms 610. This results in the movable mold 102 separating from the fixed mold 101 and the mold 100A is opened. A third primary molded part remaining on a side of the movable mold 102 (in cavity) of the mold 100A is removed by driving the take-out robot 7 in step S57.

FIGS. 6G-6I illustrate an improvement to the molding process of FIGS. 6A-6F.

In step S58, a secondary molded part α is inserted into mold 100A and then conveyed to an upper part of the injection molding machine 2 to standby. The take-out robot 7 continues to secure the third primary molded part from the take-out process (S57) until the insertion (placement) (S72) of the third primary molded part into the mold 100B is performed as describe below. As preparation of forming a fourth primary molded part and a tertiary molded part A, gate changeover occurs in step S59 to flow resin to the cavity of the tertiary molded part A.

In step S60, the movable platen 62 is moved towards the fixed platen 61 by driving the motor 66. This results in the movable mold 102 closely contacting the fixed mold 101, and the mold 100A is closed.

In step S61, the toggle mechanism 65 is driven by driving the motor 66, and the fixed platen 61 and the movable platen 62 clamp the mold 100A. In step S62, injection for the mold 100A is prepared. The resin is measured. When the nozzle 52 is separated from the mold 100A, the injection machine 5 is moved by driving the actuator 55 to touch the nozzle 52 to the mold 100A.

In step S63, injection and dwelling of molten resin is performed. The injection in step S63 is for molding the fourth primary molded part and the tertiary molded part A simultaneously.

More specifically, the injecting apparatus 5 is driven to fill molten resin into a cavity in the mold 100A from the nozzle 52 and to press the resin at a high pressure in order to compensate for a volume decrease due to resin solidifying. Upon the processing of step S63, the actual clamping force is measured by the sensor 68. During molding, the mold 100A thermally expands due to the temperature of the mold 100A gradually rising. There are cases where a difference arises in the initial clamping force and the clamping force after a period of time has passed. Accordingly, it is possible to correct the clamping force at the time of the next clamping based on a result of measurement by the sensors 68. The adjustment of the clamping force is performed by an adjustment of the position of the movable platen 63 in relation to the tie-bar 64 by driving the motor 67. In this way, it is possible to enhance precision of the clamping force by adjusting the clamping force by correcting the initial value of the position of the movable platen 63 in relation to the tie-bars 64 in accordance with the result of measurement by the sensors 68. The adjustment of the position of the movable platen 63 in relation to the tie-bars 64 may be performed at any timing.

Next, the processing of step S64 and step S66 are performed in parallel to the processing of step S65. In step S64, timing of the time for cooling the molded part in the mold 100A is started. In step S65, processing related to the clamping apparatus 6 is performed. Securing of the mold 100A by the fixing mechanism 610 is released. After a delay of a predetermined time from step S63, the motor 66 is driven to drive the toggle mechanism 65. This results in releasing of the clamping force, and the movable platen 62 slightly separates in relation to the fixed platen 61, and a space where the mold 100A and the mold 100B can be exchanged is formed.

In step S66, processing related to the injecting apparatus 5 is performed. Here, for example, a dwelling suck back, a nozzle shut-off, a retraction of the injecting apparatus 5 or the like are performed.

In step S67, mold 100A is exchanged with mold 100B. The mold 100A is unloaded from the molding operation position 11 to the conveying machine 3A, and the mold 100B is loaded from the conveying machine 3B to the molding operation position 11. The controller 41 transmits an instruction to unload the mold 100A to the controller 42A, and the controller 42A drives the conveyance unit 31 to unload the mold 100A from the molding operation position 11. The mold 100B is moved from the conveying machine 3B to the molding operation position 11. When unloading of mold 100A completes, a signal indicating unload completion is transmitted from the controller 42A to the controller 41. The mold 100A is cooled on the conveying machine 3A. The self-closing unit 103 maintains the closed state of the mold 100A.

When the signal to indicate loading completion is received, conditions regarding the mold 100B are set as the operation conditions of the molding operation in step S68. That is, the controller 41 reads and sets the operation conditions from among the multiple operation conditions (operation conditions A, B, and C) set in step S1. For example, the thickness of the mold 100B (the width of the Y direction), the clamping force and the like are set as the operation conditions of the molding operation for this time. Operation conditions such as an injection speed or the like corresponding to the mold 100B are set. A start of measurement of plasticization for the next injection is performed. The motor 66 is driven to cause the fixed platen 61 and the movable platen 62 to closely contact with the mold 100B. At this time, it is not necessary to generate a clamping force that is generated during molding. The mold 100B is secured to each of the fixed platen 61 and the movable platen 62 by driving the fixing mechanism 610.

In the present exemplary embodiment, step S68 is performed after step S67. In another exemplary embodiment, because it may take time to switch operation conditions, for example, the operation conditions may be switched simultaneously with, for example, an instruction to unload the mold 100A.

In step S69, it is determined whether the cooling of the mold 100B completed based on whether the cooling time, which started measuring in step S50, has reached a predetermined time.

In step S70, the movable platen 62 is separated from the fixed platen 61 by driving the motor 66. The fixed mold 101 is fixed to the fixed platen 61 by the fixing mechanisms 610, and the movable mold 102 is fixed to the movable platen 62 by the fixing mechanisms 610. This results in the movable mold 102 separating from the fixed mold 101 and the mold 100B is opened. The secondary molded part β remaining on a side of the movable mold 102 (in cavity) of the mold 100B is removed by driving the take-out robot 7 in step S7 and conveyed to an upper part of the injection molding machine 2 to standby after inserting the third primary molded part to a side of movable mold 102 of mold 100B. The take-out robot 7 continues to secure the secondary molded part β from the take-out process (S71) until the insertion (placement) (S85) of the secondary molded part β into the mold 100A is performed as described below.

In step S73, the movable platen 62 is moved towards the fixed platen 61 by driving the motor 66. This results in the movable mold 102B closely contacting the fixed mold 101, and the mold 100B is closed.

In step S74, clamping of the mold 100B by the fixed platen 61 and the movable platen 62 is performed by driving the motor 66 to drive the toggle mechanism 65. In step S75, preparation for injection in relation to the mold 100B is performed. Here, the actuator 55 is driven to move the injecting apparatus 5, causing the nozzle 52 to touch the mold 100B. A secondary molded part y is molded in a state where the third primary molded part is placed in the mold 100B, by the step S76, a resin is injected and overmolded into the third primary molded part to be combined.

Next, the processing of step S77 and step S79 are performed in parallel to the processing of step S78. In step S77, timing of the time for cooling the molded part in the mold 100B is started. In step S78, processing related to the clamping apparatus 6 is performed. Securing of the mold 100B by the fixing mechanism 610 is released. After a delay of a predetermined time from step S76, the motor 66 is driven to drive the toggle mechanism 65. This results in releasing the clamping force, and the movable platen 62 slightly separates in relation to the fixed platen 61, and a space where mold 100B can be exchanged with mold 100A is formed.

In step S79, processing related to the injecting apparatus 5 is performed. Here, for example, a dwelling suck back, a nozzle shut-off, a retraction of the injecting apparatus 5 or the like are performed.

In step S80, mold 100B is exchanged with mold 100A. The mold 100B is unloaded from the molding operation position 11 to the conveying machine 3B, and the mold 100A is loaded from the conveying machine 3A to the molding operation position 11. The controller 41 transmits an instruction to unload the mold 100B to the controller 42B, and the controller 42B drives the conveyance unit 31 to unload the mold 100B from the molding operation position 11. The mold 100A moves from the conveying machine 3A to the molding operation position 11. When unloading of mold 100B completes, a signal indicating unload completion is transmitted from the controller 42B to the controller 41. The mold 100B is cooled on the conveying machine 3B. The self-closing unit 103 maintains the closed state of the mold 100B.

When the signal to indicate loading completion is received, conditions regarding the mold 100A are set as the operation conditions of the molding operation in step S81. Operation condition C is set as the condition, as in step S53. The reason for the condition setting is a fifth molding primary molded part and a tertiary molded part B. Conditions such as a clamping force and a measured value can change when compared with the operation conditions A. A start of measurement of plasticization for the next injection is performed. The motor 66 is driven to cause the fixed platen 61 and the movable platen 62 to closely contact with the mold 100A. At this time, it is not necessary to generate a clamping force that is generated during molding. The mold 100A is secured to each of the fixed platen 61 and the movable platen 62 by driving the fixing mechanism 610.

In step S82, it is determined whether the cooling of the mold 100A completed based on whether the cooling time, which started measuring in step S64, has reached a predetermined time.

In step S83, the movable platen 62 is separated from the fixed platen 61 by driving the motor 66. The fixed mold 101 is fixed to the fixed platen 61 by the fixing mechanisms 610, and the movable mold 102 is fixed to the movable platen 62 by the fixing mechanisms 610. This results in the movable mold 102 separating from the fixed mold 101 and the mold 100A is opened. The fourth primary molded part and tertiary molded part A remaining on a side of the movable mold 102 (in cavity) of the mold 100A is removed by driving the take-out robot 7 in step S84. In step S85, secondary molded part β is inserted to mold 100A, and the take-out robot 7 conveys to an upper part of the injection molding machine 2 to standby.

In step S86, the movable platen 62 is moved towards the fixed platen 61 by driving the motor 66. This results in the movable mold 102 closely contacting with the fixed mold 101, and the mold 100B is closed.

In step S87, clamping of the mold 100B by the fixed platen 61 and the movable platen 62 is performed by driving the motor 66 to drive the toggle mechanism 65. In step S88, preparation for injection in relation to the mold 100B is performed. Here, the actuator 55 is driven to move the injecting apparatus 5, causing the nozzle 52 to touch the mold 100B. A secondary molded part y is molded in a state where the third primary molded part is placed in the mold 100B, by the step S89 of FIG.6, a resin is injected and overmolded into the third primary molded part to be combined.

In step S90, it is determined whether the production volume of the tertiary molded parts is less than a scheduled/targeted production volume TH. If the production volume is less, the process returns to step S67. If the production volume is greater than or equal to the scheduled/targeted production volume TH, the process ends.

### Molding Behavior

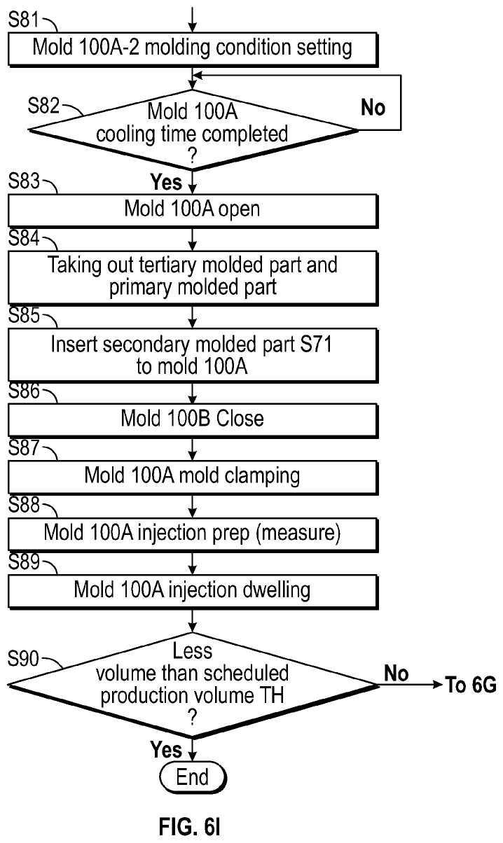

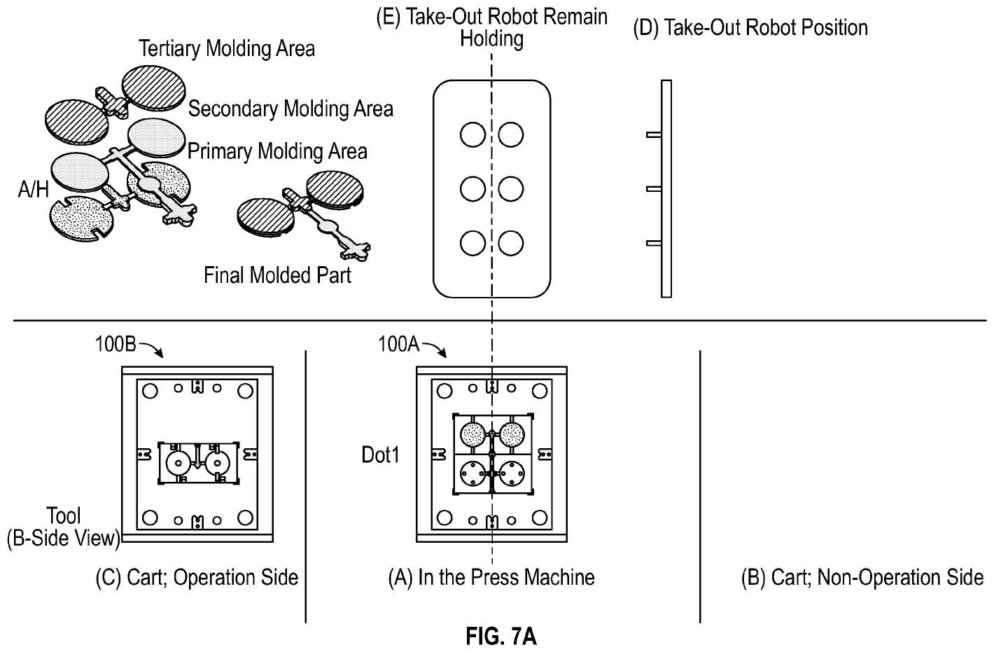

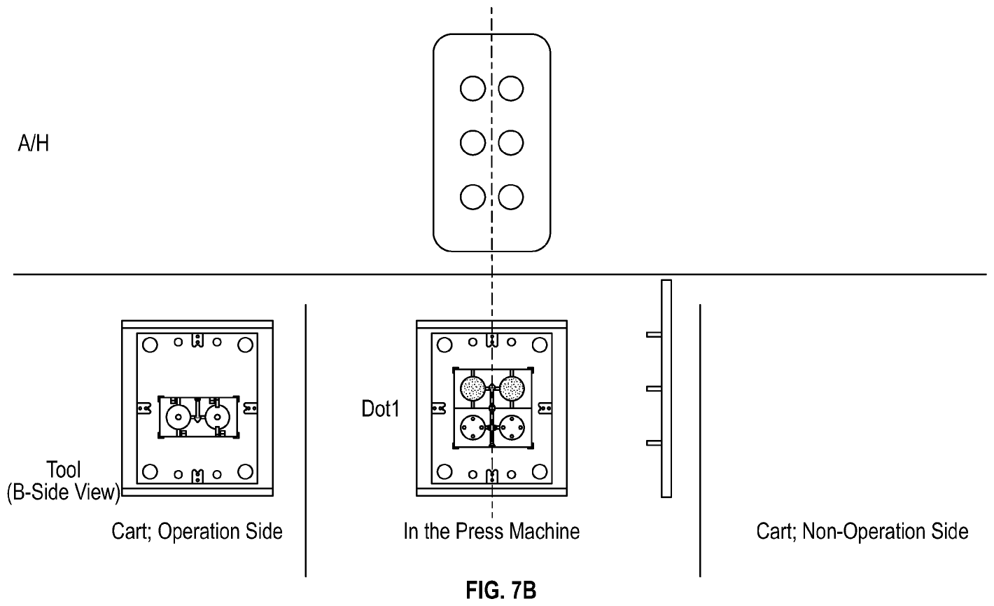

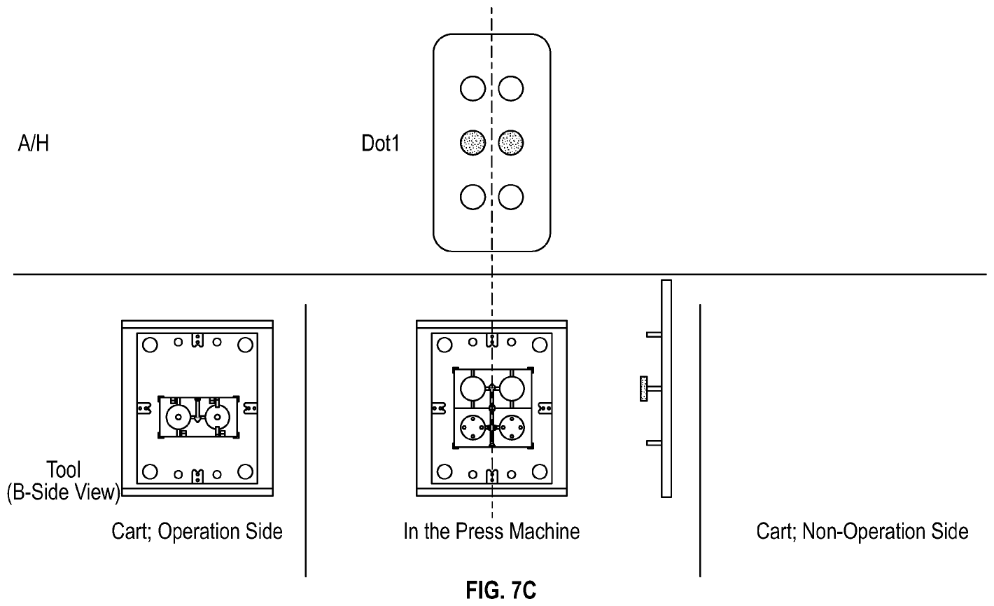

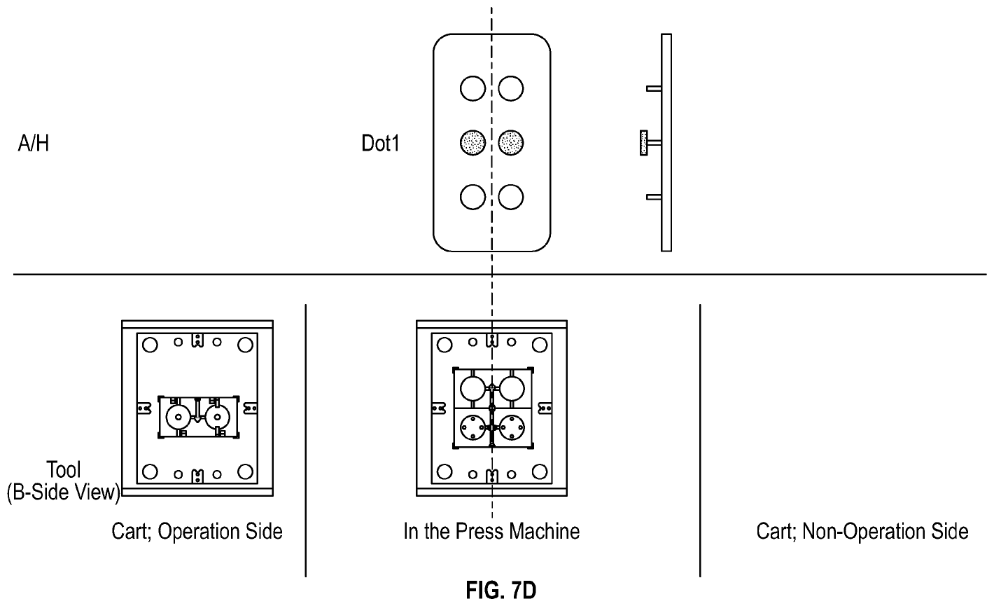

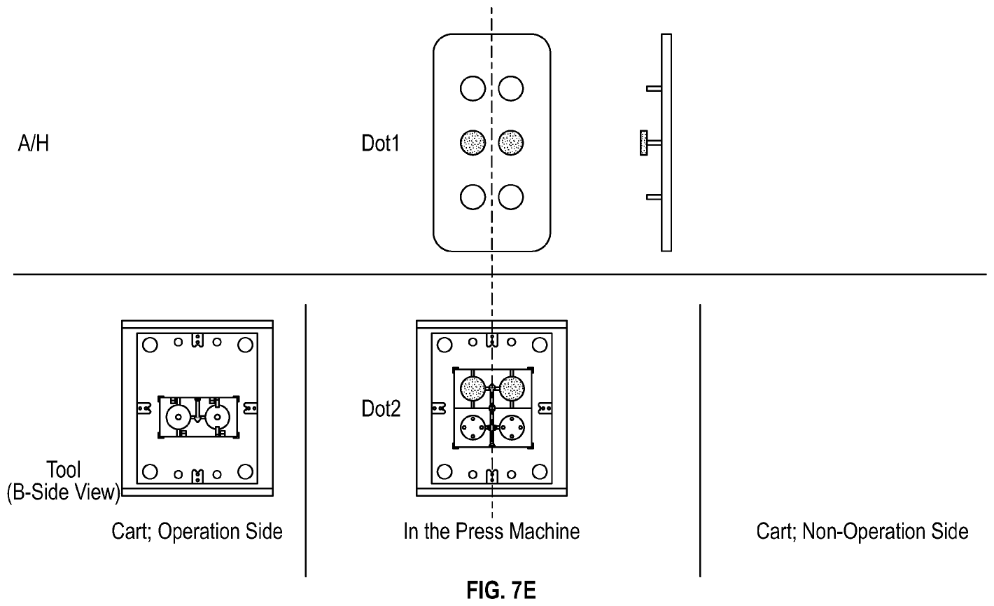

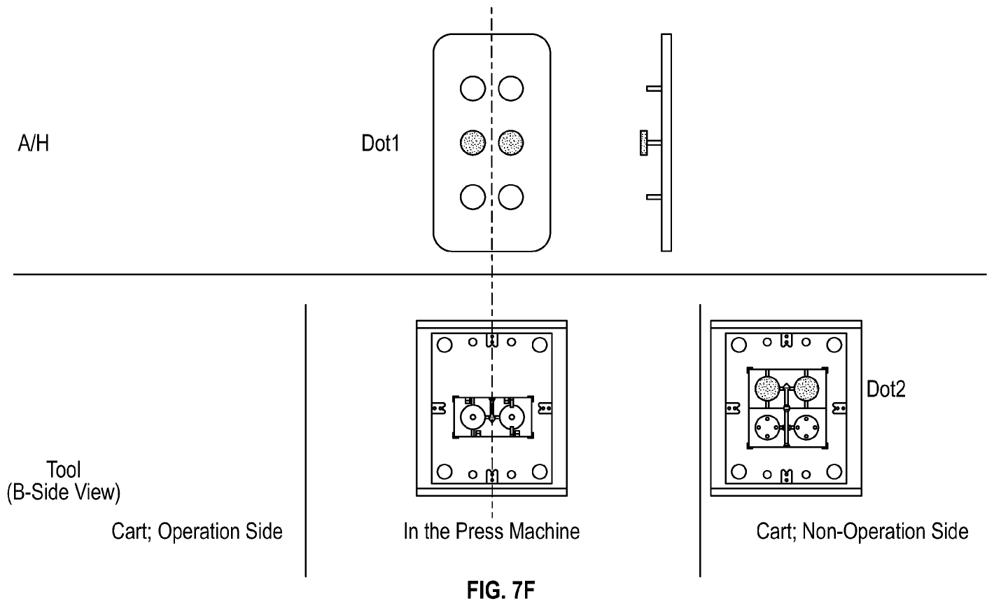

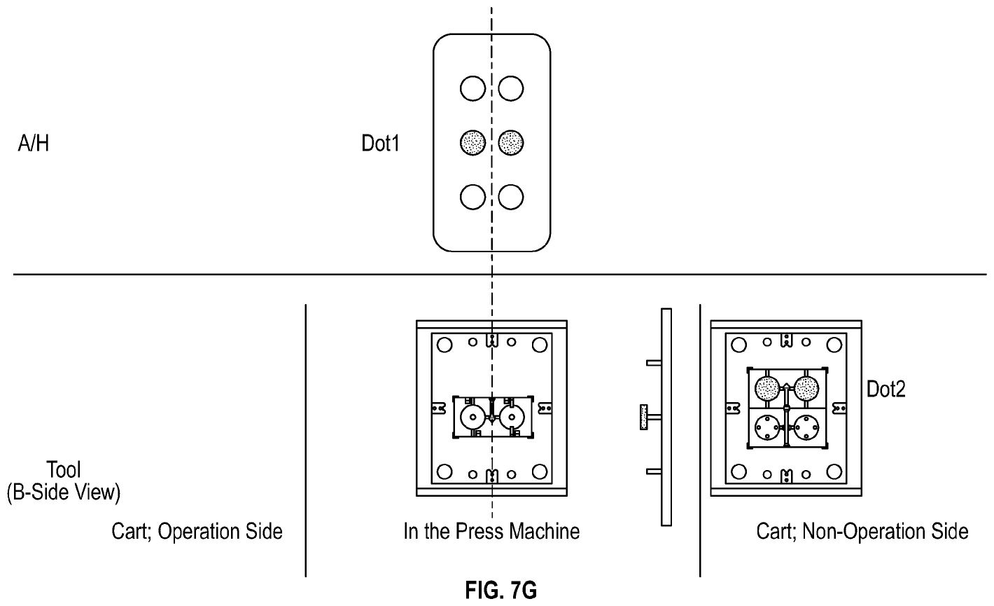

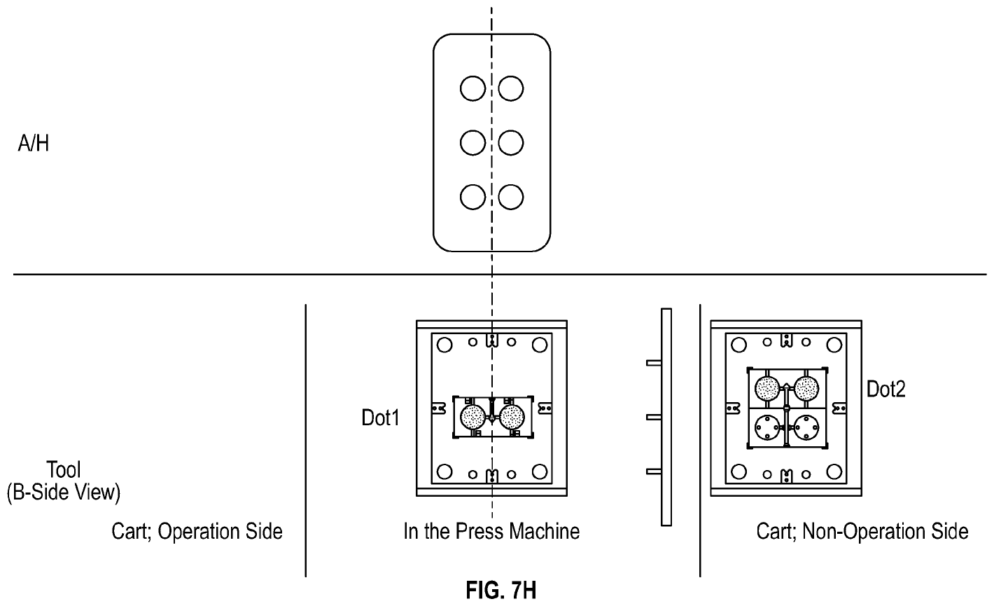

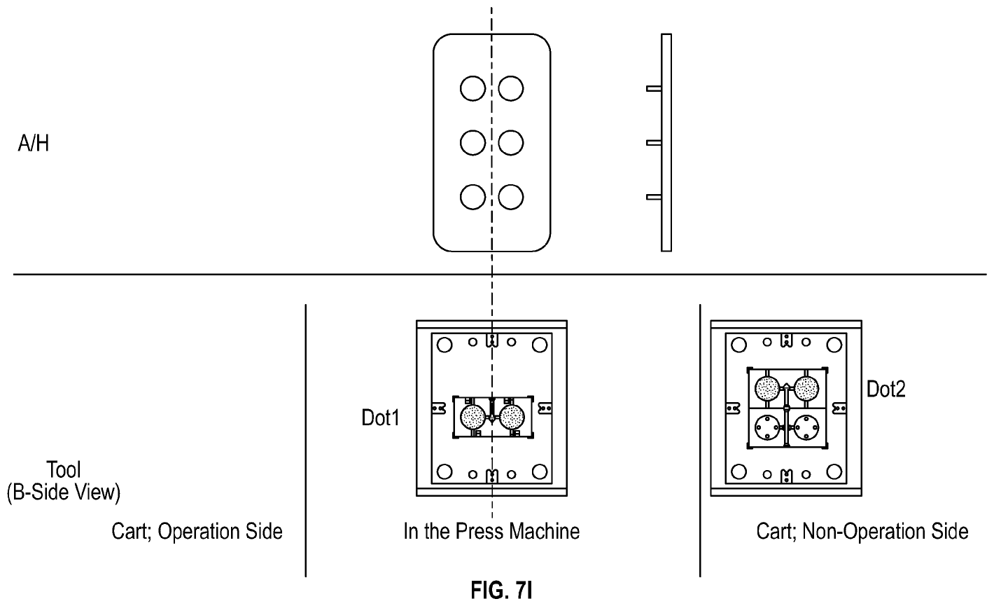

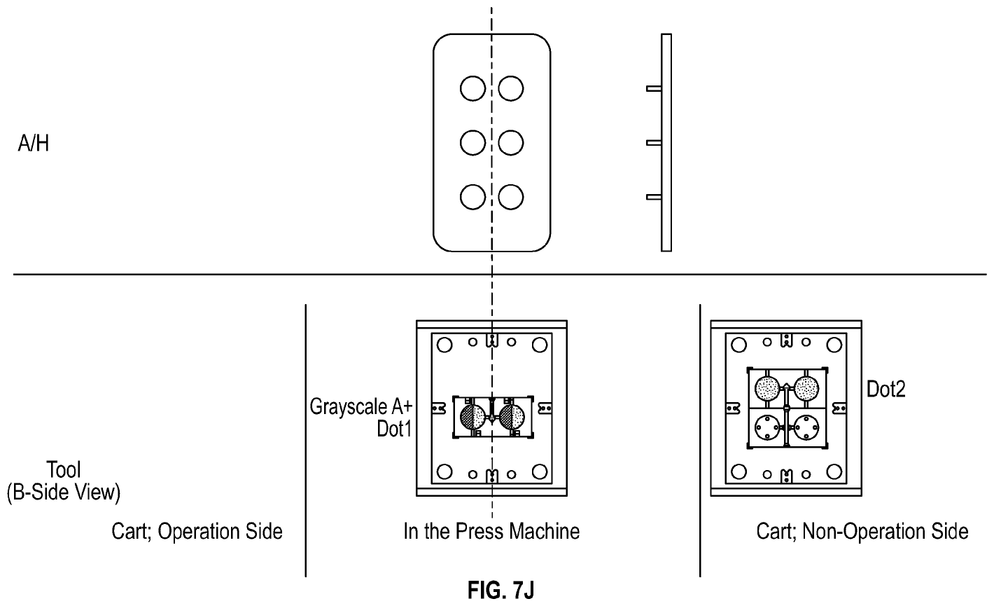

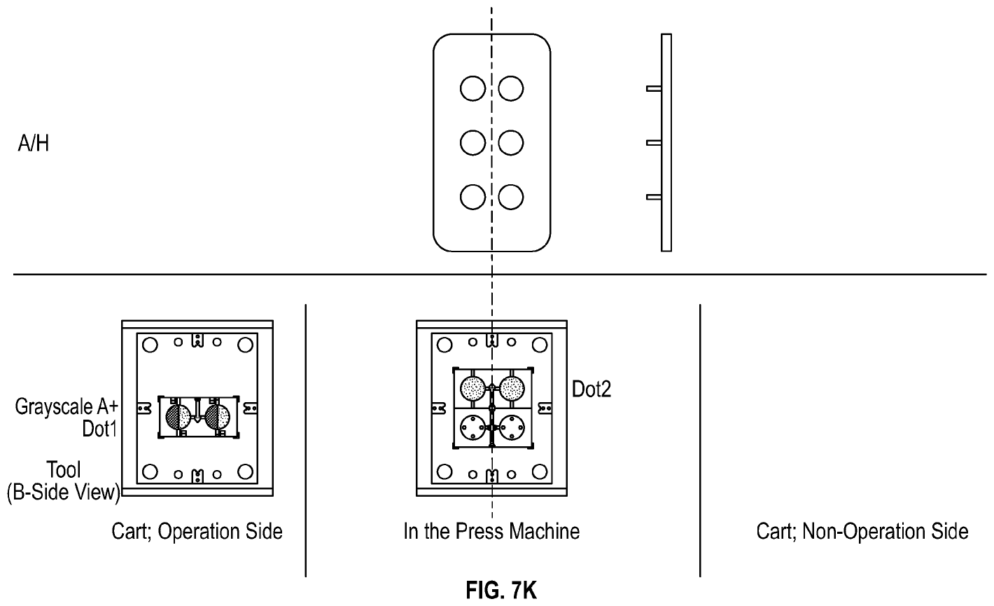

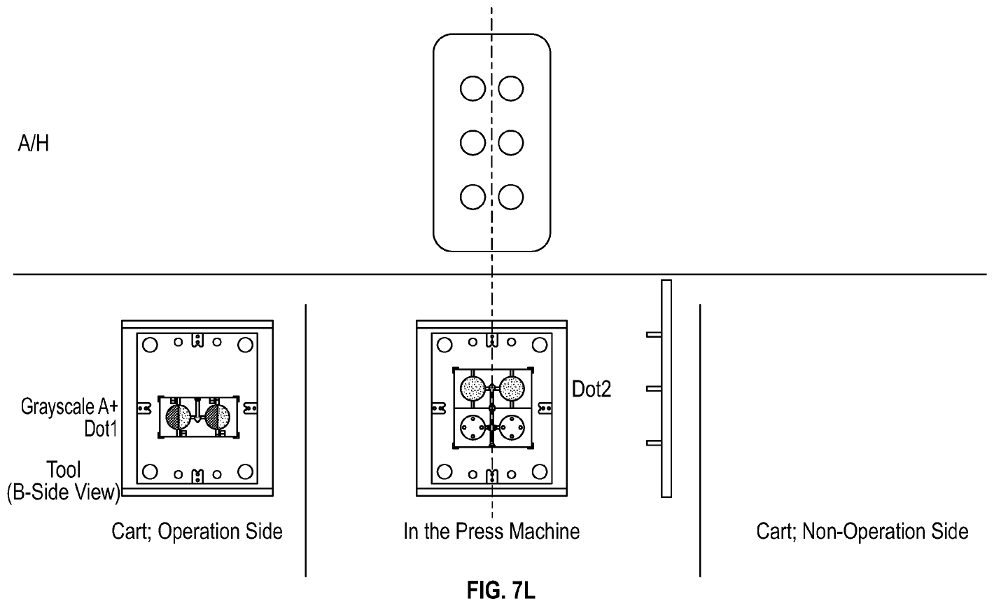

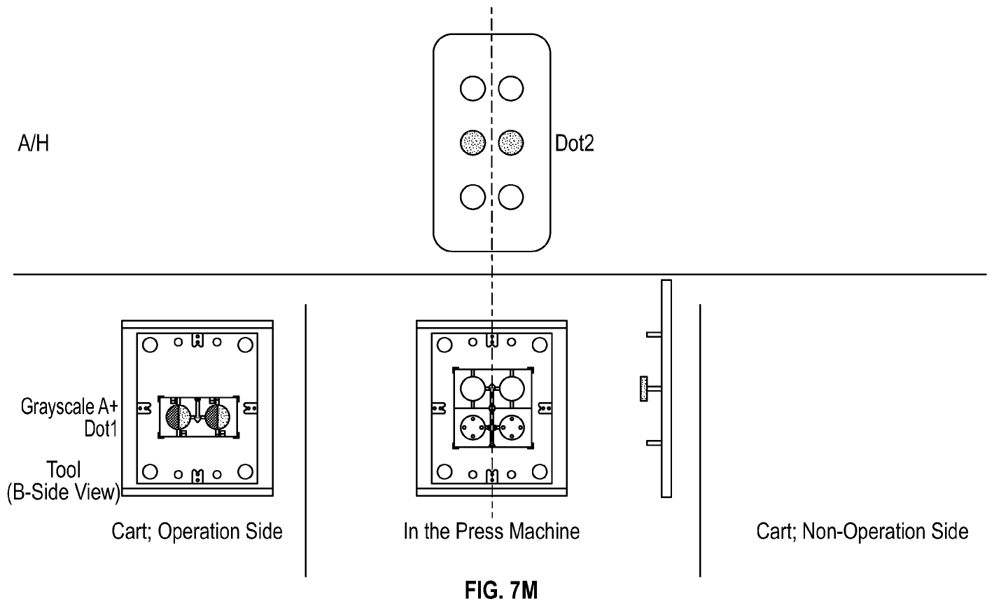

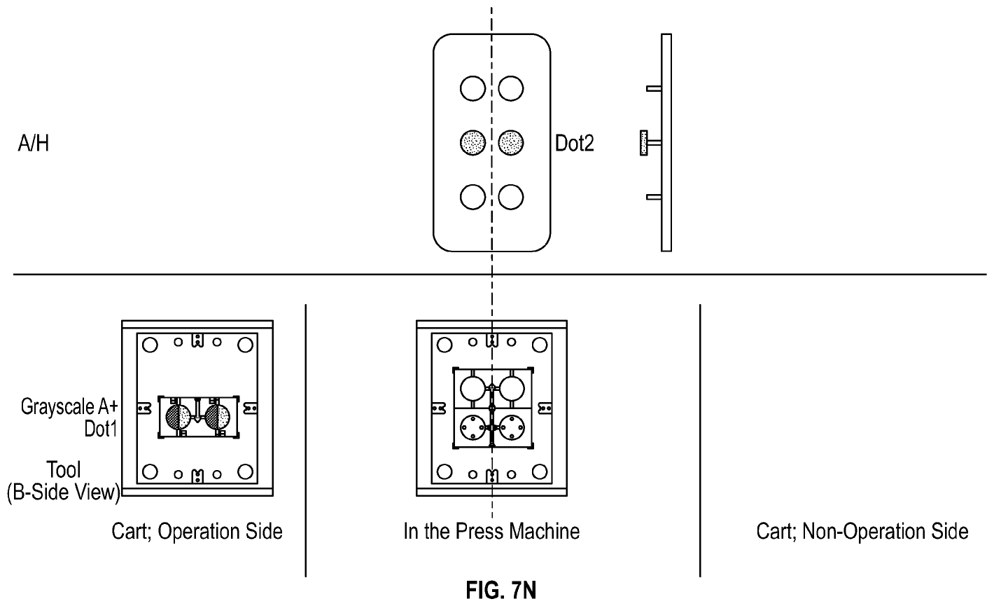

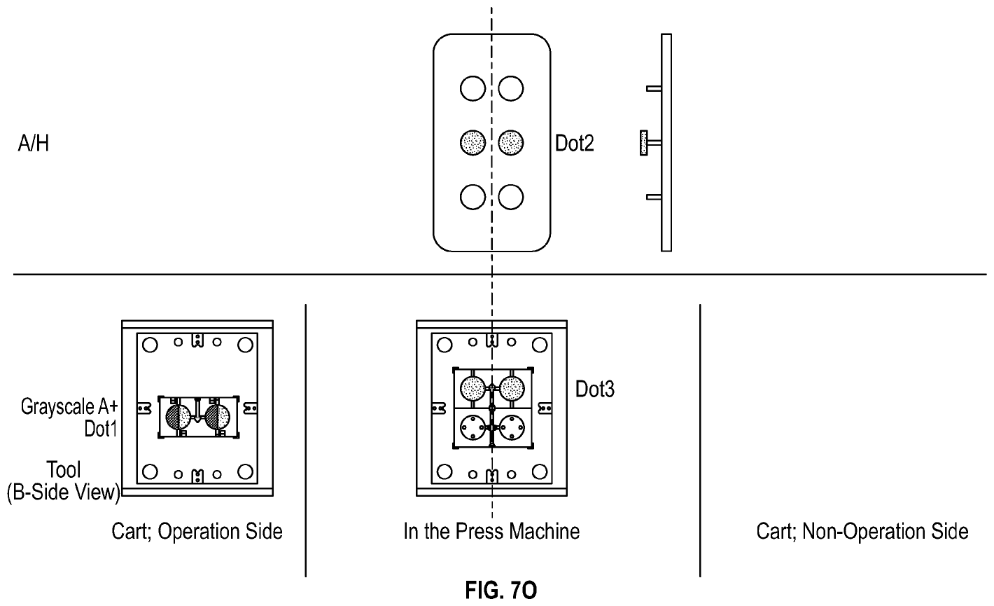

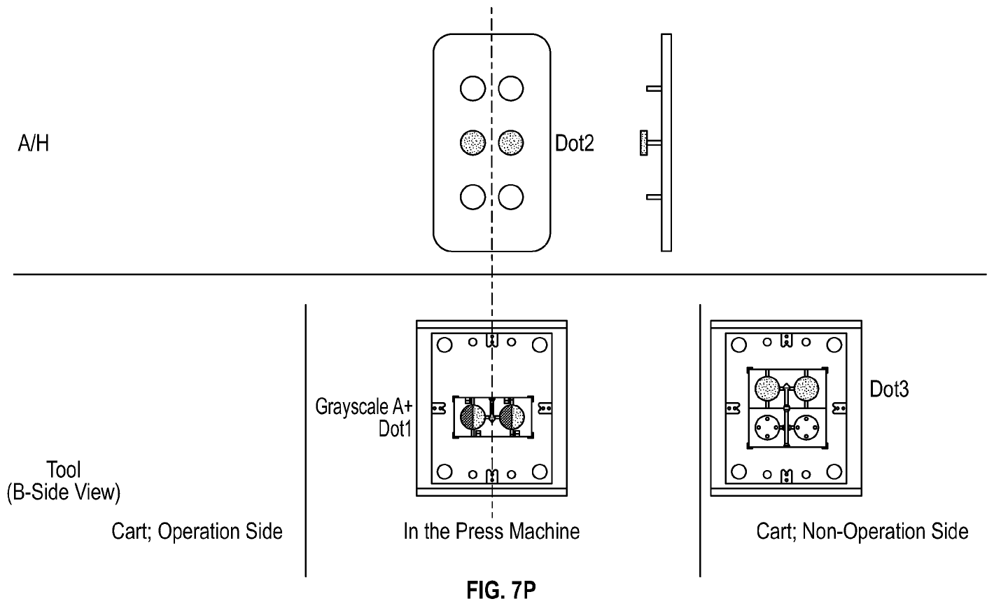

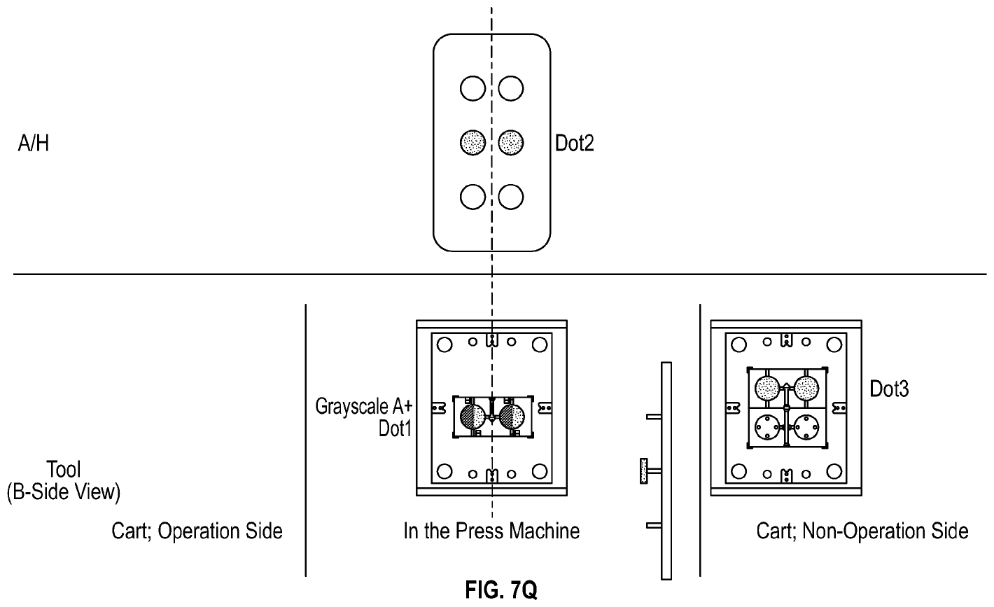

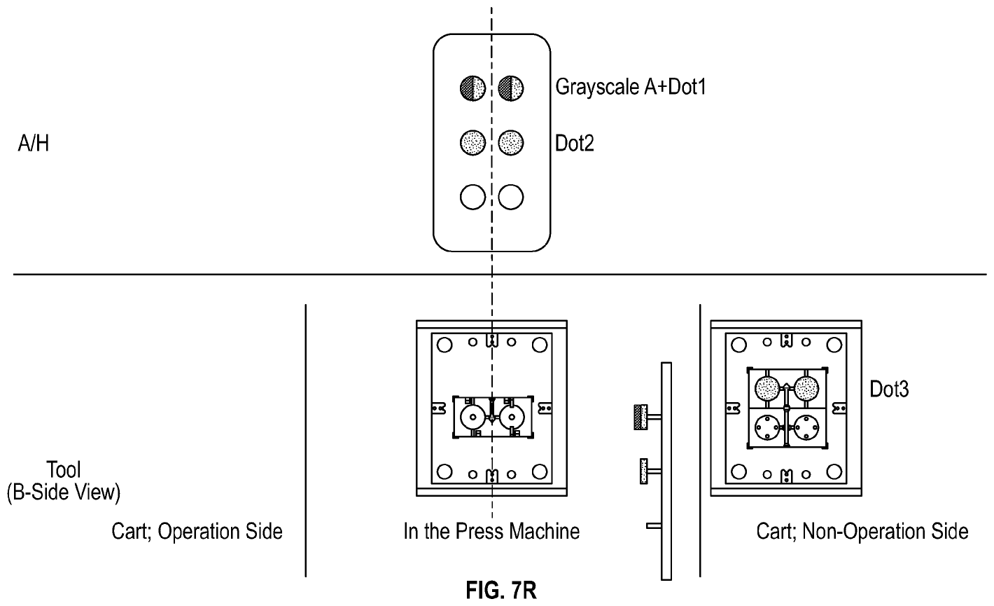

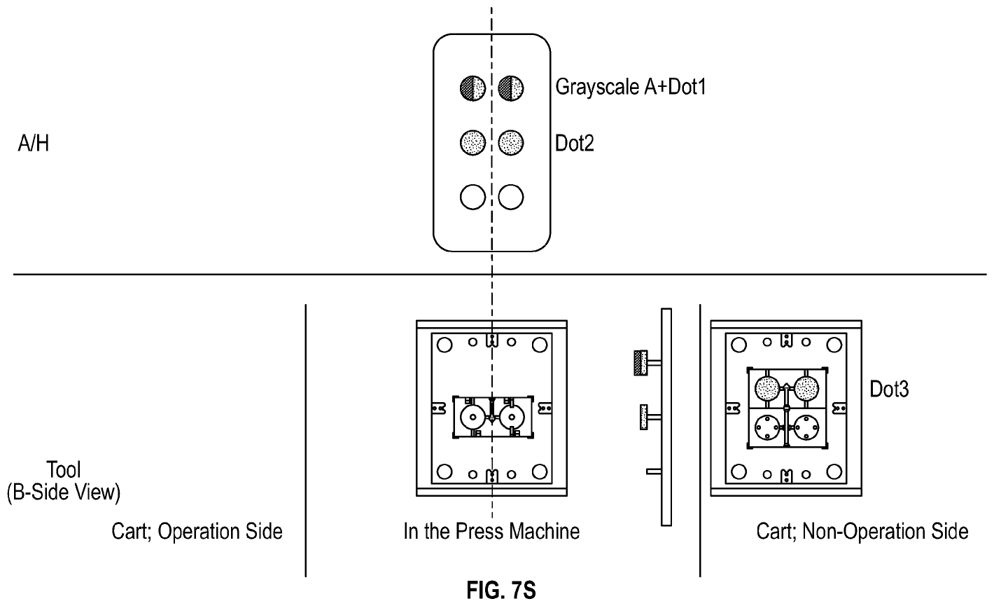

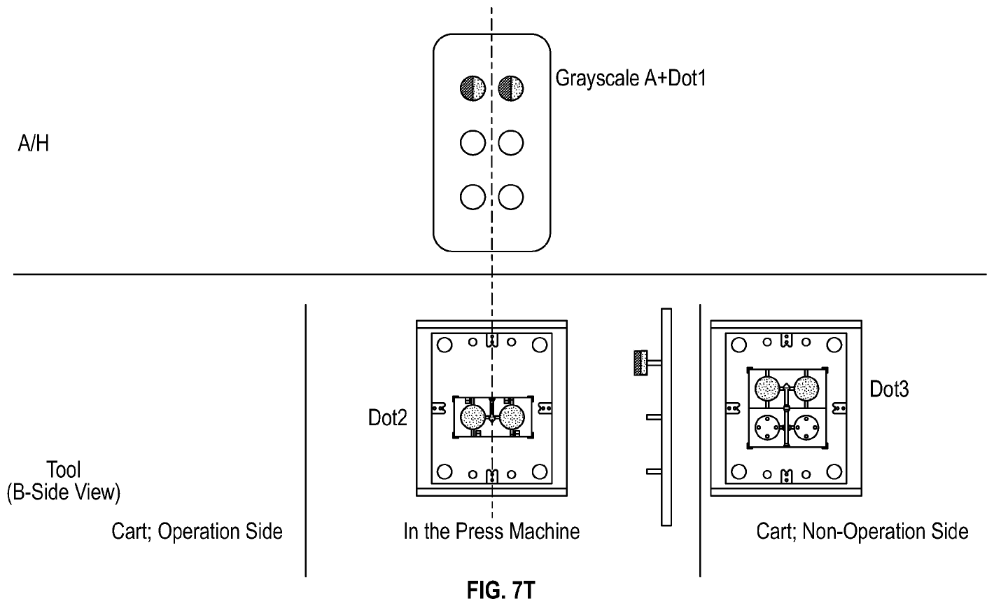

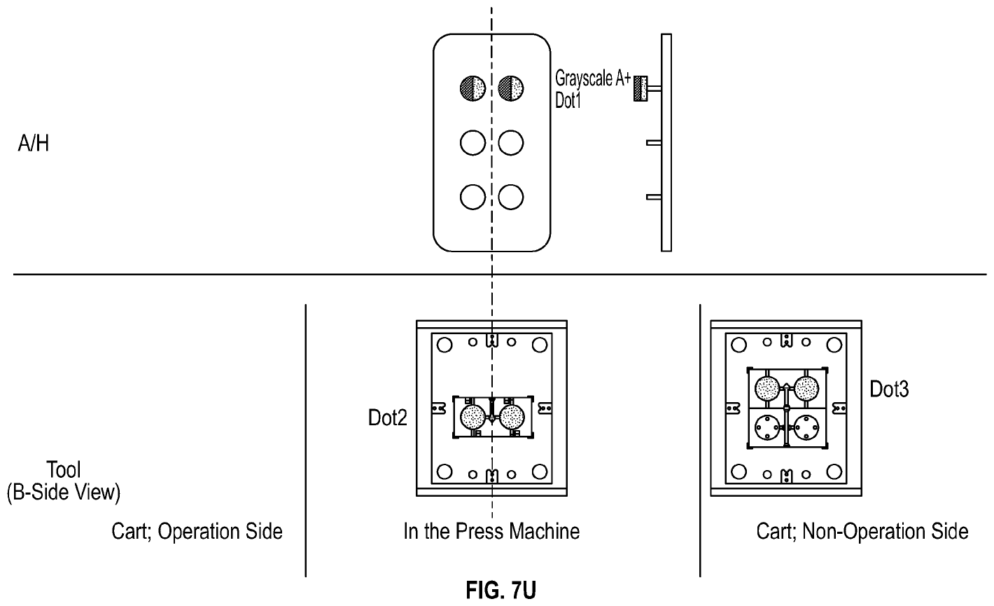

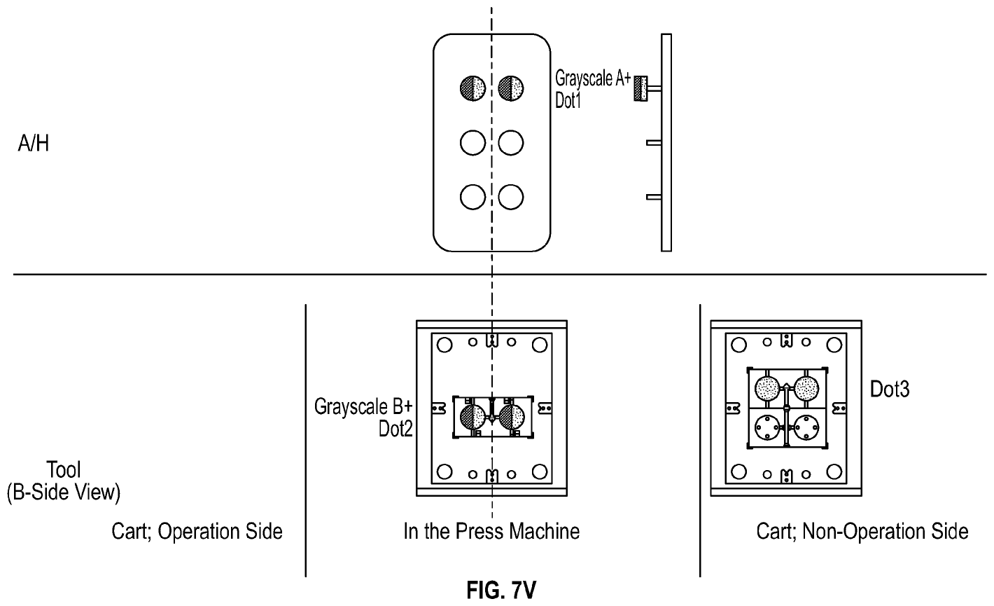

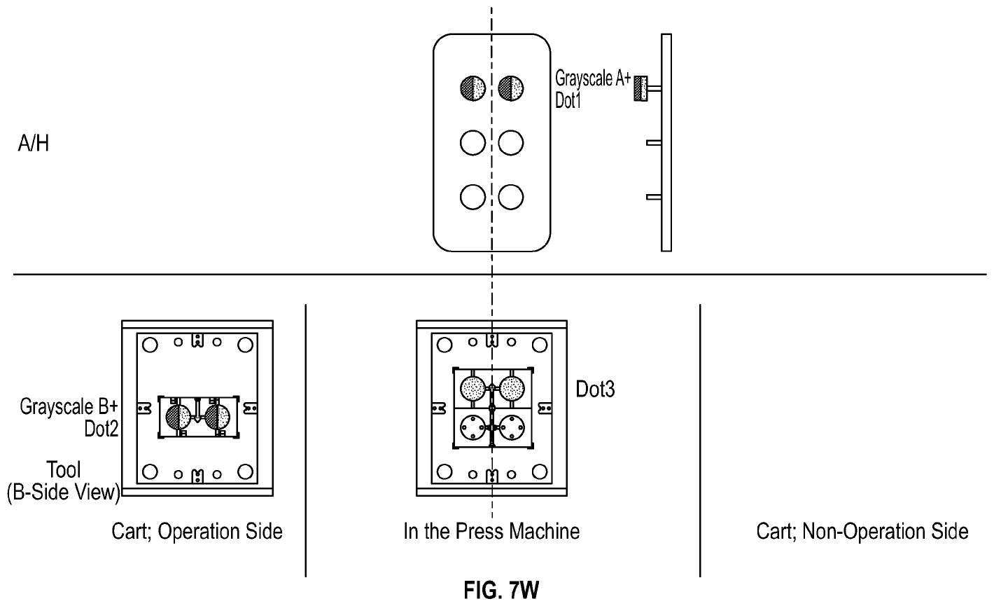

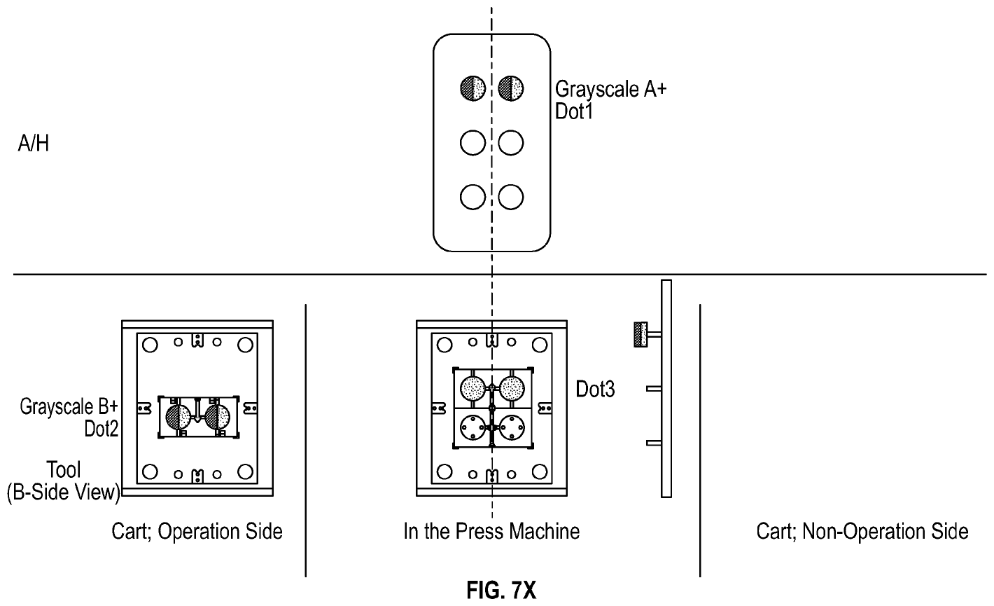

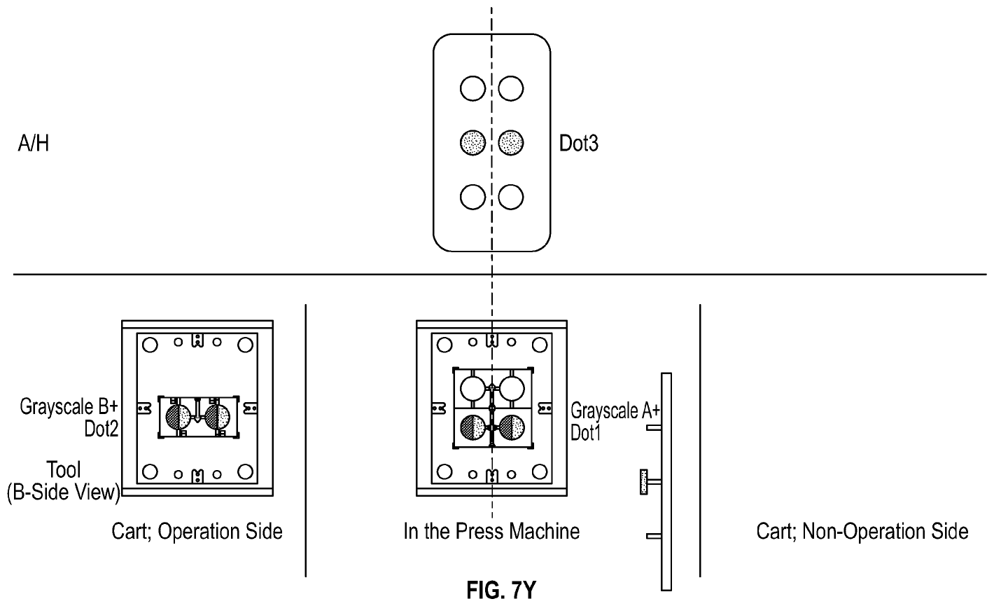

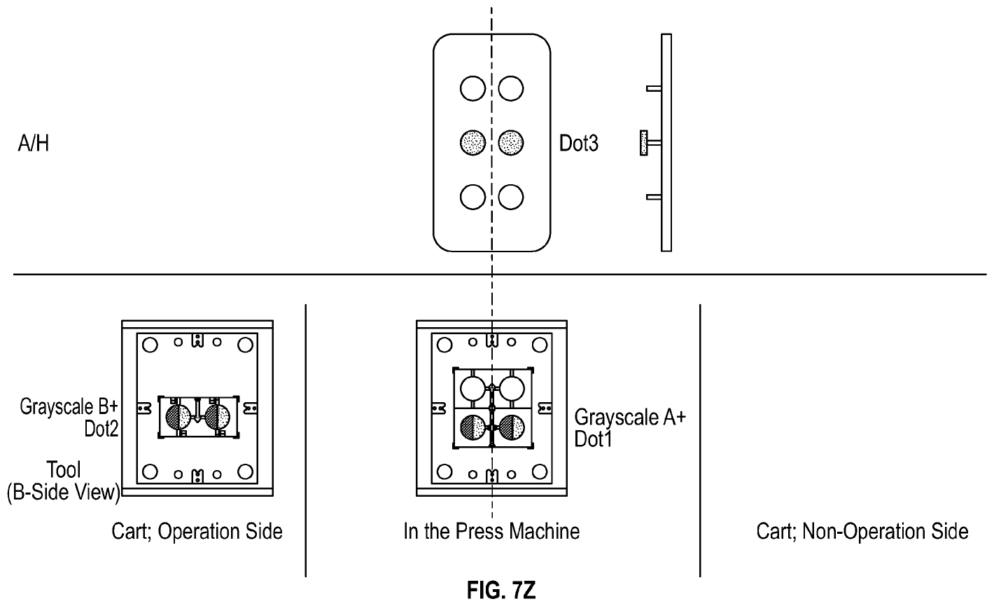

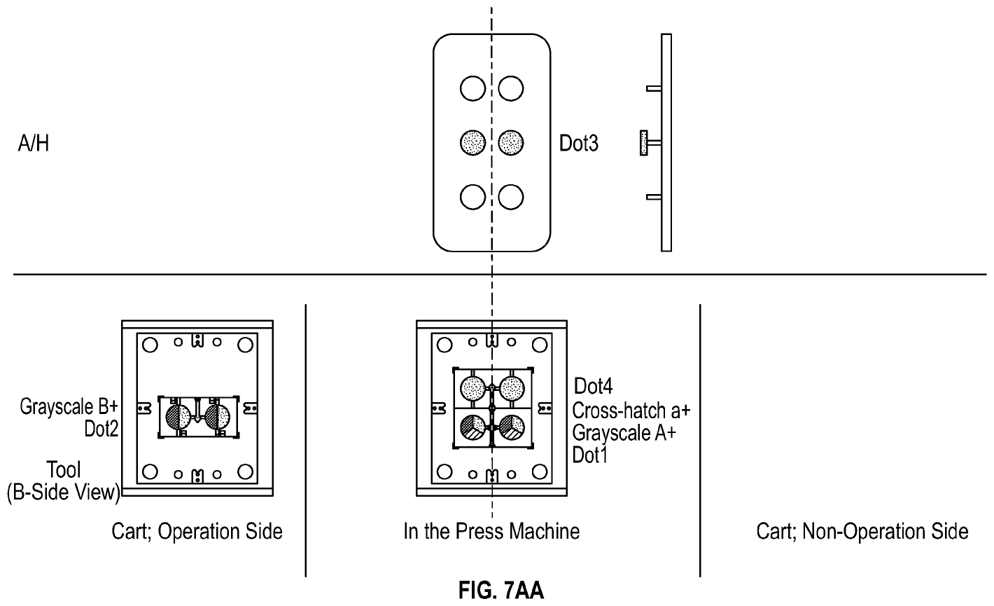

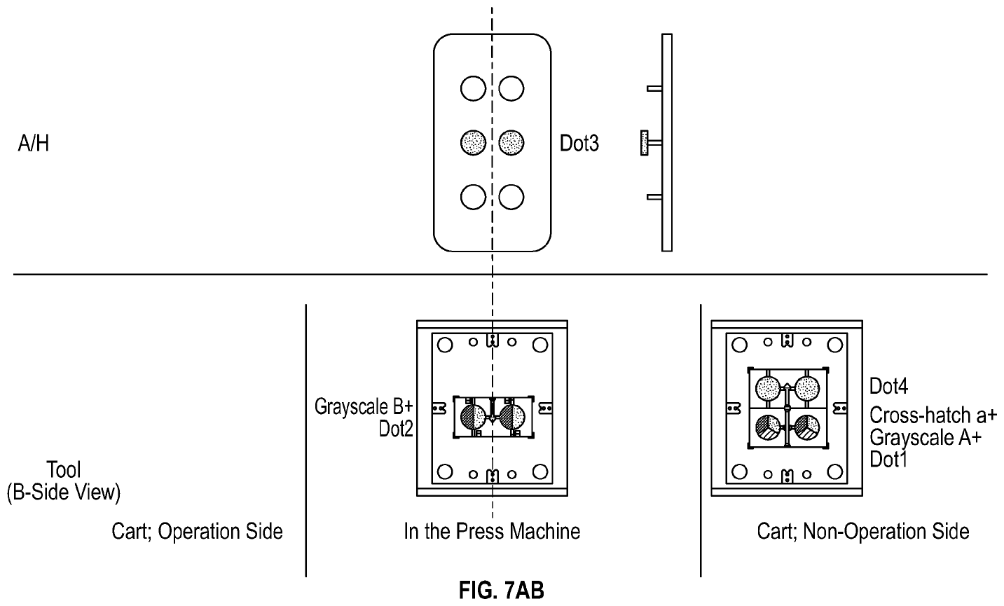

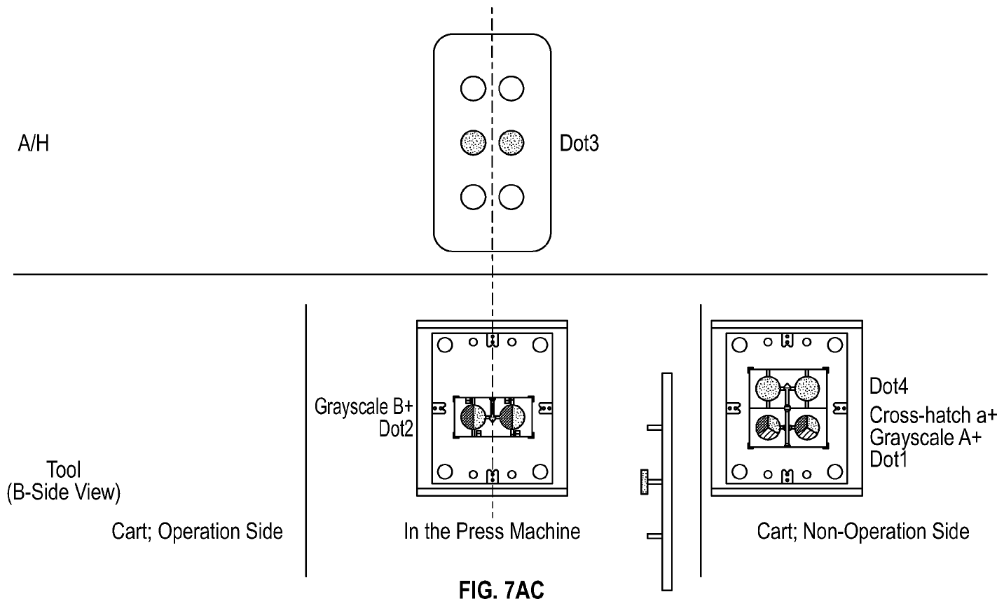

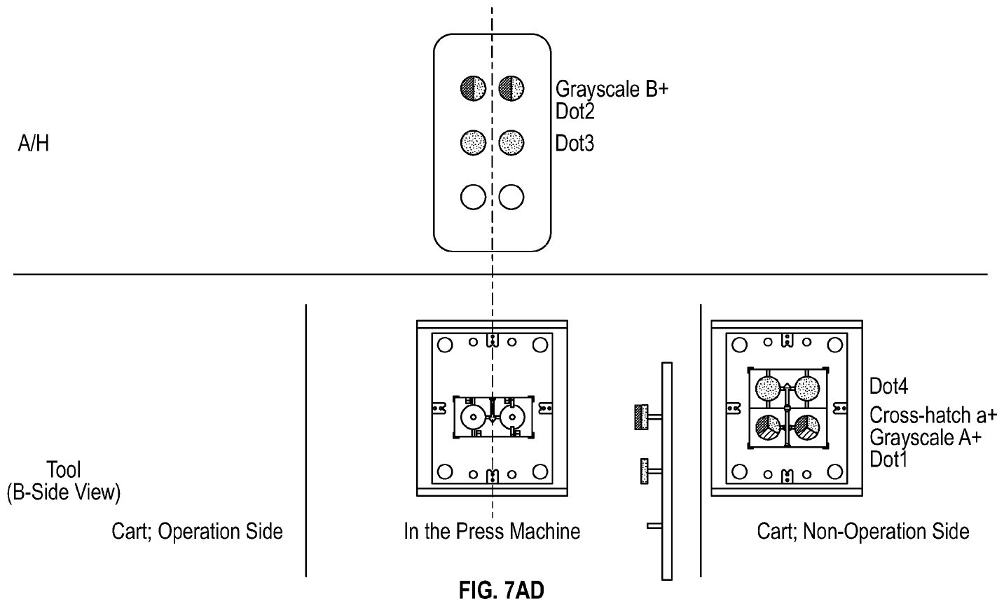

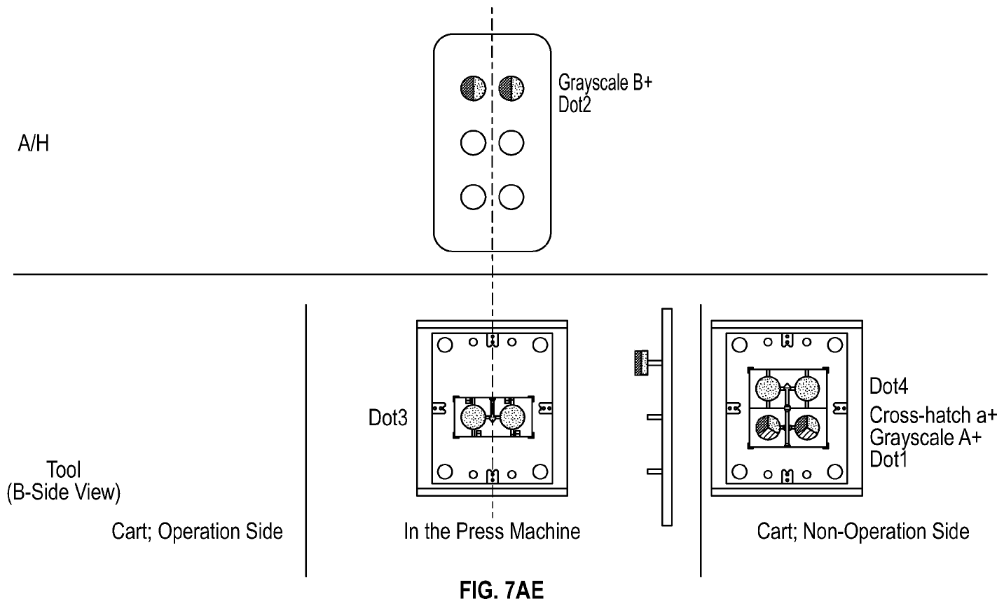

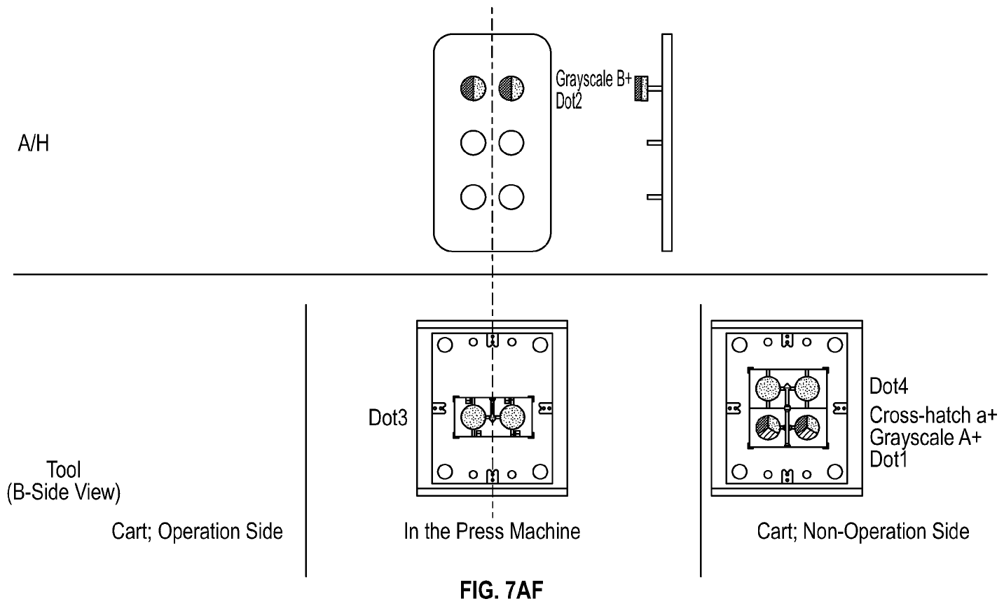

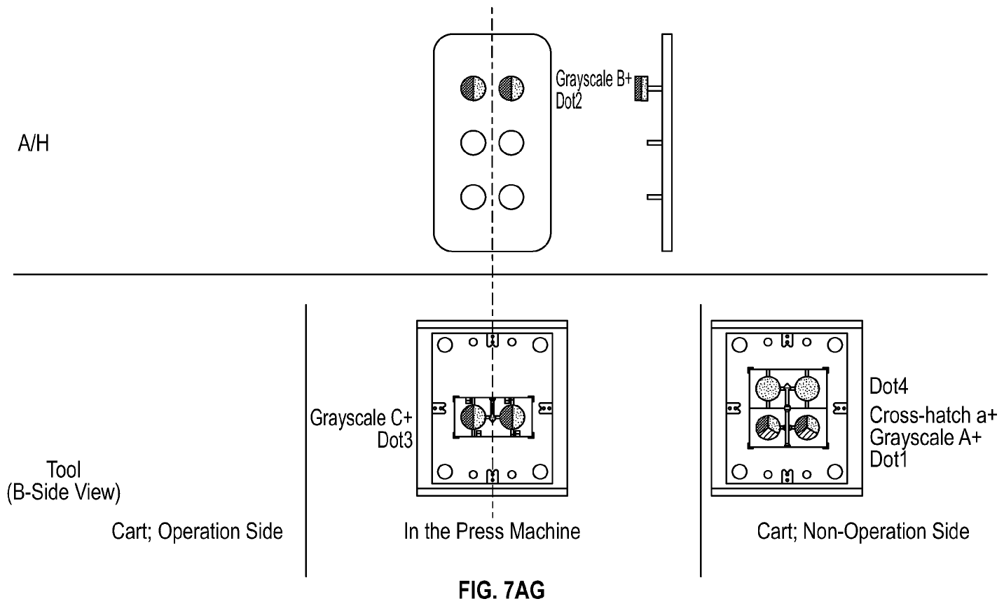

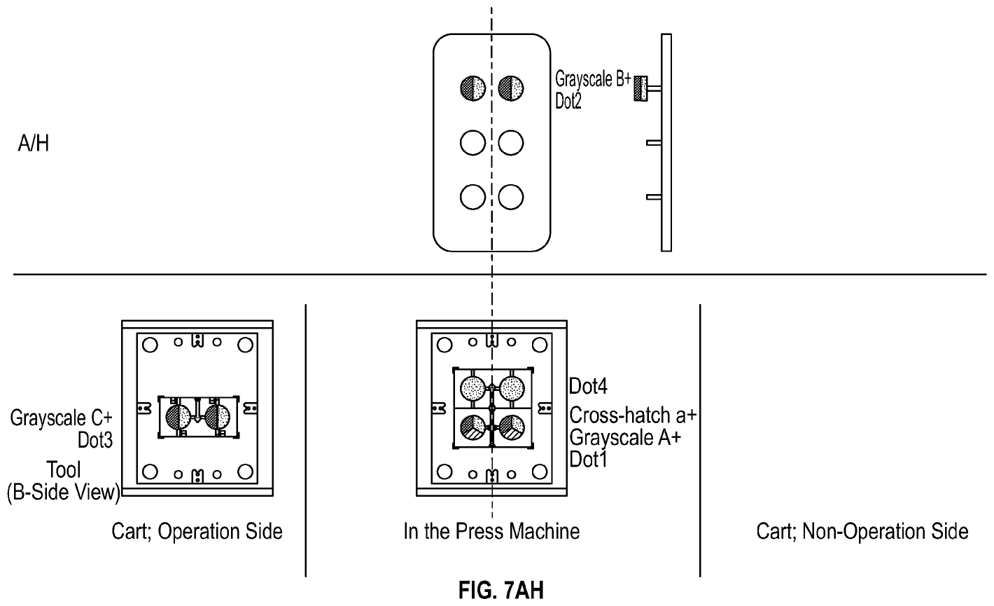

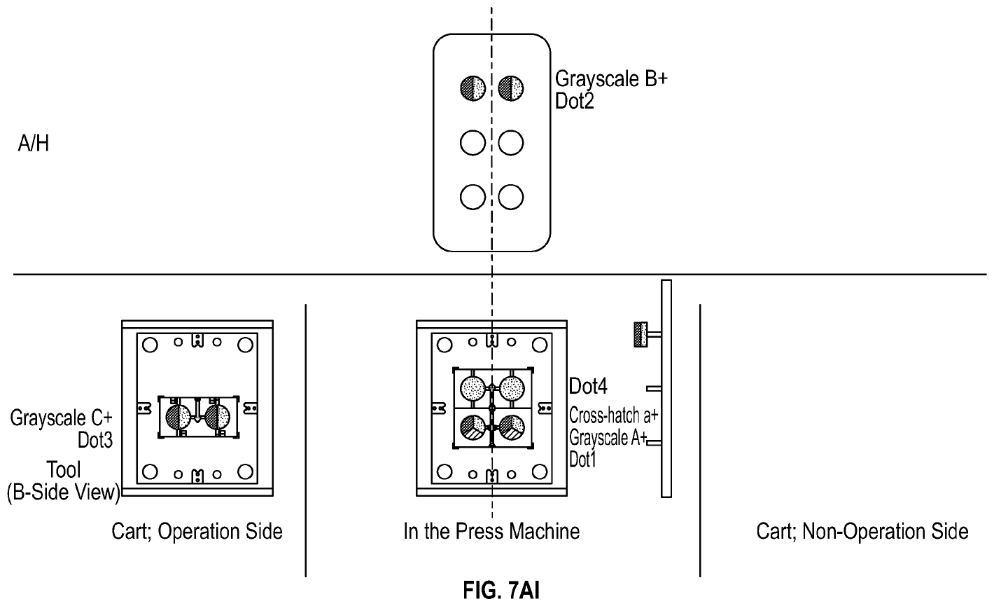

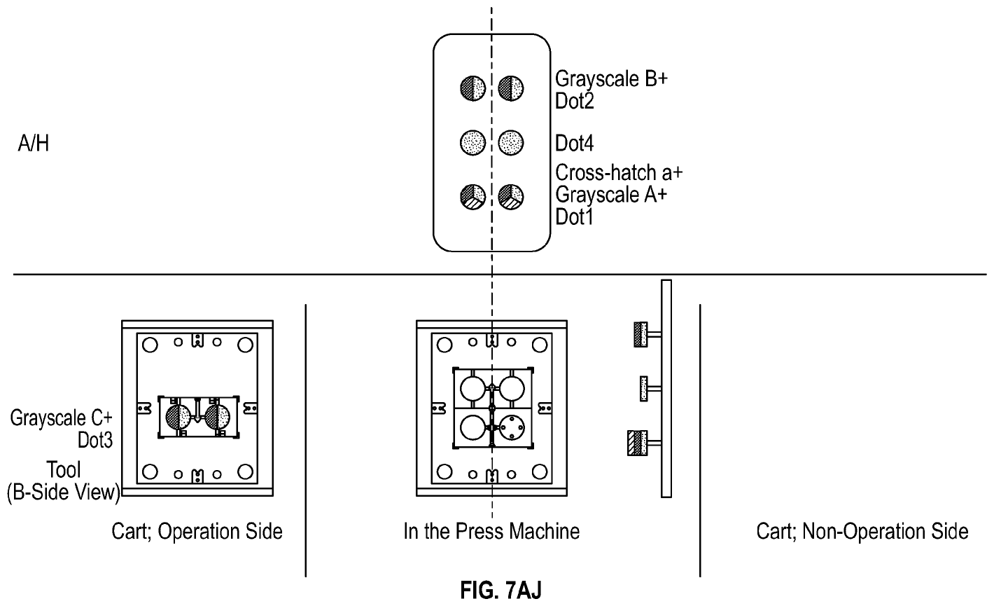

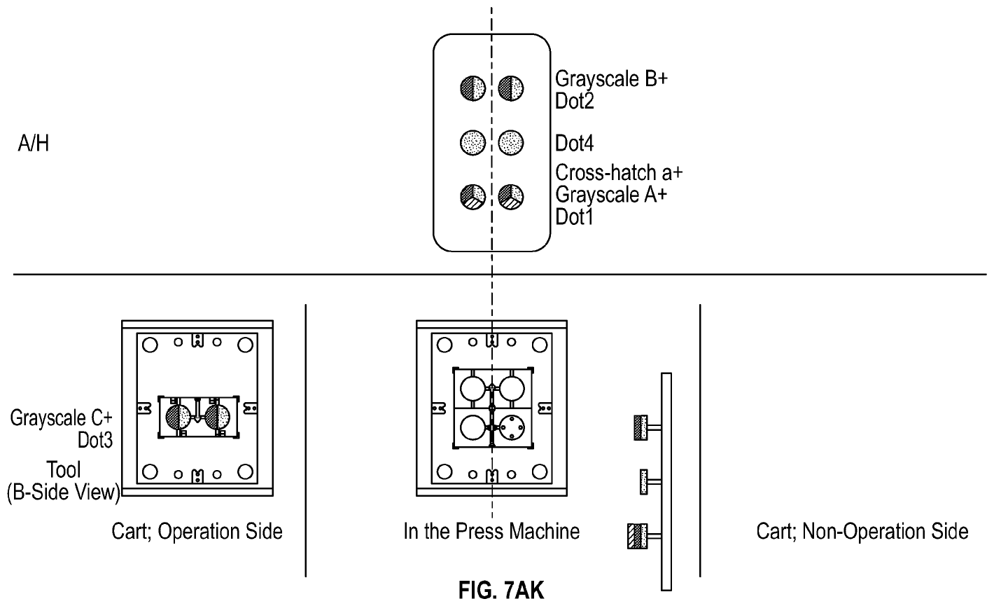

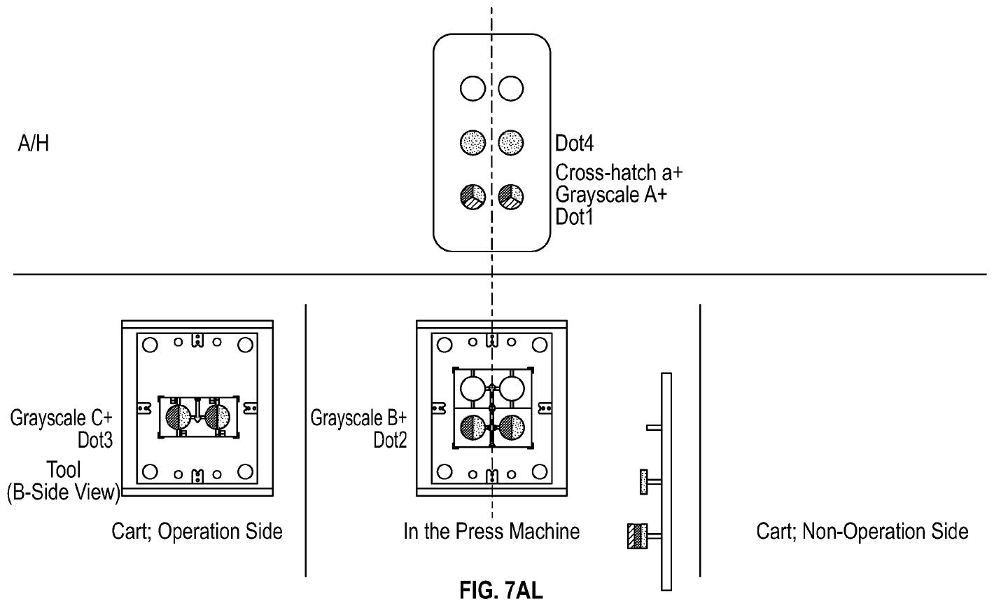

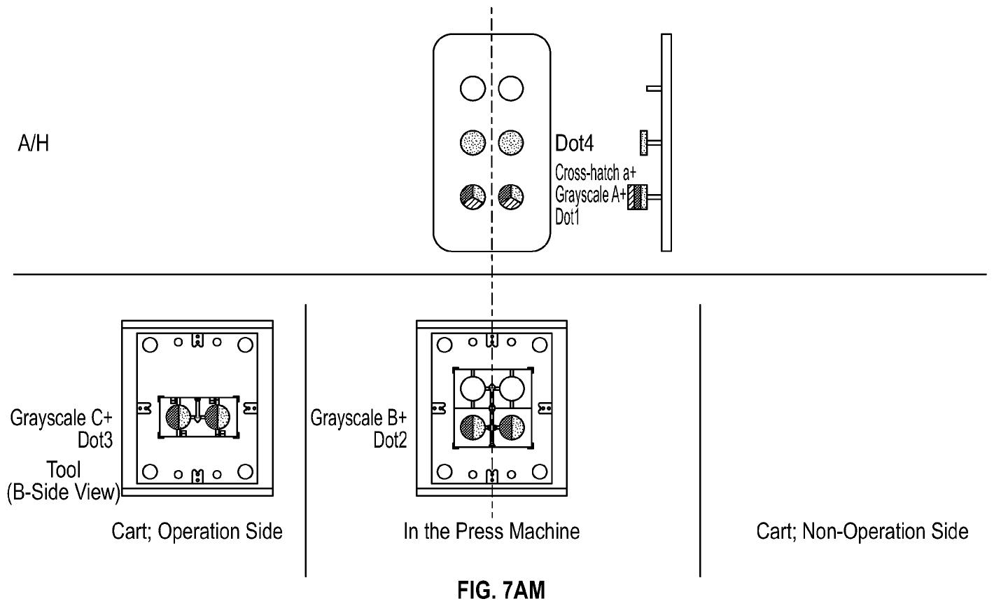

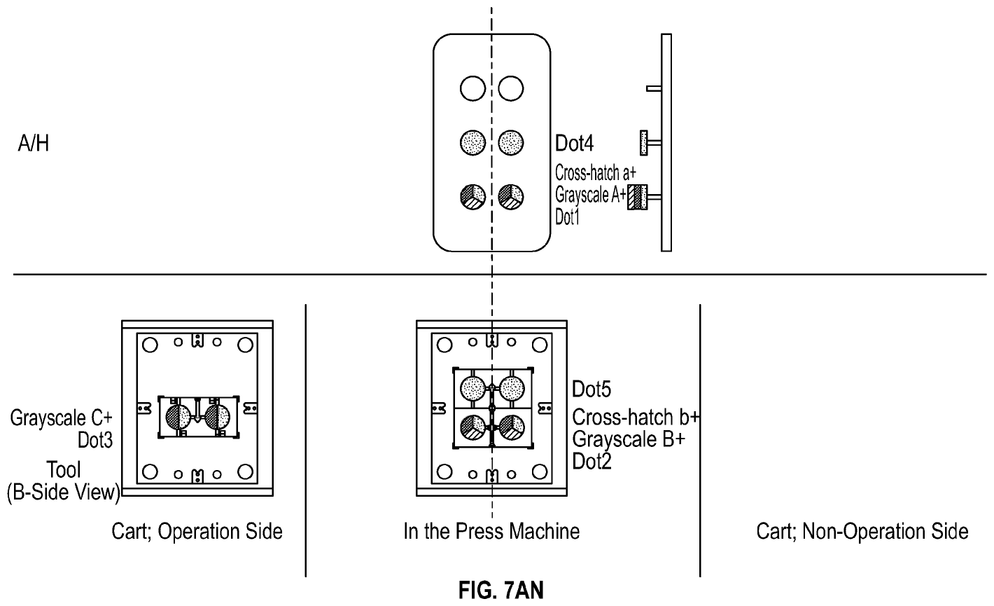

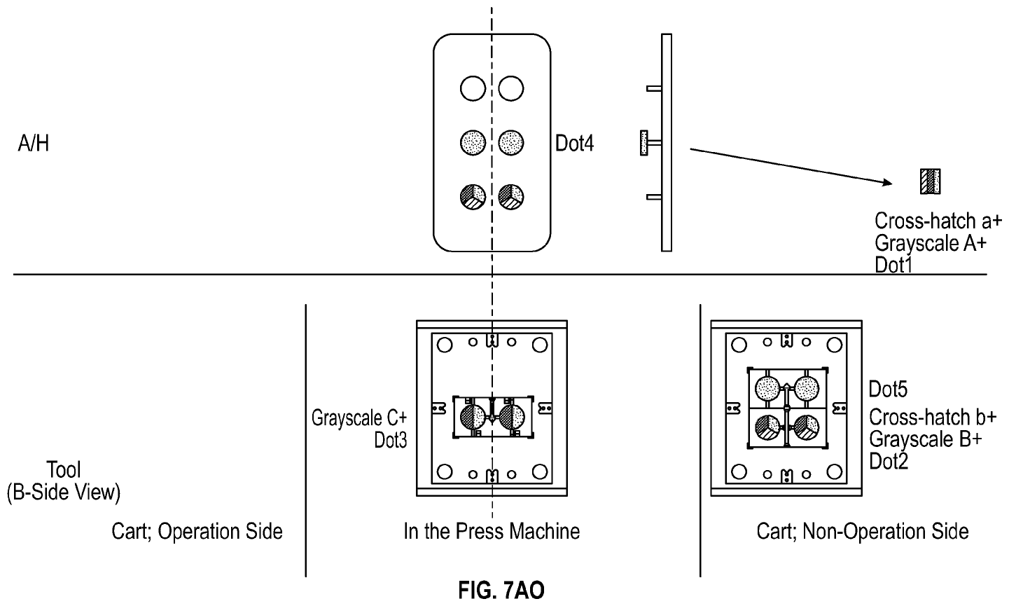

FIGS. 7A-7D illustrate a molding process using the configuration of molds from primary to tertiary molded parts and the behavior of molded parts by an injection molding system implementing the process of FIGS. 6A-6I.

According to the present embodiment, the primary molded part is referred to as the primary molded part 1, primary molded part 2 and primary molded part 3 based on the generation order. When it is not necessary to specify which primary molded part is referred to, primary molded part n is used.

According to the present embodiment, a secondary molded part is a molded part generated by additionally performing an injection process on the primary molded part n. The secondary molded part is called a secondary molded part α and a secondary molded part β based on the generation order. When it is not necessary to specify which secondary molded part is referred to, secondary molded part y is used.

According to the present embodiment, a tertiary molded part is a molded part generated by additionally performing an injection process on the secondary molded part y. The tertiary molded part is referred to as the tertiary molded part A and tertiary molded part B based on the generation order. When it is not necessary to specify which tertiary molded part is referred to, tertiary molded part x is used.

FIG. 7A illustrates a sectional view of mold 100A and mold 100B, and a cavity shape on the movable mold 102. The lower portion of FIG. 7A illustrates a cross section of the mold 100A and the mold 100B parallel to the XY plane. FIG. 7A illustrates the position is in injection molding machine (A), the mold is on the non-operation side of injection molding machine (B), and the mold is on the operation side of injection molding machine (C). FIG. 7A also illustrates the take-out robot position during injection molding (D) and the condition of a take-out robot holding a molded part (E).

The upper left portion of FIG. 7A illustrates filling shape at each process of primary molding, secondary molding and tertiary molding, and the final molded part to be the condition after the tertiary molding. In the present embodiment, the molding model was presumed for two-part pickup molding. However, the molded part pick-up count can be any number.

The mold 100A is a mold for molding a primary molded part 1 (n) and a tertiary molded part A (x) as described below. The mold 100B is a mold for molding secondary molded part α (y). Cavities to fill resin are configured for mold 100A and mold 100B.

FIG. 7A illustrates conveying mold 100A in a molding machine after completing the initial setting step S1 by clamping for primary molding, molding primary molded part 1, then opening the mold after cooling time has elapsed.

FIG. 7B illustrates a lowered take-out robot to take out primary molded part 1.

FIG. 7C illustrates a take-out robot taking out a primary molded part 1.

FIG. 7D illustrates a take-out robot rising after taking out a primary molded part 1 while holding the primary molded part 1 to standby.

FIG. 7E illustrates the condition after the processing of steps S10-S16 of FIG. 6B. In this condition, a primary molded part 2 exists in the mold 100A.

FIG. 7F illustrates the processing of step S17 of FIG. 6B. FIG. 7F also illustrates conveying mold 100B into the injection molding machine while cooling primary molded part 2 in the mold 100A and conveying the mold 100A to the opposite side of the operating side of injection molding machine.

FIG. 7G illustrates lowering the take-out robot 7 holding primary molded part 1 after changing operation conditions to the setting of 100B after exchanging molds and then opening the mold 100B.

FIG. 7H illustrates the take-out robot 7 inserting primary molded part 1 to the mold 100B. This is a state corresponding to step S20 of FIG. 6C.

FIG. 7I illustrates the take-out robot 7 rising directly after inserting primary molded part 1, closing and clamping of mold 100B, and preparing the mold 100B for injection to mold secondary molded part α. (process of step S23 of FIG. 6C).

FIG. 7J illustrates the condition of molded secondary molded part α by performing overmolding to primary molded part 1, measuring of cooling time starts after molding, releasing mold clamp to perform shutoff operation, and retracting a cylinder (not illustrated) (processes up to step S27 of FIG. 6C).

FIG. 7K illustrates, after conveying the mold 100B to outside the injection molding machine 2 and conveying mold 100A into the injection molding machine 2, the injection molding machine 2 is set to the operation conditions A to mold the primary molded part 3, and verifying if the cooling time is completed for taking out the primary molded part 2.

FIG. 7L illustrates the condition of a take-out robot 7 lowering after opening mold 100A.

FIG. 7M illustrates a take-out robot 7 taking out a primary molded part 2 from mold 100A.

FIG. 7N illustrates a take-out robot 7 rising after taking out a primary molded part 2 to standby to prepare for the next insertion.

FIG. 7O illustrates molding primary molded part 3 by performing mold closing and mold clamping after a take-out robot 7 is rising. After molding, measuring of cooling time starts, and a mold clamp is released to perform shutoff operation and retracting a cylinder (not illustrated) (processes to step S39 of FIG. 6D).

FIG. 7P illustrates, after conveying the mold 100A to outside the conveying machine 3A and conveying mold 100B into the injection molding machine 2, the injection molding machine 2 is set to the operation conditions B to mold the secondary molded part β, and verify if the cooling time is completed for taking out the secondary molded part α.

FIG. 7Q illustrates the condition of a take-out robot 7 lowering to take out a secondary molded part α.

FIG. 7R illustrates a take-out robot 7 taking out a secondary molded part α.

FIG. 7S illustrates a take-out robot 7 slightly rising to insert a primary molded part 2.

FIG. 7T illustrates a take-out robot 7 inserting a primary molded part 2 to mold 100B.

FIG. 7U illustrates a take-out robot 7 rising after inserting a primary molded part 2 to standby and preparing for the injection for mold secondary molded part β by closing a mold and clamping.

FIG. 7V illustrates molding secondary molded part β by performing overmolding to primary molded part 2. After molding, measuring of cooling time starts, and a mold clamp is released to perform a shutoff operation and retracting a cylinder (not illustrated) (process up to step S52 of FIG. 6E).

FIG. 7W illustrates, after conveying the mold 100B to outside the injection molding machine 2 and conveying mold 100A into the injection molding machine 2, the injection molding machine 2 is set to the operation conditions C to mold the tertiary molded part, and verify if the cooling time is completed for taking out the primary molded part 3.

FIG. 7X illustrates a take-out robot 7 lowering to take out a primary molded part 3.

FIG. 7Y illustrates inserting secondary molded part α to a cavity for tertiary molding by taking out primary molded part 3.

FIG. 7Z illustrates a take-out robot 7 rising after inserting a secondary molded part α and standby. Gate switching occurs for mold 100A at the time, and primary molded part and tertiary molded part are molded simultaneously.

FIG. 7AA illustrates molded primary molded part 4 and tertiary molded part A by closing and clamping mold 100A, preparing for injection, measuring of cooling time started, and releasing a mold clamp to perform a shutoff operation and retracting of a cylinder (not illustrated) (process up to step S66 of FIG. 6G.

FIG. 7AB illustrates, after conveying the mold 100A to outside the injection molding machine 2 and conveying mold 100B into the injection molding machine 2, the injection molding machine 2 is set to the operation conditions B to mold the secondary molded part β, and verify if the cooling time is completed for taking out the secondary molded part β.

FIG. 7AC illustrates a take-out robot 7 lowering to take out a secondary molded part β.

FIG. 7AD illustrates a take-out robot 7 taking out a secondary molded part β.

FIG. 7AE illustrates a take-out robot 7 inserting primary molded part 3 in the mold 100B.

FIG. 7AF illustrates a take-out robot 7 rising after inserting a primary molded part 3, and standby, and preparing for injection of molding secondary molded part γafter performing closing and clamping of a mold.

FIG. 7AG illustrates molding secondary molded part y by performing overmold to primary molded part 3, after molding, measuring of cooling time starts, and a mold clamp is released to perform a shutoff operation and retracting a cylinder (not illustrated) (the process up to step S79 of FIG.6H).

In FIG. 7AH illustrates, after conveying the mold 100B to outside the injection molding machine 2 and conveying mold 100A into the injection molding machine 2, the injection molding machine 2 is set to the operation conditions C to mold the tertiary molded part, and verify if the cooling time is completed for taking out the primary molded part 4 and tertiary molded part A.

FIG. 7AI illustrates a take-out robot 7 lowering to take out a primary molded part 4 and tertiary molded part A.

FIG. 7AJ illustrates a take-out robot 7 to take out a primary molded part 4 and tertiary molded part A.

FIG. 7AK illustrates a condition of take-out robot 7 lowering to insert a secondary molded part β.

FIG. 7AL illustrates inserting secondary molded part βto a cavity for tertiary molding by taking out primary molded part 3.

FIG. 7AM illustrates a take-out robot 7 rising and standby, performing closing and clamping a mold to prepare for injection of molding primary molded part 5 and tertiary molded part B.

FIG. 7AN illustrates molding primary molded part 5 and tertiary molded part B by performing overmolding to secondary molded part β.

FIG. 7AO illustrates a state where the tertiary molded part A is conveyed from a take-out robot 7 to a finished product storage location and it is determined whether an actual production volume is less than a scheduled/target production volume (step S90 of FIG. 6I).

If a predetermined number of production volume TH is not achieved, the process returns to FIG. 7A and the process associated with FIGS. 7A-7AO are repeated.

As described above, in step S1 of FIG. 6, the controller 41 can set the temperature for both mold 100A and mold 100B based on operator instructions. In another exemplary embodiment, mold temperature for manufacturing inner part(s) located in a middle layer (secondary molding area in the example of FIG. 7A) of the final molded part to be manufactured by overmolding is set lower than a mold temperature for manufacturing surface part(s) located external to the inner part(s) (Primary and tertiary molding areas in the example of FIG. 7A).

While the temperature of the mold 100B can be set in FIG. 7G, in another exemplary embodiment, the temperature is set as low as possible, for example, at a temperature where resin to be molded can be injected and filled into a mold. When, for example, a thick-walled molded part is overmolded, a secondary molding area serving as a middle layer does not affect surface accuracy or dimensions of the final molded part. Therefore, for molding of a second layer, the cooling rate can be accelerated by injecting and filling resin without needing to monitor the surface accuracy and the dimension of the molded product.

Intentionally changing thickness of the primary molding area, secondary molding area, or tertiary molding area can be an effective approach. For example, a thick part can be molded in a short time by forming a thick wall at a low mold temperature by forming the thickness of the secondary molding area to be thicker than the thickness of the primary molding area and the tertiary molding area. Since the primary and tertiary molding area formed at high temperature are thinner, the cooling time is shortened and productivity can be enhanced.

If the secondary molding area of the molded part includes a thicker wall, the secondary molded part α can have a thickness where a majority of the part thickness to be finally obtained is formed. In FIG. 7Z, similar to the case of molding the primary molded part, if the mold 100A is set to, for example, when set the heat deflection temperature of the resin molded at −5° C. to −30° C., a tertiary molded part with high transferability and excellent surface accuracy can be molded.

As described above, the mold 100A and the mold 100B are molded with a temperature difference, thus enabling molding a thicker wall part with higher productivity.

In the present embodiment, the mold 100A for forming a first and third layers is set at a high temperature, and the mold 100B for forming the second layer is set at a low temperature. In another exemplary embodiment, the mold 100A can be set at a low temperature and the mold 100B can be set at a high temperature depending on an intended application of the molding process.

As the operator sets the injection temperature of the resin for each molded part in step S1 of FIG. 6A, and when an operator designates a part that is at an intermediate area (in this example, the secondary molded part) from among each molded part, the temperature of the resin can be automatically determined so that the temperature of the resin for the secondary molded part is lower than the temperature of the resin for the primary molded part/tertiary molded part (Primary molded part, Secondary molded part and Tertiary molded part).

### Definitions

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. An injection molding system comprising:
an injection molding machine for injecting a resin into a mold;
a conveyer apparatus configured to move a mold between a first position within the injection molding machine and a second position outside the injection molding machine;
a controller; and
an inserting unit,
wherein the improvement to the injection molding system includes:
the controller configured to control the conveyer apparatus not to move a first mold until the injection molding machine performs N times (N≥2) of an injection process with the first mold, wherein the controller is further configured to control the conveyer apparatus to move the first mold from the first position to the second position after the N times of the injection process with the first mold such that a second mold external to the injection molding machine moves into the injection molding machine, and
the inserting unit configured to insert one of a first molded part obtained based on the N times injection process with the first mold into the second mold such that the injection molding machine injects a resin into the second mold in which the first molded part is inserted to obtain a second molded part.

2. The injection molding system according to claim 1, wherein the second molded part is inserted into the first mold such that the injection molding machine injects a resin into the first mold in which the second molded part is inserted to obtain a third molded part.

3. The injection molding system according to claim 2, further comprising a holding unit configured to hold the first molded part until the first molded part is inserted into the second mold, and the holding unit is configured to hold the second molded part until the second molded part is inserted into the first mold.

4. The injection molding system according to claim 1, wherein a cooling process for cooling the resin injected into the first mold for at least one first molded part from among the N first molded parts is performed within the injection molding machine, and wherein the cooling process for other first molded part from among the N first molded parts is performed external to the injection molding machine.

5. The injection molding system according to claim 1, wherein N is 3, and wherein, after moving the second mold to the first position, the controller controls the conveyer apparatus not to move the second mold from the first position until two times of injection process with the second mold is performed to obtain two second molded parts, and wherein the controller controls the conveyer apparatus to move the second mold from the first position external to the injection molding machine after the two times of injection process with the second mold by the injection molding machine.

6. The injection molding system according to claim 1, wherein N is 2, and wherein, after moving the second mold to the first position, the controller controls the conveyer apparatus to move the second mold from the first position external to the injection molding machine after single injection process with the second mold by the injection molding machine.

7. The injection molding system according to claim 1, further comprising an ejecting unit for ejecting the first molded part from the first mold and a holding unit configured to hold the first molded part until the first molded part is inserted into the second mold.

8. The injection molding system according to claim 7, wherein the ejecting unit is configured to eject the second molded part from the second mold and the inserting unit is configured to insert the second molded part into the first mold.

9. The injection molding system according to claim 1, further comprising a second conveyer apparatus configured to move the second mold between the first position within the injection molding machine and a third position outside the injection molding machine while the conveyer apparatus moves the first mold between the first and second positions.

10. The injection molding system according to claim 1, wherein the controller is configured to control temperature regarding injection molding process such that temperature of the first mold into which a resin injected is higher than temperature of the second mold into which a resin injected.

11. An injection molding system comprising:
an injection molding machine for injecting a resin into a mold;
a conveyer apparatus configured to move a mold between a first position within the injection molding machine and a second position outside the injection molding machine;
a controller; and
an inserting unit,
wherein the improvement to the injection molding system includes:
the inserting unit configured to insert a first molded part obtained based on injection process with a first mold into a second mold such that the injection molding machine injects a resin into the second mold in which the first molded part is inserted to obtain a second molded part, and
wherein the controller is configured to control temperature regarding injection molding process such that temperature of the first mold into which a first resin is injected is higher than temperature of the second mold into which a second resin is injected.

12. The injection molding system according to claim 11, wherein the inserting unit is configured to insert the second molded part to the first mold such that the injection molding machine injects a resin into the first mold in which the second molded part is inserted to obtain a third molded part, wherein the controller controls the temperature such that the temperature of the second mold is lower than temperature of the first mold into which the resin injected to obtain the third molded part.
